(19) United States
(12) Patent Application Publication
(10) Pub. No.: US 2017/0061070 A1
(43) Pub. Date: Mar. 2, 2017

(54) METHOD AND PROCESS FOR WHOLE GENOME SEQUENCING FOR GENETIC DISEASE DIAGNOSIS

(71) Applicant: THE CHILDREN'S MERCY HOSPITAL, Kansas City, MO (US)

(72) Inventors: Stephen Kingsmore, San Diego, CA (US); Laurel K. Willig, Kansas City, MO (US); Neil Miller, Santa Fe, NM (US)

(21) Appl. No.: 15/118,702

(22) PCT Filed: Feb. 13, 2015
(86) PCT No.: PCT/US15/15956

§ 371 Date: Aug. 12, 2016

Related U.S. Application Data
(60) Provisional application No. 61/939,654, filed on Feb. 13, 2014.

(51) Int. Cl. G06F 19/18; G06F 19/22

(52) U.S. Cl. CPC G06F 19/18; G06F 19/22

(57) ABSTRACT

The process of the present invention is used to perform nucleotide sequence variant detection using two or more independent analysis methods to produce a superset of highly sensitive variant calls. The process of the present invention is used for genetic disease diagnosis including the steps of genome sequencing, creating a superset of sensitive variant calls by using at least two independent analysis methods, comparing a database of genetic diseases with disease phenotype information to produce a prioritized list of probable genetic diseases, and integrating the superset of sensitive variant calls and the prioritized list of probable genetic diseases.

### BACKGROUND ART

The approximately 4,000 Mendelian diseases of known molecular basis are major causes of morbidity and mortality. Effective medical treatment of individual patients with suspected Mendelian diseases requires molecular diagnosis of the particular disease type. Effective treatment of Mendelian diseases includes provision of therapies that target causal disease mechanisms or disease symptoms, genetic counseling of families about risk of recurrence, prognostic determination, and anticipation and amelioration of disease complications and progression. Molecular diagnosis of Mendelian diseases has traditionally been performed by Sanger sequencing individual candidate genes, one at a time, based on their likelihood of causing the symptoms observed in individual patients. This process is obfuscated, however, by the broad range of symptoms that can be manifested in each Mendelian disease and the large number of Mendelian diseases. Next generation sequencing of the whole genome (WGS) or the parts of the genome that contain sets of disease genes (whole or targeted exome sequencing) (WES) is increasingly being used for diagnosis of Mendelian diseases. Genome sequencing, whether whole genome sequencing or sets of disease genes, allows all or most of the Mendelian diseases that cause symptoms in an individual patient to be examined diagnostically at once. This may decrease the time to diagnosis or the cost of diagnostic testing. Earlier diagnosis of Mendelian diseases can enable earlier institution of specific treatments, which may engender improved patient outcomes. It has been shown that it is possible to have molecular diagnosis in 50 hours by rapid whole genome sequencing (STATseq). However, in general, the methods that identify variants in genome sequencing were optimized for common variants and population research, and select against rare or novel deleterious variants that may cause disease, and, therefore, lack sensitivity for diagnosis of genetic diseases.

Neurodevelopmental disorders (NDD), including intellectual disability, global developmental delay and autism, affect more than 3% of children. Etiologic identification of NDD often engenders a lengthy and costly differential diagnostic odyssey without return of a definitive diagnosis. The current etiologic evaluation of NDD is complex: Primary tests include neuroimaging, karyotype, array comparative genome hybridization (array CGH) and/or single nucleotide polymorphism arrays, and phenotype-driven metabolic, molecular and serial gene sequencing studies. Secondary, invasive tests, such as biopsies, cerebrospinal fluid examination, and electromyography, enable diagnosis in a small percentage of additional cases. About 30% of NDD are attributable to structural genetic variation, but more than half of patients do not receive an etiologic diagnosis. Single gene testing for diagnosis of NDD is especially challenging due to profound locus heterogeneity and overlapping symptoms.

As predicted, the introduction of WGS and WES (whole exome sequence) into medical practice has begun to transform the diagnosis and management of patients with genetic disease. Acceleration and simplification of genetic diagnosis is a result of: 1) multiplexed testing to interrogate nearly all genes on a physician's differential at a cost and turnaround time approaching that of a single gene test; 2) the ability to analyze genes for which no other test exists; and 3) the capacity to cast a wide net that can detect pathogenic variants in genes not yet on the clinician's differential. The latter proves particularly powerful for diagnosing patients with very rare or newly discovered genetic diseases, and for patients with atypical or incomplete clinical presentations. Furthermore, new gene and phenotype discovery has increasingly become part of the diagnostic process. The importance of molecular diagnosis is that care of such patients can then shift from interim, phenotypic-driven management to definitive treatment that is refined by genotype. Although early reports indicate that WES enables diagnosis of neurologic disorders, the clinical and cost effectiveness are not known. Data are needed to guide best practice recommendations regarding testing of probands (affected patients) alone versus trios (proband plus parents), use of WES versus WGS, and the appropriate prioritization of genomic testing in an etiologic evaluation for various clinical presentations.

The effectiveness of a WGS and WES sequencing program for children with NDD, featuring an accelerated sequencing modality (rapid WGS, STATseq) for patients with high acuity illness were reported. Diagnostic yield and an initial analysis of the impact on time to diagnosis, cost of diagnostic testing and subsequent clinical care are outlined herein.

Herein are described methods for genome sequencing for diagnosis of genetic diseases with enhanced sensitivity. In one embodiment, whole genome sequencing is described herein with genome-wide genotyping and provisional diagnosis in 24 hours. By combining results from two, parallel bioinformatic methods, 2.8 billion nucleotides were genotyped and 4.9 million variants were detected. This technique increased the identification of rare, potentially disease causing variants 2.5-fold without significant loss of specificity. In 17 families (21 acutely ill neonates and infants) enrolled prospectively, clinical whole genome sequencing gave 10 definitive molecular diagnoses, and clinical management was modified in four. Therefore, rapid whole genome sequencing with twin bioinformatic analyses is effective for diagnosis of genetic disorders. In addition, rapid whole genome sequencing with multiple independent analysis methods (STATseq) produce a superset of highly sensitive variant calls, which increases the sensitivity, rate, or likelihood of diagnosis of genetic disorders.

### DISCLOSURE OF INVENTION

The system of the present invention is used to perform nucleotide sequence variant detection using two or more independent analysis methods to produce a superset of highly sensitive variant calls (STATseq). Each independent analysis method includes at least one sequence alignment algorithm and at least one variant detection mechanism. Since variant detection methods have individual strengths and weaknesses, the combining of results from at least two methods produces a set of variant calls that could not have been produced by using a single analysis method. These results provided for a significant increase in the number of variants detected. The results include at least a 2.7 fold increase in the number of variants of types that can cause genetic disease.

In addition, the system of the present invention can provide rapid testing and interpretation of genetic diseases that involve large nucleotide inversions, large deletions, insertions, large triplet repeat expansions, gene conversions and complex rearrangements.

Other and further objects of the invention, together with the features of novelty appurtenant thereto, will appear in the course of the following description.

### BRIEF DESCRIPTION OF DRAWINGS

In the accompanying drawings, which form a part of the specification and are to be read in conjunction therewith:

FIG. 1. Improving the sensitivity of nucleotide variant identification for diagnosis of rare genetic diseases in ˜40× human genome sequencing. FIG. 1a is a Venn diagram comparison of nucleotide variants identified in genome sequencing of sample UDT_173 (HiSeq 2500, 139 GB, 2×100 nt rapid-run mode, 18 hour run time) employing previously disclosed methods for 50-hour diagnostic genome sequencing (Published pipeline), parameters developed to cure rare variant loss (Diagnostic pipeline), a Rapid pipeline (iSAAC 01.13.01.31 and starling 2.0.2, respectively), and the superset of those methods (Dual pipeline). FIG. 1b is a Venn diagrams showing the distribution of allele frequencies and pathogenicity of nucleotide variants reported by the four pipelines in genome sequencing of three samples. Rare variants had allele frequencies <0.01, based on genomic sequences of up to 2,446 internal samples. Previously reported disease causing variants are American College of Medical Genetics (ACMG) Category 1 mutations. Likely pathogenic variants are ACMG Category 2 variants (loss of initiation, premature stop codon, disruption of stop codon, whole gene deletion, frameshifting indel, disruption of splicing). Possibly pathogenic variants are ACMG Category 3 (non-synonymous substitution, in-frame indel, disruption of polypyrimidine tract, overlap with 5′ exonic, 5′ flank or 3′ exonic splice contexts). FIG. 1c are graphs of variant density versus variant allele frequency. Values for three pipelines are plotted. Results represent the sum of ˜40× genome sequencing in three samples. Upper panel shows results for all variants. Lower panel shows results for ACMG Category 1-3 variants. FIG. 1d is a histogram of variants identified uniquely by the three pipelines in sample UDT173. Genotype differences (dark blue) accounted for a very small proportion of the variants uniquely identified by a single pipeline.

FIG. 2. Examination of the sensitivity and accuracy of nucleotide variant genotype calls in genome sequencing with the Rapid and Diagnostic pipelines. FIG. 2a is a comparison of the sensitivity and accuracy of all nucleotide variant calls. FIG. 2b is a comparison of the accuracy of unique calls by the Rapid and Diagnostic pipelines. Genome sequencing was performed using the HiSeq 2500 with 2×100 cycles and 18-hour run time. The sample UDT_173 genotype “truth set” was from hybridization to the Omni4 SNP array. The NA12878 “truth set” was from ftp://ftp-trace.ncbi.nih.gov/giab/ftp/data/NA12878/variant_calls/NIST

FIG. s1. The contrasting requirements of research genome sequencing and diagnostic whole genome sequencing for diagnosis of genetic disorders in acutely ill neonates.

FIG. s2. (a) flow diagram of steps for rapid diagnosis of genetic diseases by genome sequencing that compares (b) the previously reported 50-hour method with (c) a 24- and 40-hour, high sensitivity dual-alignment protocol and (d) reflex testing of parent samples, as needed. 24-hour provisional molecular diagnosis was obtained by faster sample preparation, sequencing, alignment, variant calling and annotation. GSNAP is the Genomic Short-read Nucleotide Alignment Program. The Genome Analysis Tool Kit (GATK) is a software library for variant identification and genotyping. The final stage in the GATK best practices with human genome sequencing is to use known variants as training data to establish the probability of each variant's accuracy (Variant Quality Score Recalibration, VQSR), and subsequently to remove low-probability variants. iSAAC is an extremely rapid read alignment method. High sensitivity for rare variant identification was obtained herein by use of the superset of variants generated by two alignment and variant identification pipelines (GSNAP version 2012.07.12 with GATK version 1.6.13 without VQSR, and iSAAC version 01.13.01.31 with starling version 2.0.2). Rare or novel variants do not overlap sufficiently with extant training data to provide a statistically significant Bayesian prior, so VQSR was not included. At 24 hours, the need for extension to trio samples was adjudged, with those results becoming available in a further 21 hours Symptom and Sign-Assisted Genome Analysis (S SAGA) is a clinico-pathological correlation tool that maps the clinical features of genetic diseases to genetic diseases and causative genes.

FIG. s3. Examples of variants in GSNAP-aligned 2×100 cycle sequences (bam⁺, the binary version of the Sequence Alignment/Map format), that were supported by multiple, non-clonal reads and high-quality alignments, but that were absent from Variant Call Format files (vcf⁻) following application of the Genome Analysis Tool Kit (GATK) with best practices for variant identification and genotyping.

FIG. s4. Comparison of the ratio of nucleotide transitions to transversions (Ti/Tv) of the four pipelines, both for common (left panels) and rare (MAF<1%, right panels) variants. Genome sequencing was performed on samples UDT_173 and NA12878 using the HiSeq 2500 with 2×100 cycles and 18- or 26-hour run time.

FIG. s5. Base composition of rapid genome sequencing of sample UDT_173 (HiSeq 2500 2×100 nt rapid-run mode). (a) read 1, 26-hour run; (b) read 1, 18-hour run, (c) read 2, 26-hour run; (d) read 2, 18-hour run. Base composition was not materially different in the 18- and 26-hour runs. However, the % non-AGTC reads was lower in the 18-hour run. This may either reflect better sequence quality or lower cluster density.

FIG. s6. Frequency distribution of GC content of 18- and 26-hour genome sequencing of sample UDT_173 (HiSeq 2500 2×100 nt rapid-run mode). (a) read 1, 26-hour run; (b) read 1, 18-hour run, (c) read 2, 26-hour run; (d) read 2, 18-hour run. 18- and 26-hour runs had identical GC content distributions, with sequence representation between GC content of 15% and 75%. GC content varies widely across the human genome—the isochore structure of the human genome. The median genome GC content estimated by 18- and 26-hour whole genome sequencing (35%-40%) agreed with the estimated median from the 1,000 genomes project (38.6%), and is slightly lower than estimates by cesium density gradient centrifugation (39.6%-40.3%).

FIG. s7. Quality scores of nucleotide calls as a function of cycle number in 18- and 26-hour genome sequencing of sample UDT_173 (HiSeq 2500 2×100 nt rapid-run mode). (a,) read 1, 26-hour run; (b,) read 1, 18-hour run, (c,) read 2, 26-hour run; (d,) read 2, 18-hour run. 18- and 25-hour run scores were indistinguishable.

FIG. s8. Normalized, log-transformed distribution plots of 18- and 26-hour genome sequencing (HiSeq 2500 2×100 nt rapid-run mode). Samples and run times are shown on the right. Plots show an approximate log-transformed Poisson distribution with a tail at the origin reflecting non-aligned sequences and a curious, small increase in frequency at a depth of approximately 0.15-fold coverage per GB. 18- and 25-hour runs showed overlapping distributions.

FIG. s9. Screenshot of the variant analysis and interpretation tool VIKING. Boxes on the left hand side are automatically populated by the clinical features and relevant diseases and disease genes in patient CMH002 that were entered in the SSAGA tool, which had been validated for 768 genetic diseases, at patient enrollment. Alternatively, clinical features were mapped to 7,546 OMIM and Orphanet diseases with the Phenomizer tool. On the right are displayed the five annotated variants identified in the exome of CMH002 that map within those genes. The filter at the bottom left is set to display only variants with an MAF<2%. The top variant is a homozygous, known mutation that creates a premature stop codon in Aprataxin (APTX), giving a provisional genomic diagnosis of Early onset Ataxia with Oculomotor Apraxia, hypoalbuminemia and coenzyme Q10 deficiency which was confirmed by Sanger sequencing of the patient, her affected sister and both parents. At interpretation, a right click on a particular variant pulls up a menu with an option to markup of the selected variant with regard to likely disease causality. A left click pulls up a menu with options to inspect the local read alignments in IGV or to view the complete variant annotation in the variant warehouse. Interpretation sessions can be saved and results exported with standard fields and formats that populate a report form.

FIG. s10. Screenshot of the variant analysis and interpretation tool VIKING. Boxes on the left hand side are automatically populated by the clinical features and relevant diseases and disease genes in patient UDT_002 that were entered in SSAGA at patient enrollment. On the right are displayed the two annotated variants identified in the exome of UDT_002 that map within those genes. The filter at the bottom left is set to display only variants with an MAF<2%. The two variants are heterozygous, known mutations in Hexosaminidase A (HEXA), giving a provisional genomic diagnosis of Tay-Sachs disease, which was the correct diagnosis in this blinded test sample.

FIG. MD 1 is a flow diagram of the study of the diagnostic sensitivity and accuracy of STATseq.

FIG. MD 2 an illustration of the Kaplan-Meier survival curves of NICU and PICU infants with and without a genetic disease diagnosis shown in (a) and clinical time course of patients CMH487 shown in (b) and CMH569 shown in (c).

FIG. ND s1 is an illustration of paried read alignments to a 5,294 nt interval encompassing the introless MAGEL2 gene on Chr 15q11.2 are shown in the Integrated Genome Viewer.

FIG. ND illustrates diagnoses and inheritance patterns in 100 NDD families tested by genome or exome sequencing, where (a) shows diagnostic outcomes in 100 families and (b) shows inheritance pattern in 45 families. AR, autosomal recessive.

FIG. ND 2 shows clinical features of patients CMH301, CMH663, CMH334 and CMH335. Patient CMH301, with multiple congenital anomalies-hypotonia-seizures syndrome 2 (PIGA, c.68dupG, p.Ser24LysfsX6) at age 2 years (A), 6 years (B), and 10 years (C). (D) Infant CMH663, with compound heterozygous mutations in the mitochondrial malate/citrate transporter (SLC25A1). (E) Male patients CMH334, (left), and CMH335 (right) with X-linked Rett syndrome (MECP2 c.419C>T, p.A140V), and their mother.

FIG. ND 3 provides for the expression of GPI-anchored proteins on peripheral blood cells of patient CMH301. CMH301 was diagnosed with multiple congenital anomalies-hypotonia-seizures syndrome 2. Flow cytometric signals corresponding to CMH301 are shown by the green lines, his mother CMH303 is shown in blue, and a normal control in red. Erythrocytes were stained with anti-CD59 antibodies. Granulocytes, B cells, and T cells were stained with fluorescent aerolysin (FLAER). The orange line represents an unstained normal control. The X-axis is the number of cells. The Y-axis is fluorescence intensity, representing the abundance of protein expression on the cell surface. CMH301 has normal expression of CD59 and decreased expression of glycosylphosphatidylinositol-anchored proteins on granulocytes, B lymphocytes and T lymphocytes.

FIG. ND 4 illustrates the effect of citrate supplementation on urinary citrate and 2-hydroxyglutarate in patient CMH663. CMH663 had combined D-2- and L-2-hydroxyglutaric aciduria. CMH urinary citrate reference value for normal urine is >994 mmol/mol creatinine. CMH urinary 2-OH-glutarate reference value for normal urine is <89 mmol/mol creatinine.

### BEST MODE FOR CARRYING OUT THE INVENTION

The requirements of genome sequencing for population research and individual diagnosis contrast sharply (FIG. s1). To be relevant for clinical management of acutely ill neonates and infants, diagnostic genome sequencing must be extremely fast and exquisitely sensitive for mutations. In particular, Mendelian diagnostic whole genome sequencing has a single goal—genotyping all sites and identification of one or two rare genotypes in a single gene that cause the rare disease phenotypes of that individual. Accuracy is not paramount since clinicopathologic correlation and confirmatory testing of likely causative genotypes is standard. Absent a causative genotype, the presence of normal genotypes at all nucleotides of on-target disease genes is important to rule out differential diagnoses. As a first step towards diagnostic genome sequencing for rare genetic diseases, it has been demonstrated to be feasible in 50 hours (FIG. s2).

Variants were identified and genotyped with the sensitive Genomic Short-read Nucleotide Alignment Program (GSNAP) and the Genome Analysis Tool Kit (GATK) best practices (Published pipeline). In contrast to 91 genomes analyzed with pipelines developed for population research, the Published pipeline accessed 28% more of the genome and yielded 91% more indels (See Table s1 below).

TABLE s1

| | Run | | Truth Set | Reference | Best practice GATK | | GATK - VQSR | |
|---|---|---|---|---|---|---|---|---|
| Sample | Time | Aligner | Genotypes | genotypes | % Sens. | % Spec. | % Sens. | % Spec. |
| UDT_173 | 26 | GSNAP | 2,366,994 | 71.6% | 94.34 | 97.66 | 95.82 | 97.56 |
| | 18 | | | 74.8% | 83.76 | 97.85 | 95.78 | 97.61 |
| | 26 | BWA | | 73.2% | 89.06 | 97.73 | 92.79 | 97.57 |
| | 18 | | | 72.8% | 90.58 | 97.62 | 92.83 | 97.51 |

| | Run | Truth Set | | Reference | | |
|---|---|---|---|---|---|---|
| Sample | Time | Genotypes | Pipeline | Genotypes | Sensitivity | Specificity |
| NAl2878 | 18 | 2,336,705,924 | Dual | 99.9% | 95.99% | 99.99% |
| | | | Diagnostic | 99.9% | 92.82% | 99.99% |
| | | | Rapid | 99.9% | 87.68% | 99.99% |
| | | | Published | 99.9% | 87.37% | 99.99% |
| UDT_173 | 26 | 2,366,994 | Dual | 71.1% | 96.17% | 97.47% |
| | | | Diagnostic | 71.2% | 95.82% | 97.56% |
| | | | Rapid | 71.9% | 93.61% | 98.21% |
| | | | Published | 71.6% | 94.34% | 97.66% |
| UDT_173 | 18 | 2,366,994 | Dual | 71.1% | 96.15% | 97.49% |
| | | | Diagnostic | 71.2% | 95.78% | 97.61% |
| | | | Rapid | 71.2% | 93.53% | 98.18% |
| | | | Published | 74.8% | 83.76% | 97.85% |

| | | Variants | % | Variants | | Variants | |
|---|---|---|---|---|---|---|---|
| Alignment 1 | Alignment | Detected | Detected | Unique to | % Unique | Unique to | % Unique to |
| Method 1 | Method 2 | By Both | By Both | Method 1 | to Method 1 | Method 2 | Method 2 |
| BWA | CASAVA | 3,505,141 | 78.7 | 466,203 | 10.5 | 482,418 | 10.8 |
| GSNAP | CASAVA | 3,607,308 | 80.3 | 506,910 | 11.3 | 380,251 | 8.5 |

Table s1 is a comparison of metrics of the Published, Rapid, Diagnostic and Dual pipelines in three genome sequencing samples with each other and those of 91 other published genome sequencing samples. Comparison of sensitivity and specificity of nucleotide variant genotypes of 18- and 26-hour 2×100 cycle HiSeq 2500 genome sequencing of samples UDT_173 and NA12878 with four alignment methods and two variant calling methods. In the Published pipeline, variants were identified and genotyped with the sensitive Genomic Short-read Nucleotide Alignment Program (GSNAP) and the Genome Analysis Tool Kit (GATK) best practices. The Diagnostic pipeline is the novel combination of methods that were developed to cure rare variant loss (GSNAP version 2012.07.12, with default parameters, and GATK version 1.6.13, without Variant Quality Score Recalibration). The Rapid pipeline uses the iSAAC alignment algorithm, version 01.13.01.31, and the starling variant caller, version 2.0.2. The Dual pipeline is the superset of the Diagnostic and Rapid pipelines. The set of consensus correct genotypes (Truth Set) for sample UDT_173 were from hybridization to the Omni4 SNV array. Correct genotypes for NA12878 were from ftp://ftp-trace.ncbi.nih.gov/giab/ftp/data/NA12878/variant_calls/NIST

However, these methods still favored specificity over sensitivity, leading to the removal of rare, novel variants in aligned sequences (bam⁺, the binary version of the Sequence Alignment/Map format), which were supported by multiple, non-clonal reads and high-quality alignments (absent from Variant Call Format files (vcf⁻). Removal of rare and variants is problematic for clinical testing as these are enriched for disease causing mutations, significantly decreasing the diagnostic yield of clinical genome sequencing.

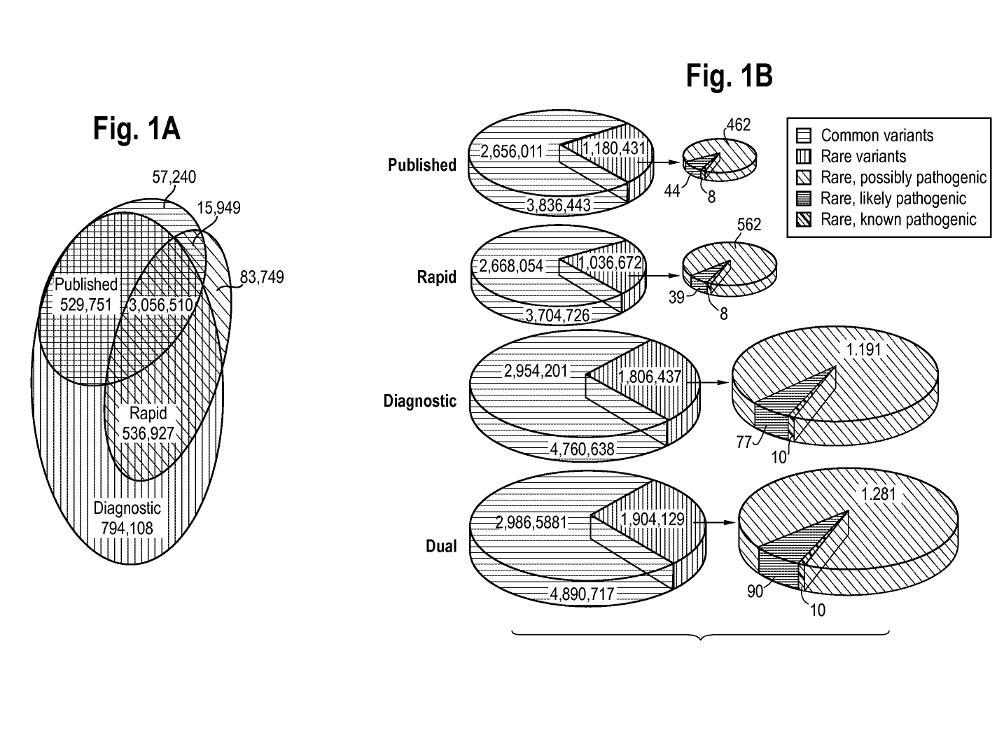

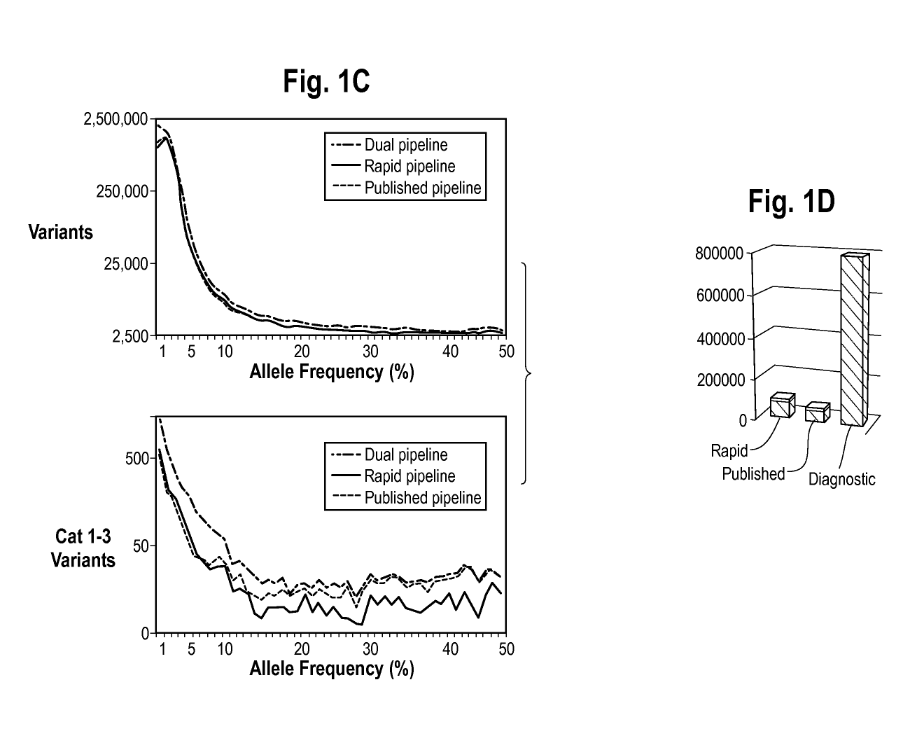

To rectify this phenomenon, a set of well supported, rare, potentially pathogenic bam⁺, vcf⁻ variants in disease genes were used to optimize genome sequencing pipeline components, versions and parameters for diagnostic sensitivity (See FIG. s3). As previously shown, GSNAP was modestly more sensitive than other aligners, particularly for insertion-deletion variants (indels, Table s1). The Published pipeline used public database variants to train a model (Variant Quality Score Recalibration, VQSR) that removed non-conforming variants. This is a common practice in WGS for population research, and reduces type 2 errors (β, false positives) in batched analyses of datasets from multiple sites, technologies, protocols and varied coverage, such as the 1,000 genomes project. As novel variants are, a priori, rare, and absent from public databases, this method introduces a bias against rare, novel variants. A Diagnostic pipeline was derived that genotyped all nucleotides and retained the exemplar variants in genome sequencing and exome sequences. It comprised GSNAP (version 2012.07.12, with default parameters) and GATK (version 1.6.13, without VQSR). The sensitivity of the Published and Diagnostic pipelines in three samples were compared with approximately 43 fold whole genome sequencing. The Published pipeline identified 3.8 million nucleotide variants in 2.9 billion genotyped nucleotides (92% of the reference genome, FIG. 1, Tables s1 above and s2 below). The Diagnostic pipeline was significantly more sensitive. It genotyped all genomic nucleotides, rather than just those with variants, and identified 24% (924,195) more variants than the Published method. The largest detected deletion and insertion were 93 nt and 100 nt, respectively. Of remarkable significance for the diagnosis of genetic diseases, however, was a greater (53%) increase in rare variants (minor allele frequency, MAF<0.01) identified in genome sequencing, especially those that were known or likely to cause genetic diseases (148% increase in variants of American College of Medical Genetics, ACMG, categories 1-3, FIG. 1, Tables s1 above and s2 below). In contrast, the results of analysis of batched exomes with both pipelines were almost identical (See Table s3 below).

TABLE s2

| | Fold | Data | # Called | Nuc | | |
|---|---|---|---|---|---|---|
| Description | Coverage | Source | bases | Diversity | SNVs | indels |
| NA18507 autosomes | 40 | Literature | 2,140,000,000 | | | |
| NA19239 autosomes | 29 | Literature | 2,110,000,000 | | | |
| NA12891 autosomes | 38 | Literature | 2,110,000,000 | | | |
| SJK autosomes | 20 | Literature | 2,130,000,000 | | | |
| YH autosomes | 30 | Literature | 2,190,000,000 | | | |
| CEU trio | 43 | Literature | 2,260,000,000 | 0.136% | 2,741,276 | 322,078 |
| YRI trio | 40 | Literature | 2,210,000,000 | 0.165% | 3,261,276 | 382,869 |
| 1KG trios | 42 | Literature | 2,240,000,000 | 0.150% | 3,001,156 | 352,474 |
| 44 genomes | 66 | Literature | n.d | | 3,307,678 | 492,486 |
| Duke 20 genomes | 31 | Literature | n.d | | 3,473,639 | 609,795 |
| Korean 10 genomes | 26 | Literature | n.d. | | 3,602,372 | 332,561 |
| NA12878 GIAB integrated truth | many | Literature | 2,336,800,532 | 0.138% | 2,917,387 | 316,706 |
| set | | | | | | |
| NA12878 1KG | | Literature | 2,333,566,439 | 0.086% | 2,002,646 | |
| NA12878 1kG SNV calls | 40 | Literature | 2,336,705,924 | 0.132% | 2,766,607 | 328,527 |
| NA12878 Samtools.1.12 | 40 | Literature | 2,336,705,924 | 0.159% | 3,343,333 | 373,543 |
| NA12878 GATK | 40 | Literature | 2,336,705,924 | 0.161% | 3,372,098 | 378,470 |
| UDT_173 Published, 26 hour | 44.8 | Herein | 2,857,395,318 | 0.139% | 3,243,903 | 740,092 |
| WGS | | | | | | |
| UDT_173 Rapid, 26 hour WGS | 44.8 | Herein | 2,744,502,370 | 0.135% | 3,354,741 | 360,514 |
| UDT_173 Diagnostic, 26 hour | 44.8 | Herein | 2,858,252,044 | 0.169% | 4,125,416 | 708,374 |
| WGS | | | | | | |
| UDT_173 Dual, 26 hour WGS | 44.8 | Herein | 2,858,345,315 | 0.172% | 4,173,922 | 753,088 |
| UDT_173 Published, 18 hour | 34.2 | Herein | 2,857,595,840 | 0.128% | 2,929,296 | 730,154 |
| WGS | | | | | | |
| UDT_173 Rapid, 18 hour WGS | 34.2 | Herein | 2,727,476,191 | 0.135% | 3,338,964 | 354,171 |
| UDT_173 Diagnostic, 18 hour | 34.2 | Herein | 2,858,227,218 | 0.172% | 4,221,078 | 696,128 |
| WGS | | | | | | |
| UDT_173 Dual, 18 hour WGS | 34.2 | Herein | 2,858,405,619 | 0.176% | 4,273,148 | 743,756 |
| NA12878 Published, 18 hour | 50.7 | Herein | 2,857,497,509 | 0.135% | 3,108,581 | 757,302 |
| WGS | | | | | | |
| NA12878 Rapid, 18 hour WGS | 50.7 | Herein | 2,673,895,493 | 0.139% | 3,341,430 | 364,359 |
| NA12878 Diagnostic, 18 hour | 50.7 | Herein | 2,858,208,756 | 0.159% | 3,833,384 | 697,534 |
| WGS | | | | | | |
| NA12878 Dua1, 18 hour WGS | 50.7 | Herein | 2,858,313,363 | 0.165% | 3,980,029 | 748,209 |
| Average of 91 research genomes | 37.4 | Literature | 2,236,191,134 | 0.148% | 3,196,943 | 388,951 |
| Average Published Pipeline (3 | 43.2 | Herein | 2,857,496,222 | 0.134% | 3,093,927 | 742,516 |
| genomes) | | | | | | |
| Average Rapid Pipeline (3 | 43.2 | Herein | 2,715,291,351 | 0.136% | 3,345,045 | 359,681 |
| genomes) | | | | | | |
| Average Diagnostic Pipeline (3 | 43.2 | Herein | 2,858,229,339 | 0.167% | 4,059,959 | 700,679 |
| genomes) | | | | | | |
| Average Dual Pipeline (3 | 43.2 | Herein | 2,358,354,766 | 0.171% | 4,142,366 | 748,351 |
| genomes) | | | | | | |
| Rapid - Published | | | −142,204,371 | 0.002% | 251,118 | −382,835 |
| Diagnostic - Published | | | 733,117 | 0.032% | 966,033 | −41,837 |
| Dual - Published | | | 858,543 | 0.037% | 1,048,440 | 5,835 |
| % Rapid - Published | | | −4.98% | 1.6% | 8.1% | −51.6% |
| % Diagnostic - Published | | | 0.03% | 24.1% | 31.2% | −5.6% |
| % Dual - Diagnostic | | | 0.03% | 2.7% | 2.0% | 6.6% |
| % Published Pipeline-91 research | | | 27.8% | −9.4% | −3.3% | 90.9% |
| genornes | | | | | | |
| % Dual - 91 research genomes | | | 27.8% | 15.4% | 29.5% | 92.4% |

| | | | | nt variant |
|---|---|---|---|---|
| | total nt | MAF <1% | | heterozygosity |
| Description | variants | variants | # Heterozygotes | (per kb) |
| NA18507 autosomes | | | 2,170,000 | 1.013 |
| NA19239 autosomes | | | 2,210,000 | 1.051 |
| NA12891 autosomes | | | 1,670,000 | 0.791 |
| SJK autosomes | | | 1,470,000 | 0.69 |
| YH autosomes | | | 1,520,000 | 0.694 |
| CEU trio | 3,063,354 | | | |
| YRI trio | 3,644,145 | | | |
| 1KG trios | 3,353,630 | | | |
| 44 genomes | 3,800,164 | | | |
| Duke 20 genomes | 4,083,434 | | | |
| Korean 10 genomes | 3,934,933 | | | |
| NA12878 GIAB integrated truth set | 3,234,093 | | 2,002,646 | 0.857 |
| NA12878 1KG | | | | |
| NA12878 1kG SNV calls | 3,095,134 | | | |
| NA12878 Samtools.1.12 | 3,716,876 | | 0.66 | 0.944 |
| NA12878 GATK | 3,750,568 | | 0.65 | 0.938 |
| UDT_173 Published, 26 hour WGS | 3,983,995 | | 2,318,594 | 0.811 |
| UDT_173 Rapid, 26 hour WGS | 3,715,255 | | 2,268,097 | 0.826 |
| UDT_173 Diagnostic, 26 hour WGS | 4,833,790 | | 3,048,975 | 1.067 |
| UDT_173 Dual, 26 hour WGS | 4,927,010 | | 3,129,662 | 1.095 |
| UDT_173 Published, 18 hour WGS | 3,659,450 | | 2,038,232 | 0.713 |
| UDT_173 Rapid, 18 hour WGS | 3,693,135 | | 2,269,733 | 0.832 |
| UDT_173 Diagnostic, 18 hour WGS | 4,917,206 | | 3,138,721 | 1.098 |
| UDT_173 Dual, 18 hour WGS | 5,016,904 | | 3,226,946 | 1.129 |
| NA12878 Published, 18 hour WGS | 3,865,883 | | 2,251,173 | 0.788 |
| NA12878 Rapid, 18 hour WGS | 3,705,789 | | 2,291,247 | 0.857 |
| NA12878 Diagnostic, 18 hour WGS | 4,530,918 | | 2,803,292 | 0.981 |
| NA12878 Dua1, 18 hour WGS | 4,728,238 | | 2,981,218 | 1.043 |
| Average of 91 research genomes | 3,587,894 | | | 0.872 |
| Average Published Pipeline (3 genomes) | 3,836,443 | 1,180,431 | 2,202,666 | 0.771 |
| Average Rapid Pipeline (3 genomes) | 3,704,726 | 1,036,672 | 2,276,359 | 0.838 |
| Average Diagnostic Pipeline (3 | 4,760,638 | 1,806,437 | 2,996,996 | 1.049 |
| genomes) | | | | |
| Average Dual Pipeline (3 genomes) | 4,890,717 | 1,904,129 | 3,112,609 | 1.089 |
| Rapid - Published | −131,716 | −143,759 | 73,693 | 0.07 |
| Diagnostic - Published | 924,195 | 626,006 | 794,330 | 0.28 |
| Dual - Published | 1,054,275 | 723,698 | 909,942 | 0.32 |
| % Rapid - Published | −3.4% | −12.2% | 3.3% | 8.8% |
| % Diagnostic - Published | 24.1% | 53% | 36% | 36% |
| % Dual - Diagnostic | 2.7% | 5.4% | 3.9% | 3.9% |
| % Published Pipeline - 91 research | 6.9% | | | −11.6% |
| genornes | | | | |
| % Dual - 91 research genomes | 36.3% | | | 24.8% |

| | | Category 4, | Category 1, | |
|---|---|---|---|---|
| | Accessible | MAF <1% | MAF <1% | Category 2, |
| Description | genome | variants | variants | MAF <1% variants |
| NA18507 autosomes | 69% | | | |
| NA19239 autosomes | 68% | | | |
| NA12891 autosomes | 68% | | | |
| SJK autosomes | 69% | | | |
| YR autosomes | 71% | | | |
| CEU trio | 73% | | | |
| YRI trio | 71% | | | |
| 1KG trios | 72% | | | |
| 44 genomes | | | | |
| Duke 20 genomes | | | | |
| Korean 10 genomes | | | | |
| NA12878 GIAB integrated truth set | 75% | | | |
| NA12878 1KG | 75% | | | |
| NA12878 1kG SNV calls | 75% | | | |
| NA12878 Samtools.1.12 | 75% | | | |
| NA12878 GATK | 75% | | | |
| UDT_173 Published, 26 hour WGS | 92% | 1,173,776 | 7 | 52 |
| UDT_173 Rapid, 26 hour WGS | 89% | 984,254 | 7 | 40 |
| UDT_173 Diagnostic, 26 hour WGS | 92% | 1,771,440 | 9 | 82 |
| UDT_173 Dual, 26 hour WGS | 92% | 1,852,353 | 9 | 95 |
| UDT_173 Published, 18 hour WGS | 92% | 1,178,654 | 7 | 44 |
| UDT_173 Rapid, 18 hour WGS | 88% | 1,091,595 | 7 | 36 |
| UDT_173 Diagnostic, 18 hour WGS | 92% | 2,048,222 | 8 | 82 |
| UDT_173 Dual, 18 hour WGS | 92% | 2,131,545 | 8 | 93 |
| NA12878 Published, 18 hour WGS | 92% | 1,187,321 | 10 | 36 |
| NA12878 Rapid, 18 hour WGS | 86% | 1032342 | 10 | 40 |
| NA12878 Diagnostic, 18 hour WGS | 92% | 1,595,818 | 12 | 66 |
| NA12878 Dua1, 18 hour WGS | 92% | 1,724,349 | 12 | 81 |
| Average of 91 research genomes | 72% | | | |
| Average Published Pipeline (3 genomes) | 92% | 1,179,917 | 8 | 44 |
| Average Rapid Pipeline (3 genomes) | 88% | 1,036,064 | 8 | 39 |
| Average Diagnostic Pipeline (3 | 92% | 1,805,160 | 10 | 77 |
| genomes) | | | | |
| Average Dual Pipeline (3 genomes) | 92% | 1,902,749 | 10 | 90 |
| Rapid - Published | −5% | −143,853 | 0 | −5 |
| Diagnostic - Published | 0% | 625,243 | 2 | 33 |
| Dual - Published | 0% | 722,332 | 2 | 46 |
| % Rapid - Published | −5% | −12.2% | 0.0% | −12.1% |
| % Diagnostic - Published | 0% | 53% | 21% | 74% |
| % Dual - Diagnostic | 0% | 5.4% | 0.0% | 17.0% |
| % Published Pipeline - 91 research | 28% | | | |
| genornes | | | | |
| % Dual - 91 research genomes | 28% | | | |

| | Category 3, | | | | |
|---|---|---|---|---|---|
| | MAF <1% | Cat 1-3 | | Ti/Tv | Ti/Tv |
| Description | variants | MAF <1% | Ti/Tv all | MAF <1% | MAF <1% |
| NA18507 autosomes | | | | | |
| NA19239 autosomes | | | | | |
| NA12891 autosomes | | | | | |
| SJK autosomes | | | | | |
| YH autosomes | | | | | |
| CEU trio | | | | | |
| YRI trio | | | | | |
| 1KG trios | | | | | |
| 44 genomes | | | | | |
| Duke 20 genomes | | | | | |
| Korean 10 genomes | | | | | |
| NA12878 GIAB integrated truth set | | | | | |
| NA12878 1KG | | | | | |
| NA12878 1kG SNV calls | | | | | |
| NA12878 Samtools.1.12 | | | | | |
| NA12878 GATK | | | | | |
| UDT_173 Published, 26 hour WGS | 458 | 517 | 2.13 | 2.02 | 2.16 |
| UDT_173 Rapid, 26 hour WGS | 532 | 579 | 2.18 | 2.10 | 2.20 |
| UDT_173 Diagnostic, 26 hour WGS | 1120 | 1211 | 1.94 | 1.65 | 2.13 |
| UDT_173 Dual, 26 hour WGS | 1195 | 1299 | 1.93 | 1.64 | 2.13 |
| UDT_173 Published, 18 hour WGS | 460 | 511 | 2.28 | 2.28 | 2.28 |
| UDT_173 Rapid, 18 hour WGS | 605 | 648 | 2.18 | 2.10 | 2.21 |
| UDT_173 Diagnostic, 18 hour WGS | 1557 | 1647 | 1.91 | 1.63 | 2.15 |
| UDT_173 Dual, 18 hour WGS | 1649 | 1750 | 1.90 | 1.62 | 2.15 |
| NA12878 Published, 18 hour WGS | 469 | 515 | 2.23 | 2.22 | 2.23 |
| NA12878 Rapid, 18 hour WGS | 548 | 598 | 2.18 | 2.11 | 2.21 |
| NA12878 Diagnostic, 18 hour WGS | 896 | 974 | 2.07 | 1.85 | 2.18 |
| NA12878 Dua1, 18 hour WGS | 999 | 1092 | 2.03 | 1.81 | 2.15 |
| Average of 91 research genomes | | | | | |
| Average Published Pipeline (3 genomes) | 462 | 514 | 2.21 | 2.17 | 2.22 |
| Average Rapid Pipeline (3 genomes) | 562 | 608 | 2.13 | 2.11 | 2.21 |
| Average Diagnostic Pipeline (3 | 1,191 | 1,277 | 1.97 | 1.71 | 2.15 |
| genomes) | | | | | |
| Average Dual Pipeline (3 genomes) | 1,281 | 1,380 | 1.96 | 1.69 | 2.14 |
| Rapid - Published | 99 | 94 | | | |
| Diagnostic - Published | 729 | 763 | | | |
| Dual - Published | 819 | 866 | | | |
| % Rapid - Published | 21.5% | 18.3% | | | |
| % Diagnostic - Published | 158% | 148% | | | |
| % Dual - Diagnostic | 7.6% | 8.1% | | | |
| % Published Pipeline - 91 research | | | | | |
| genornes | | | | | |
| % Dual - 91 research genomes | | | | | |

| | # heterozygotes Cat. | # heterozygotes | # heterozygotes |
|---|---|---|---|
| Description | 3 MAF <1% | Cat. 2 MAF <1% | Cat. 1 MAF <1% |
| NA18507 autosomes | | | |
| NA19239 autosomes | | | |
| NA12891 autosomes | | | |
| SJK autosomes | | | |
| YH autosomes | | | |
| CEU trio | | | |
| YRI trio | | | |
| 1KG trios | | | |
| 44 genomes | | | |
| Duke 20 genomes | | | |
| Korean 10 genomes | | | |
| NA12878 GIAB integrated truth set | | | |
| NA12878 1KG | | | |
| NA12878 1kG SNV calls | | | |
| NA12878 Samtools.1.12 | | | |
| NA12878 GATK | | | |
| UDT_173 Published, 26 hour WGS | 431 | 47 | 6 |
| UDT_173 Rapid, 26 hour WGS | 514 | 39 | 6 |
| UDT_173 Diagnostic, 26 hour WGS | 1000 | 71 | 8 |
| UDT_173 Dual, 26 hour WGS | 1072 | 84 | 8 |
| UDT_173 Published, 18 hour WGS | 418 | 41 | 5 |
| UDT_173 Rapid, 18 hour WGS | 581 | 35 | 6 |
| UDT_173 Diagnostic, 18 hour WGS | 1362 | 77 | 6 |
| UDT_173 Dual, 18 hour WGS | 1458 | 88 | 6 |
| NA12878 Published, 18 hour WGS | 433 | 31 | 10 |
| NA12878 Rapid, 18 hour WGS | 538 | 37 | 10 |
| NA12878 Diagnostic, 18 hour WGS | 823 | 57 | 12 |
| NA12878 Dua1, 18 hour WGS | 917 | 69 | 12 |
| Average of 91 research genomes | | | |
| Average Published Pipeline (3 genomes) | 427 | 40 | 7 |
| Average Rapid Pipeline (3 genomes) | 544 | 37 | 7 |
| Average Diagnostic Pipeline (3 | 1062 | 68 | 9 |
| genomes) | | | |
| Average Dual Pipeline (3 genomes) | 1149 | 80 | 9 |
| Rapid - Published | | | |
| Diagnostic - Published | | | |
| Dual - Published | | | |
| % Rapid - Published | | | |
| % Diagnostic - Published | | | |
| % Dual - Diagnostic | | | |
| % Published Pipeline - 91 research | | | |
| genornes | | | |
| % Dual - 91 research genomes | | | |

Table s2 is a comparison of sensitivity and specificity of nucleotide variant genotypes of 18- and 26-hour 2×100 cycle HiSeq 2500 genome sequencing of samples UDT_173 and NA12878 with four alignment methods and three variant calling methods. In the Published pipeline, variants were identified and genotyped with the sensitive Genomic Short-read Nucleotide Alignment Program (GSNAP) and the Genome Analysis Tool Kit (GATK) best practices. The Diagnostic pipeline is the novel combination of methods that were developed to cure rare variant loss (GSNAP version 2012.07.12, with default parameters, and GATK version 1.6.13, without Variant Quality Score Recalibration). BWA is the Burrows-Wheeler algorithm, version 0.6.2. Correct genotypes (Truth Set) for sample UDT_173 were from hybridization to the Omni4 SNV array. Correct genotypes for NA12878 were from ftp://ftp-trace.ncbi.nih.gov/giab/ftp/data/NA12878/variant_calls/NIST. Portion a of Table s2 shows four comparisons of the sensitivity and specificity of variant genotypes of GATK with and without VQSR in sample UDT_173. The comparisons feature two alternative HiSeq 2500 genome sequencing run times and two short-read alignment algorithms (GSNAP and BWA). Portion b of Table s2 compares of the sensitivity and specificity of four genome sequencing alignment and variant calling pipelines in three samples. The four were the Published pipeline, the Diagnostic pipeline, a Rapid pipeline (iSAAC 01.13.01.31 and starling 2.0.2, respectively), and the superset of those methods (Dual pipeline) Portion c of Table s2 is a pairwise comparisons of three alignment algorithms (GSNAP, BWA and CASAVA), showing the overlap of variant calls following application of the GATK.

TABLE s3

| sample | TP | FN | FP | TN | total | sens. | spec. |
|---|---|---|---|---|---|---|---|
| | Published Pipeline | | | | | | |
| NA12753.Exomes_Nex_Pool_64_ExpEx | 26816 | 2042 | 624 | 67749 | 94565 | 92.9% | 99.1% |
| NA12753.CMH_Exonnes_Pool_64 | 27452 | 1406 | 446 | 67113 | 94565 | 95.1% | 99.3% |
| NA07019.CMH_Exomes_Nex_Pool_64_ExpEx | 7959 | 744 | 342 | 41354 | 49313 | 91.5% | 99.2% |
| NA07019.CMH_Exomes_Pool_64 | 7978 | 725 | 343 | 41335 | 49313 | 91.7% | 99.2% |
| UDT_173.exome | 24190 | 3311 | 950 | 103663 | 127853 | 88.0% | 99.1% |
| Average | | | | | | 91.8% | 99.2% |
| | Diagnostic Pipeline | | | | | | |
| NA12753.Exomes_Nex_Pool_64_ExpEx | 26864 | 1994 | 651 | 67701 | 94565 | 93.1% | 99.0% |
| NA12753.CMH_Exonnes_Pool_64 | 27488 | 1370 | 470 | 67077 | 94565 | 95.3% | 99.3% |
| NA07019.CMH_Exomes_Nex_Pool_64_ExpEx | 7984 | 719 | 370 | 41329 | 49313 | 91.7% | 99.1% |
| NA07019.CME_Exomes_Pool_64 | 7997 | 706 | 370 | 41316 | 49313 | 91.9% | 99.1% |
| UDT_173.exome | 24201 | 3300 | 953 | 103652 | 127853 | 88.0% | 99.1% |
| Average | | | | | | 92.0% | 99.1% |

FN = in OMNI4 SNP array data only
FP = in seq data only
TP = in seq and chip data
TN = in chip set but not called in chip data or seq

Table s3 is a comparison of sensitivity and specificity of nucleotide variant genotypes of exomes, analyzed in batches of 12 (Illumina TruSeq panel enrichment, 8 GB, 2×100 cycles HiSeq 2500), with OMNI SNP array results.

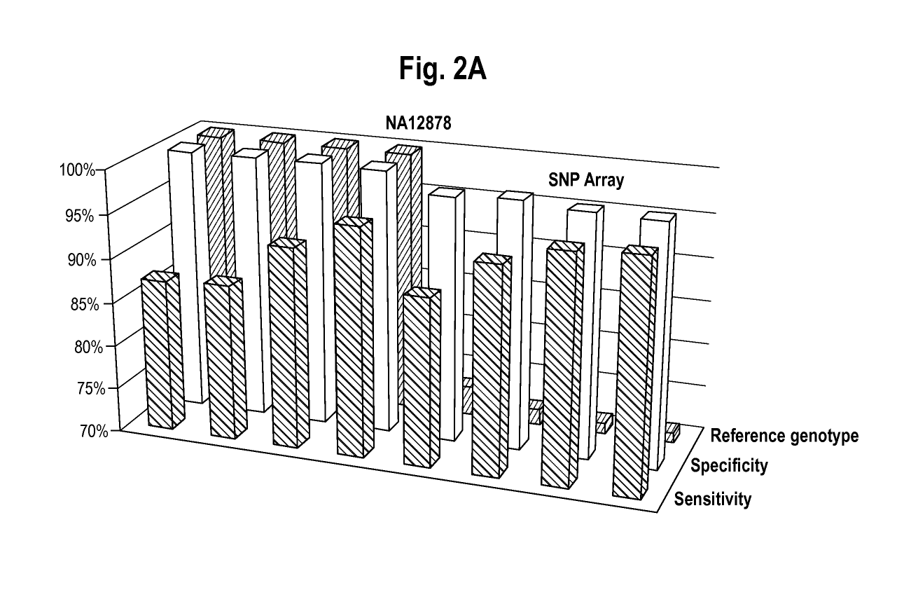

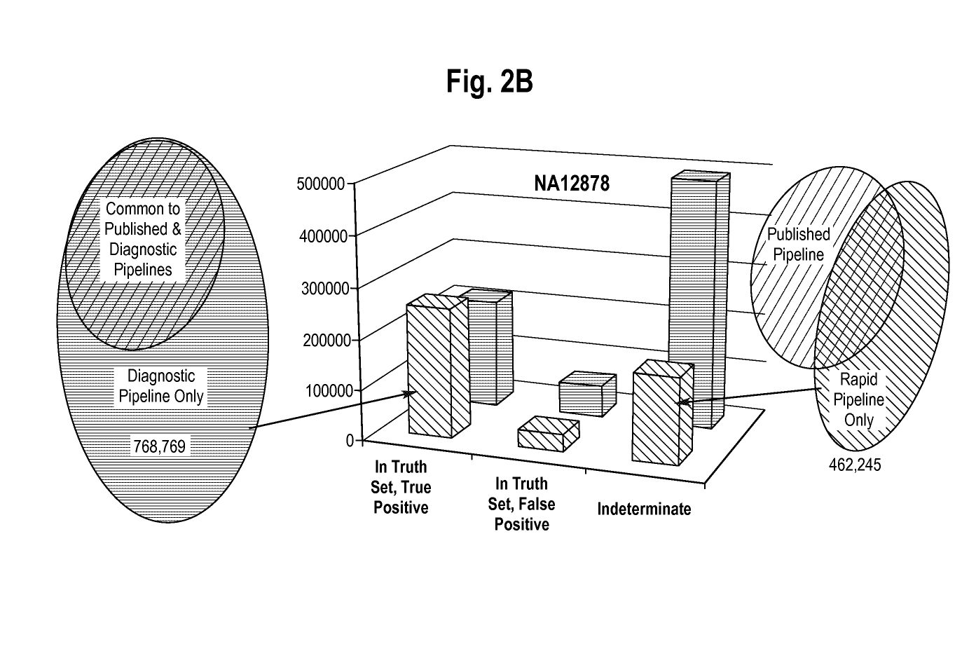

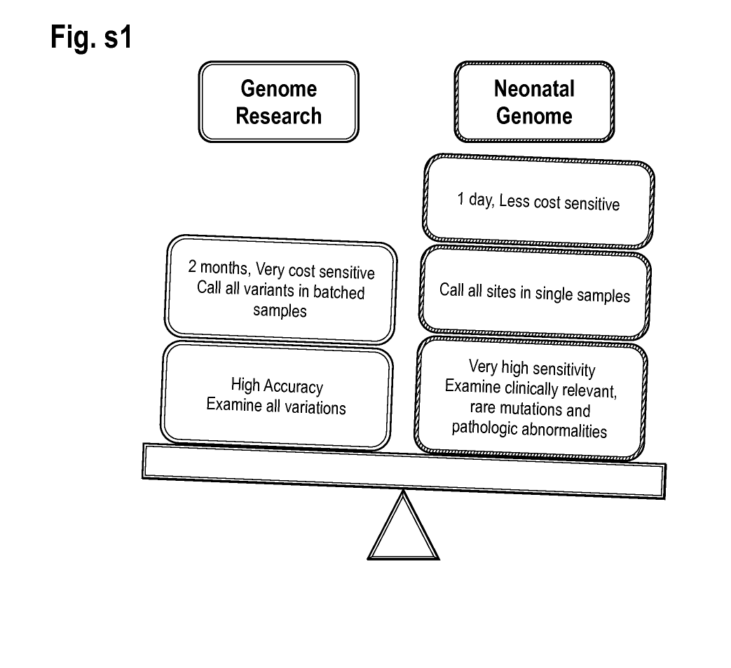

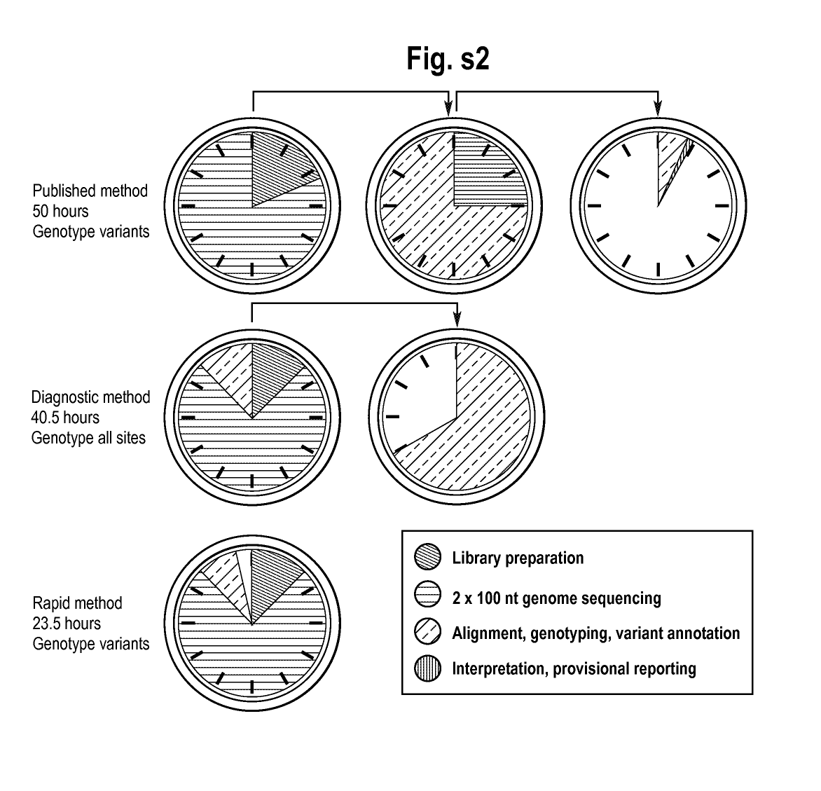

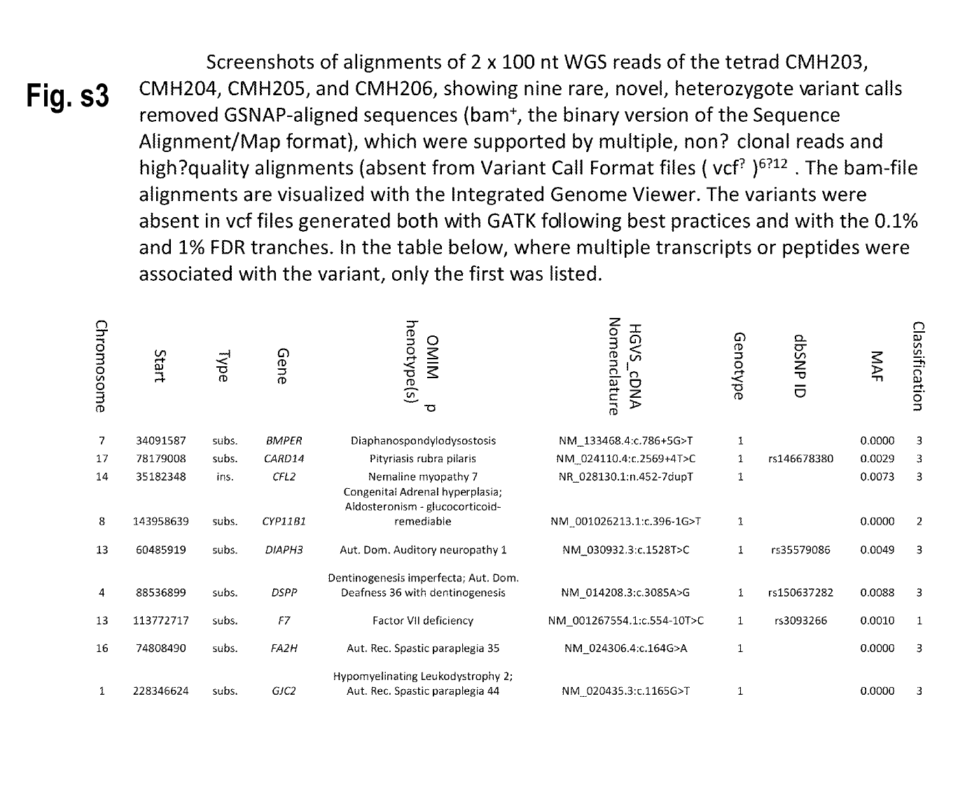

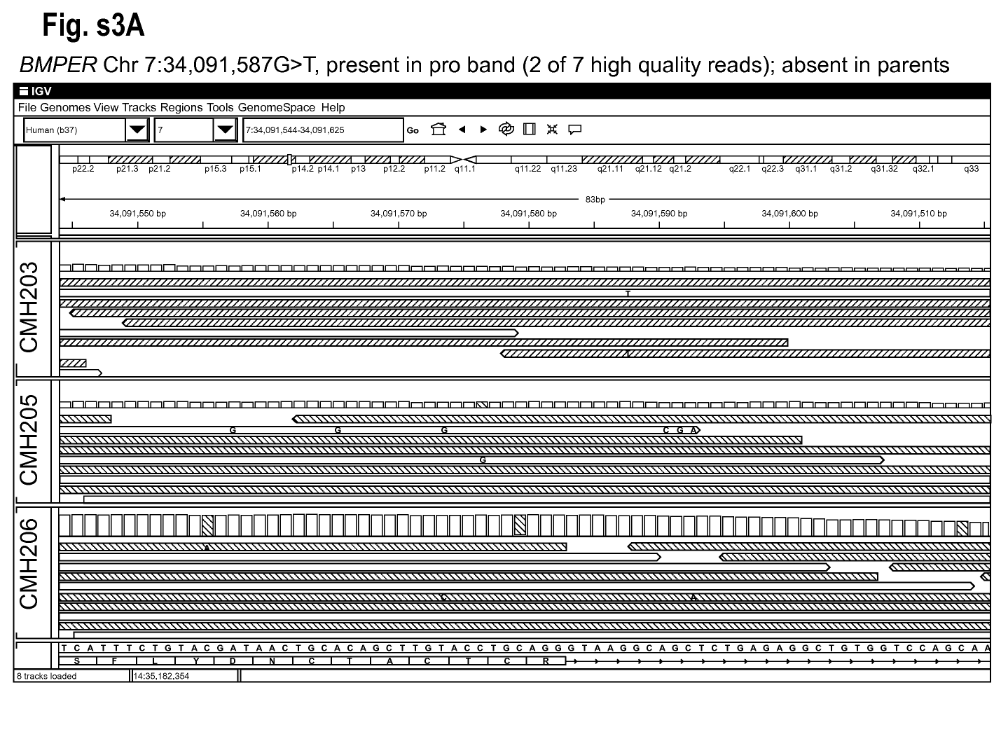

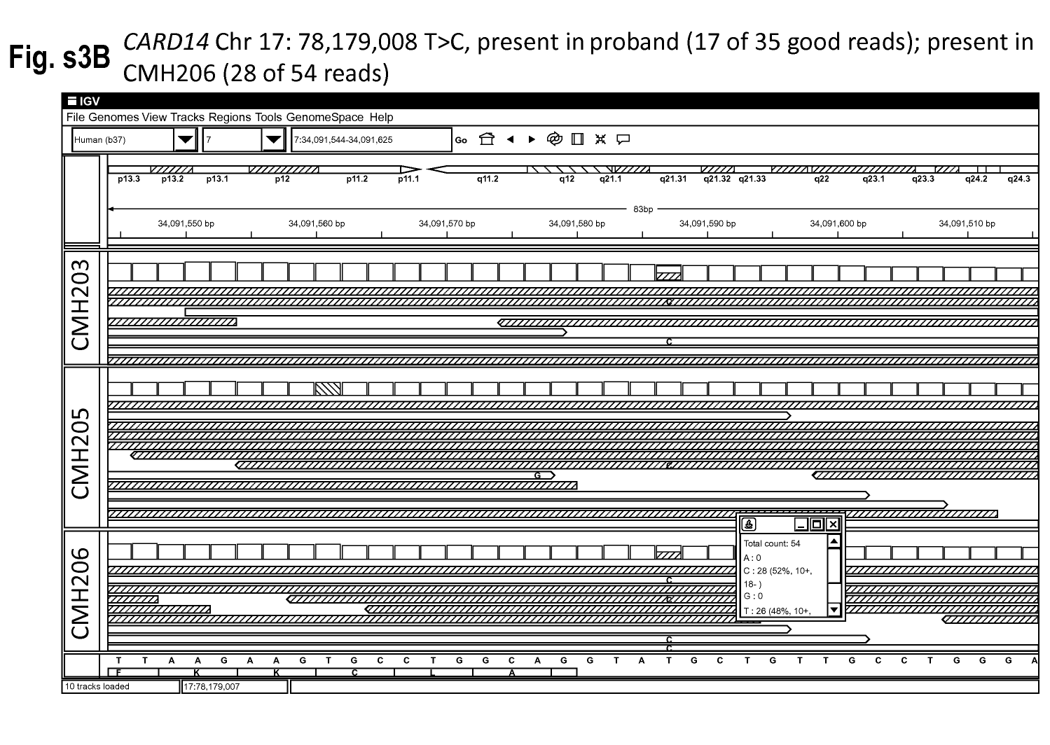

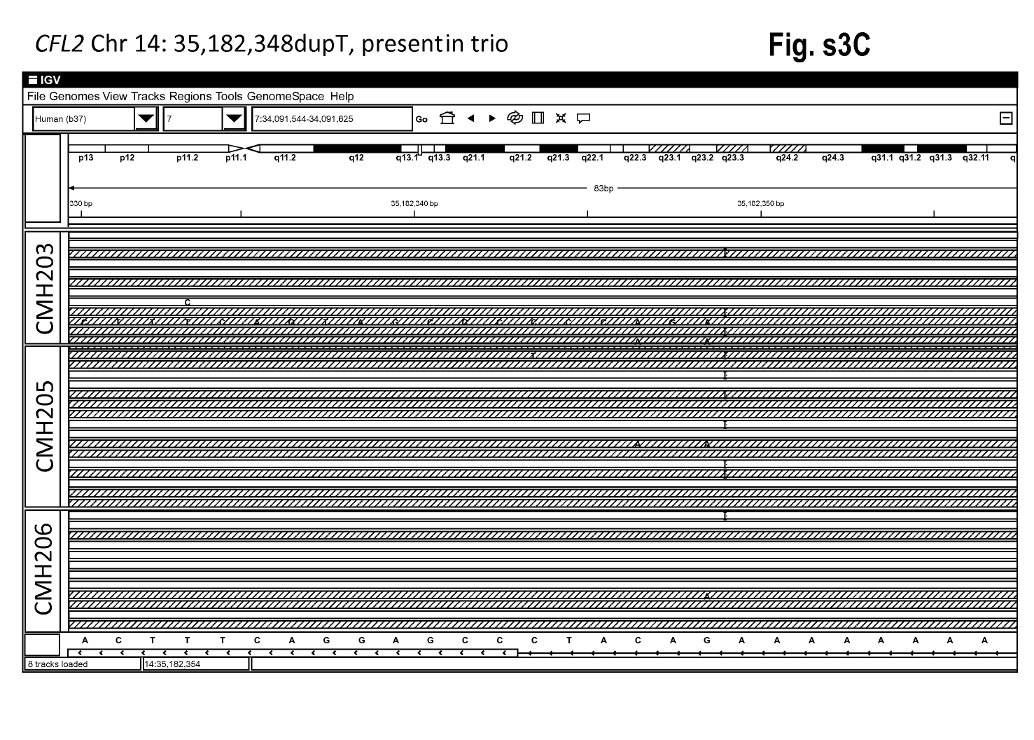

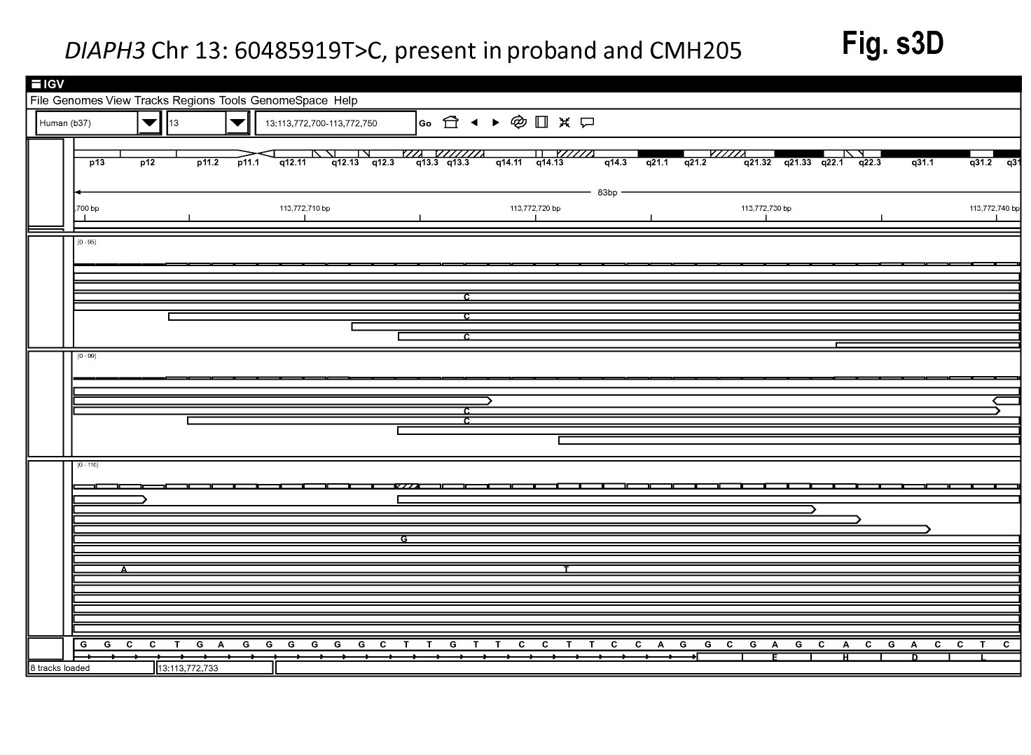

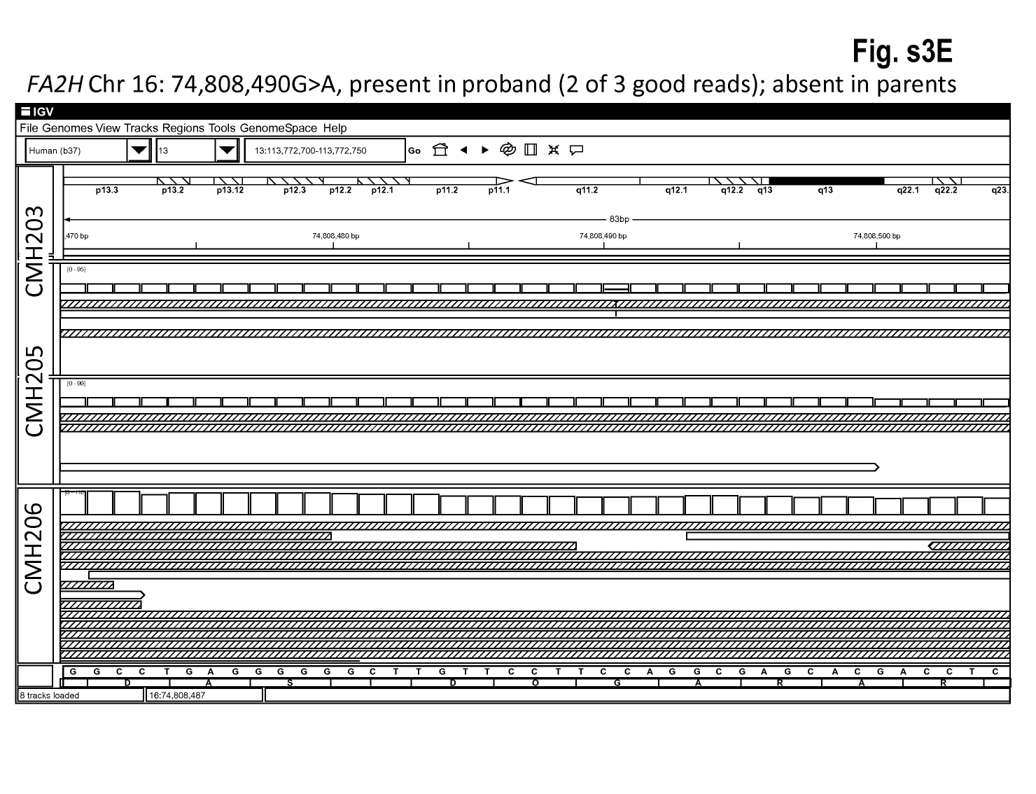

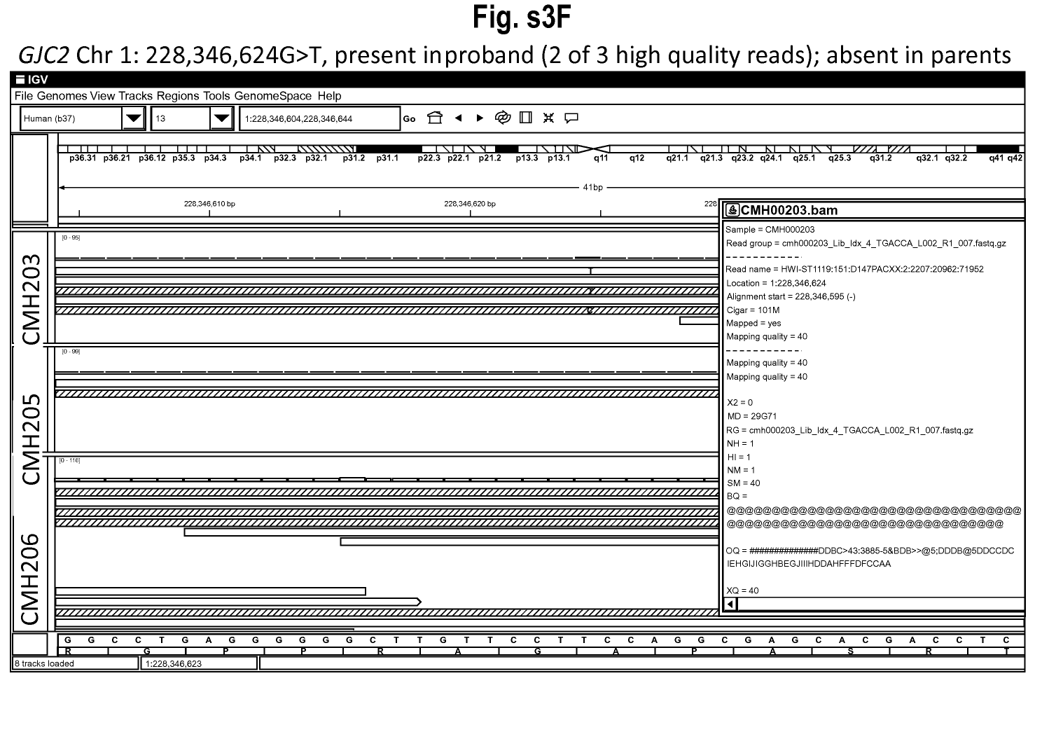

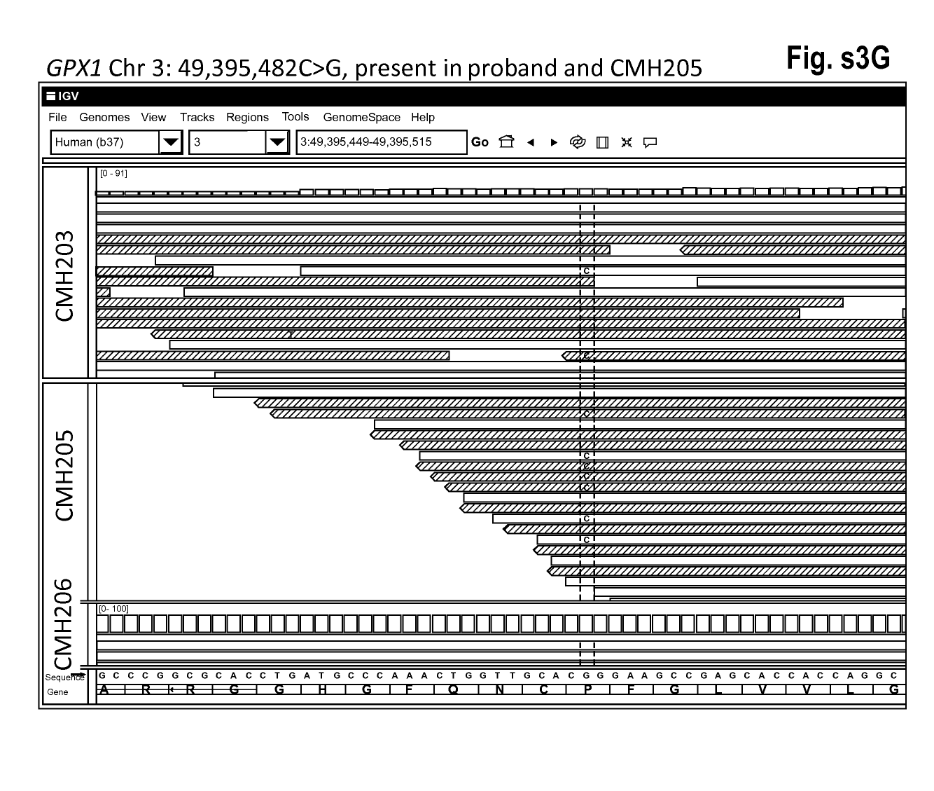

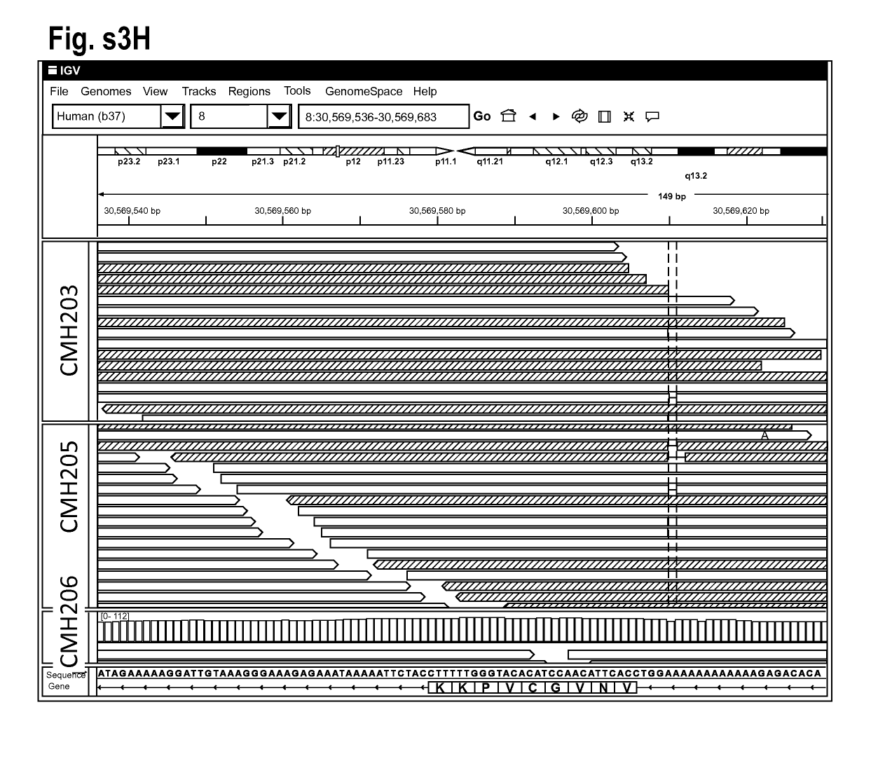

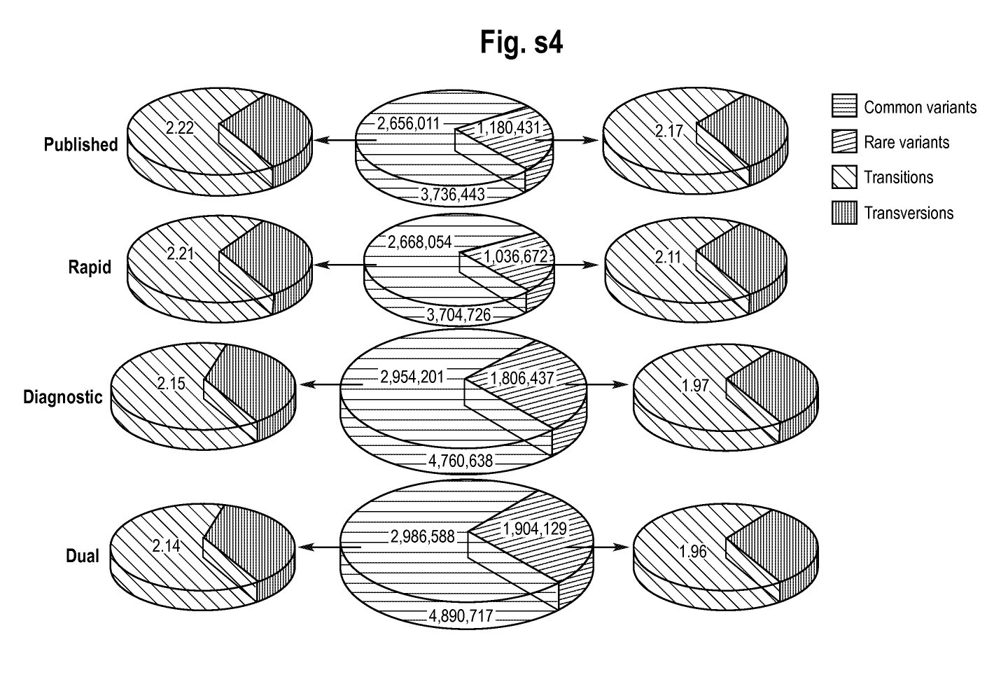

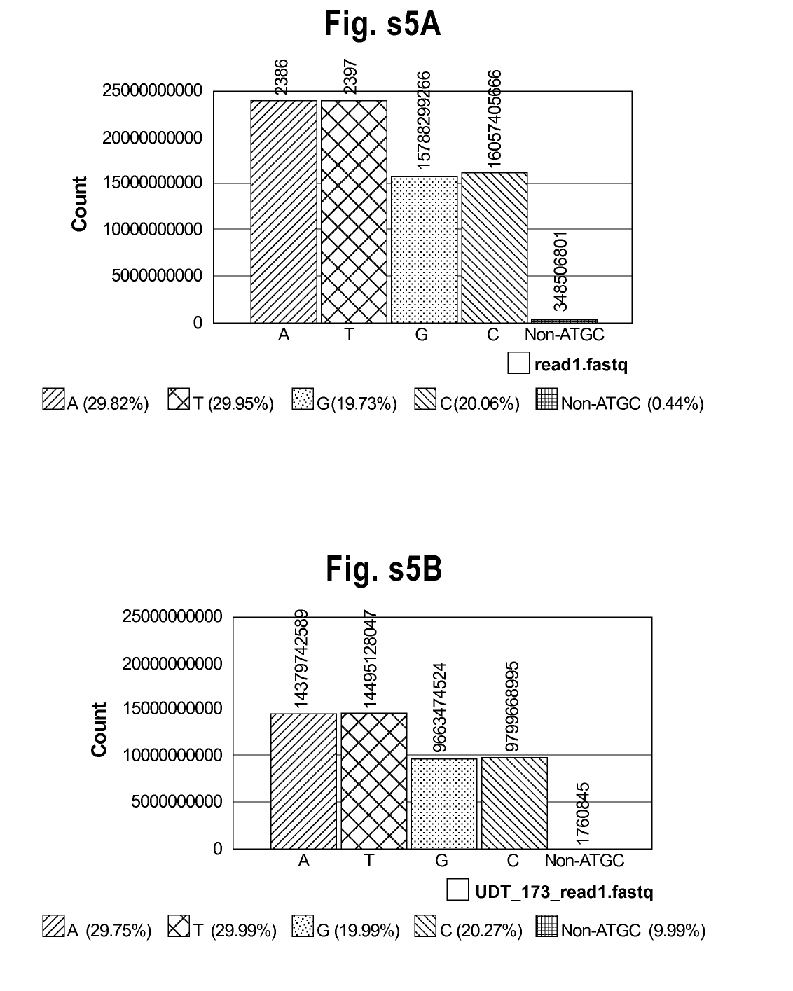

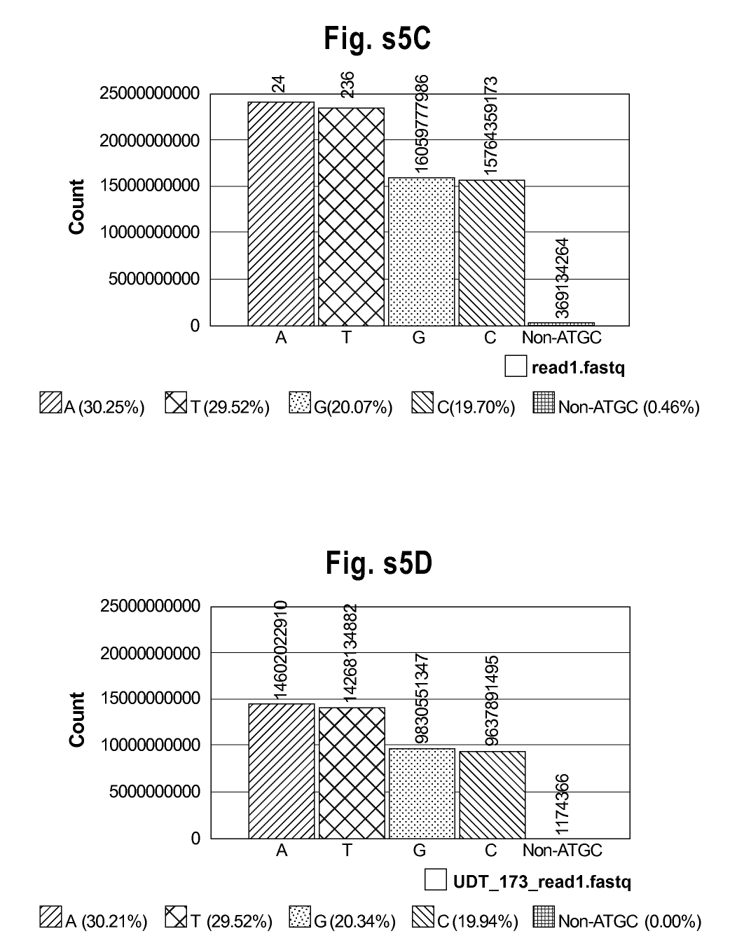

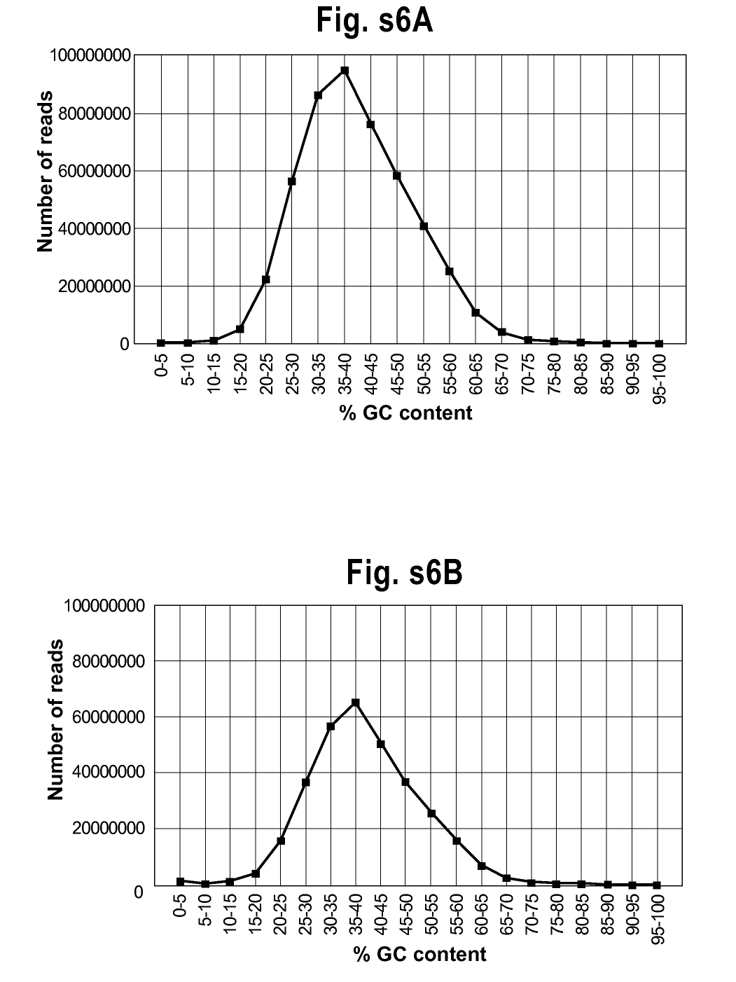

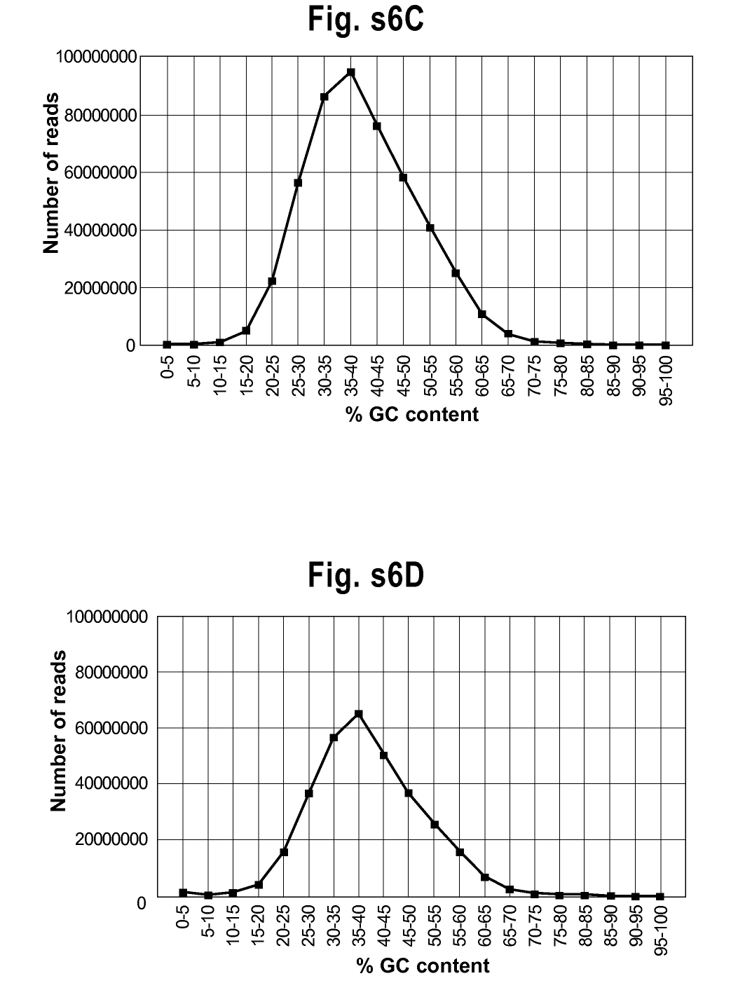

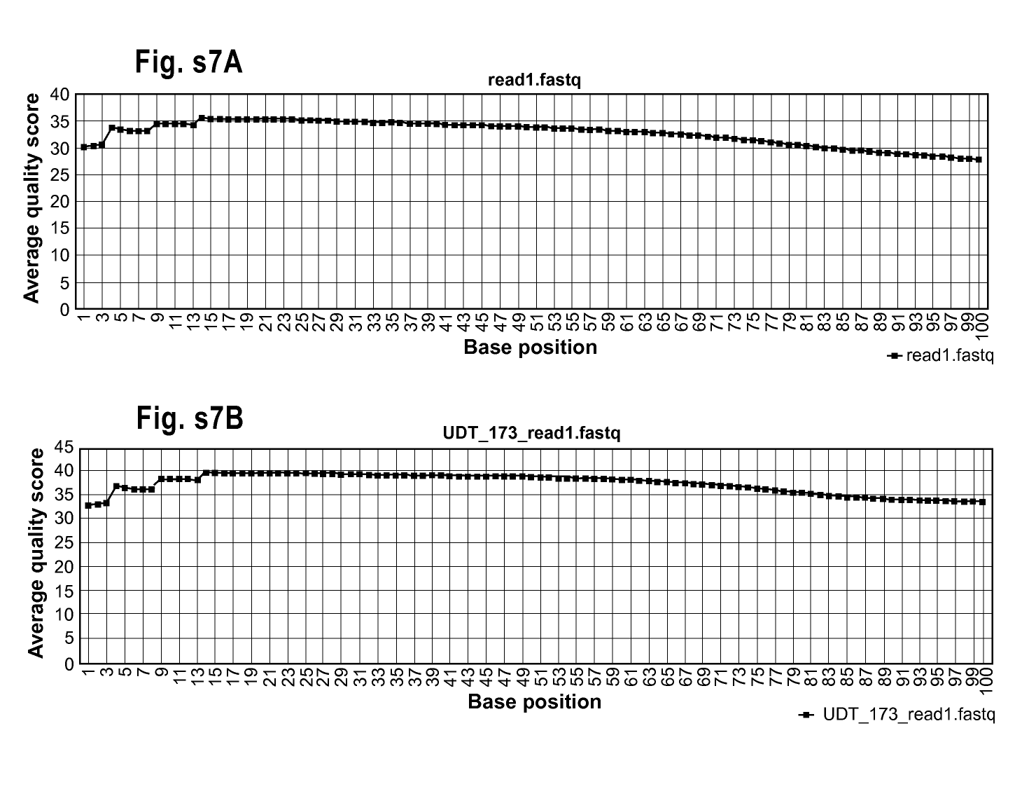

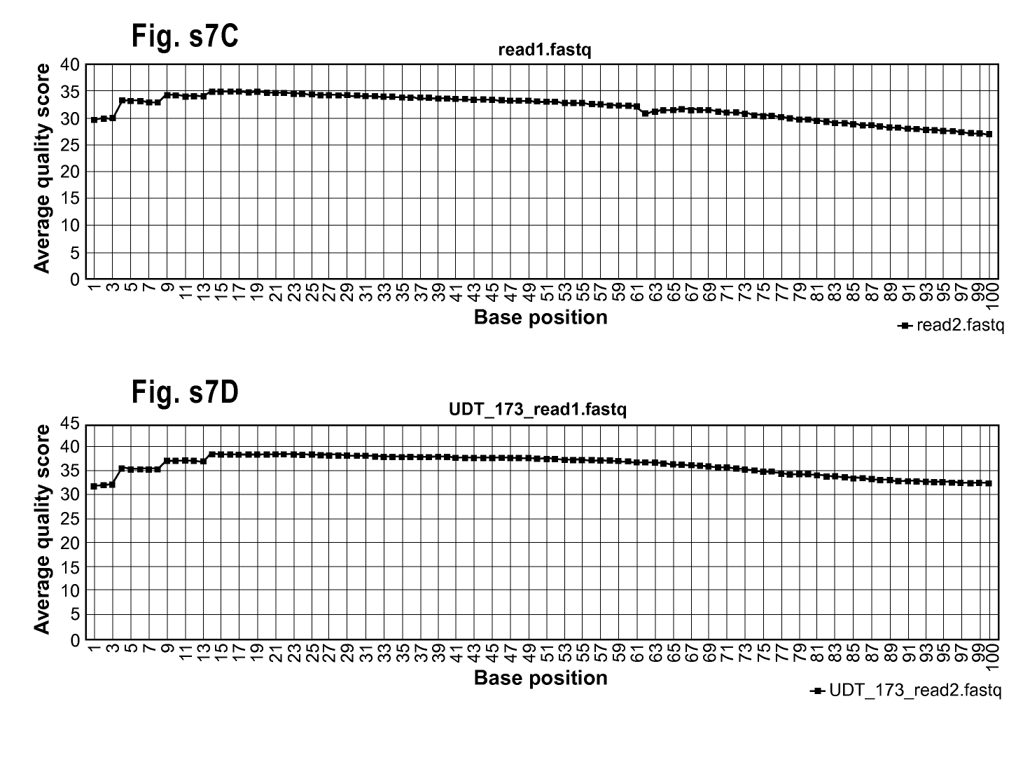

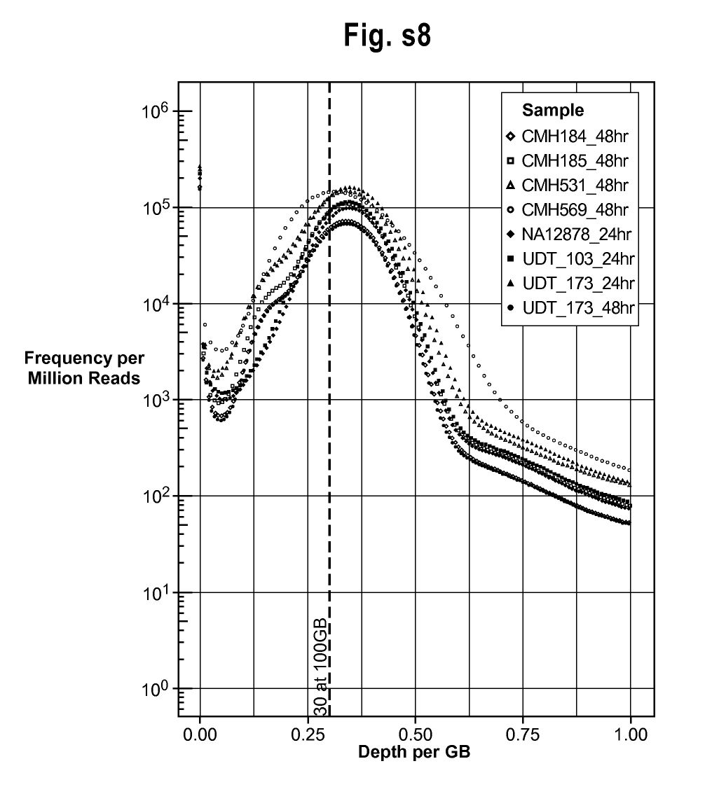

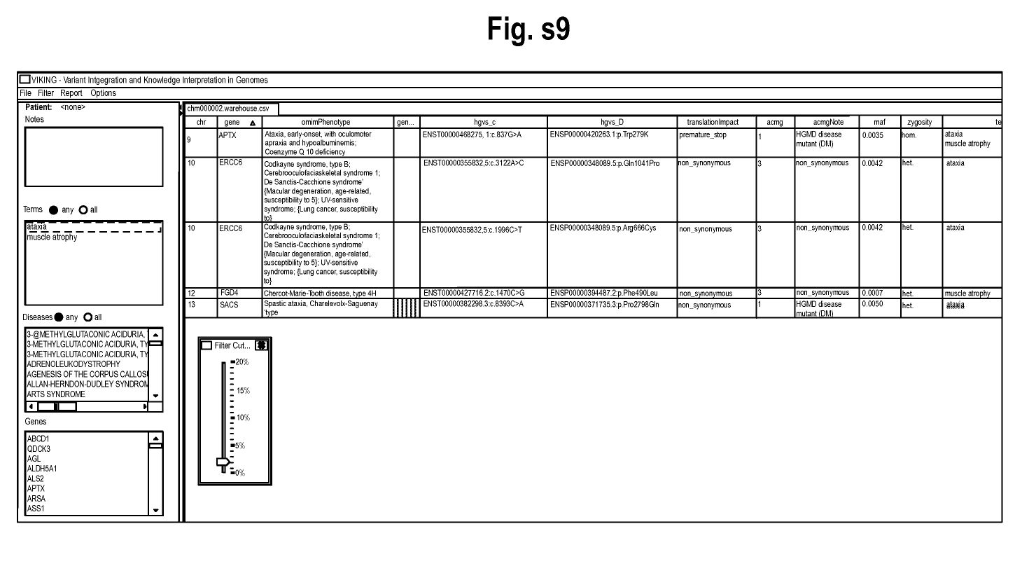

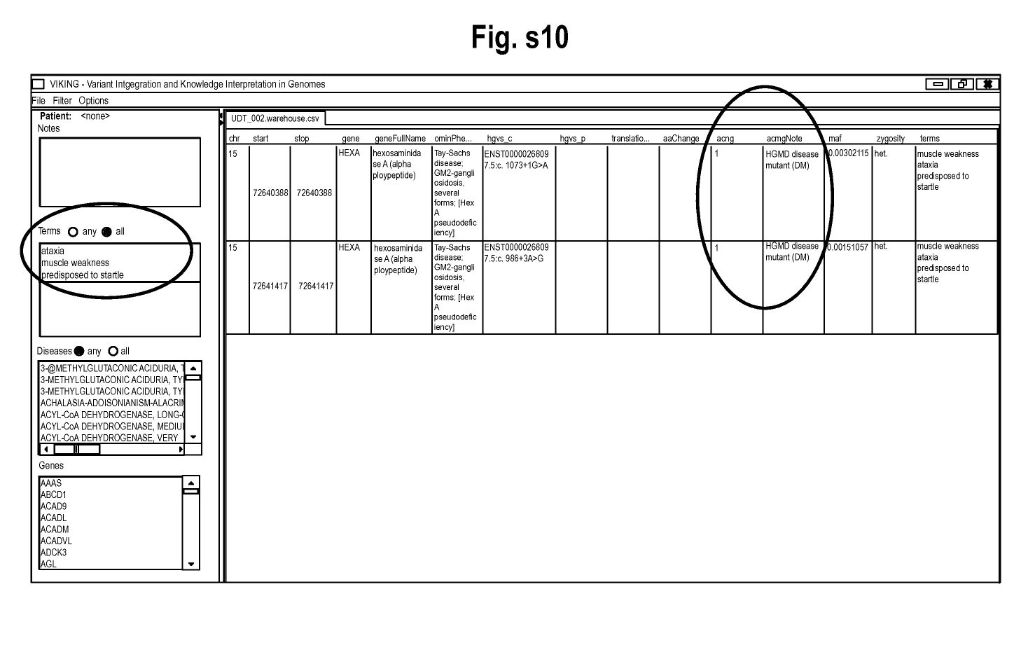

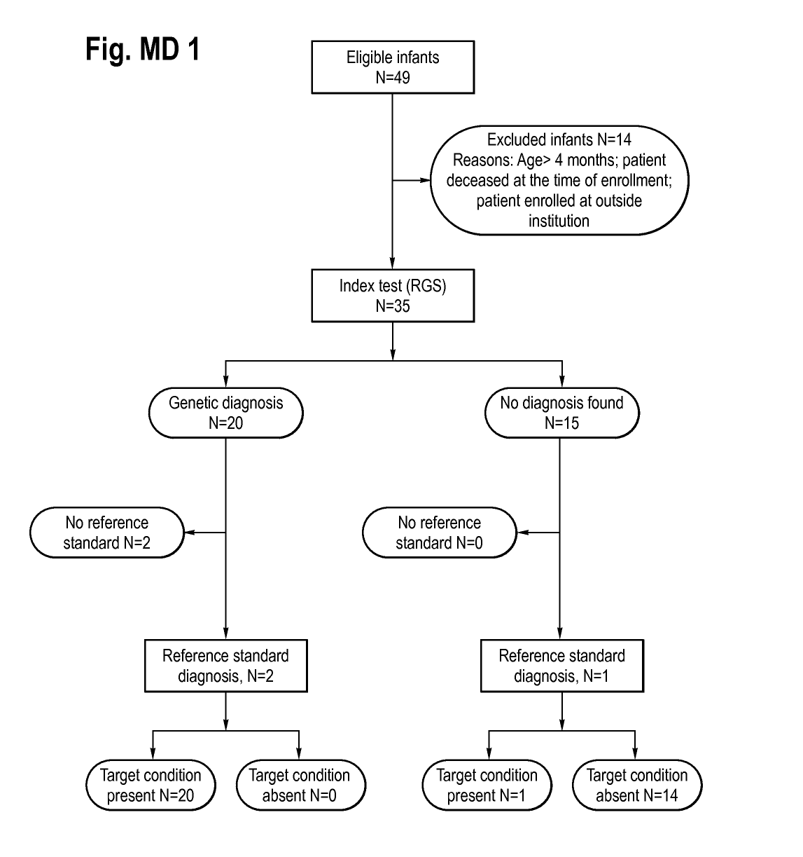

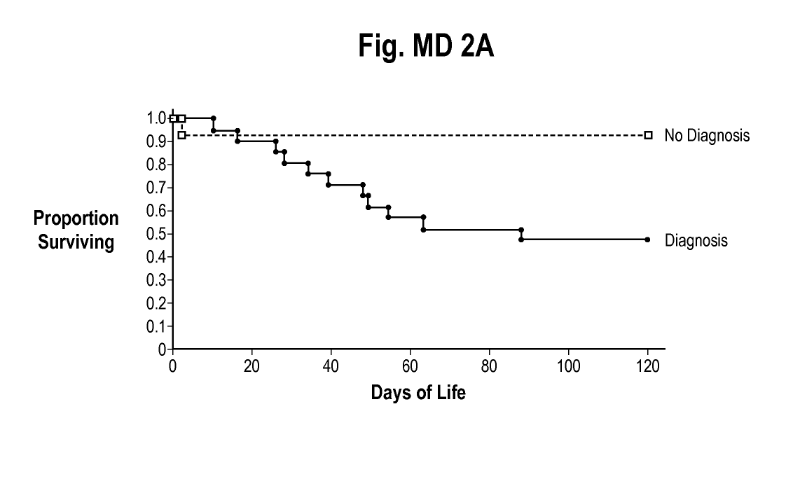

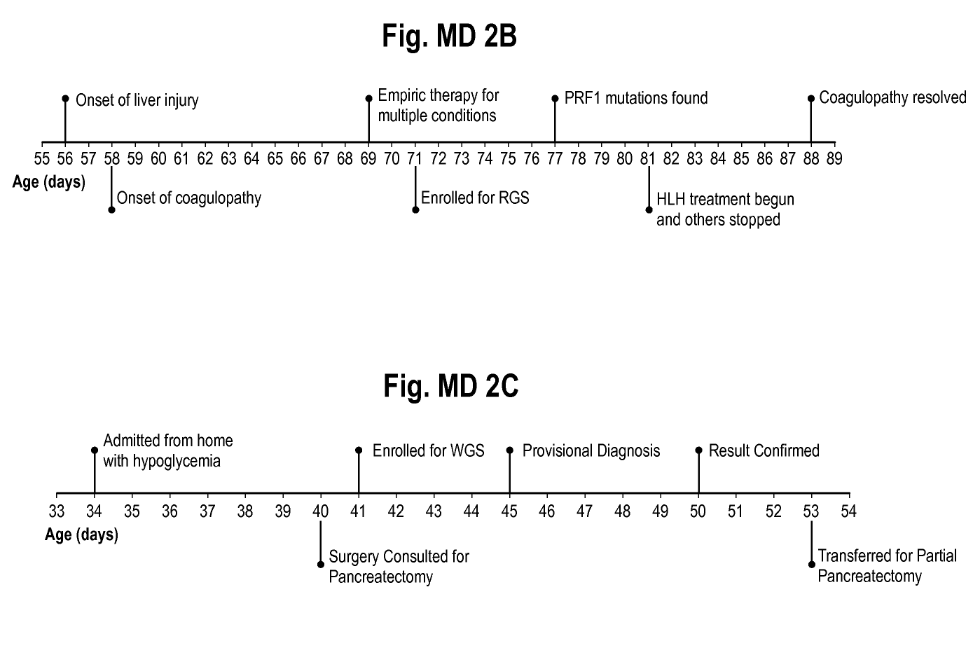

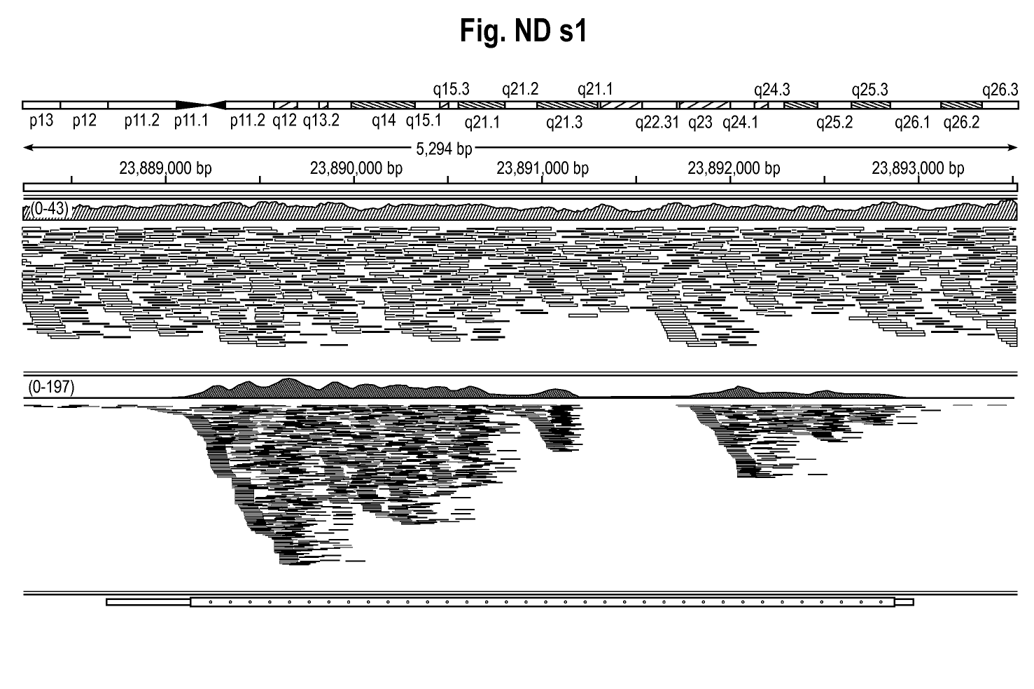

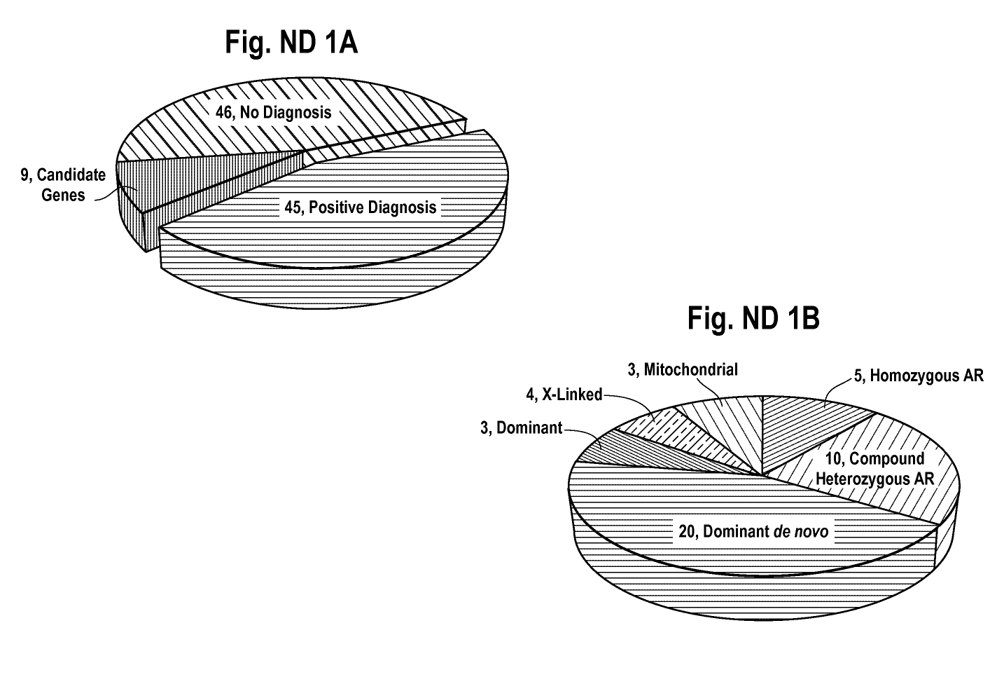

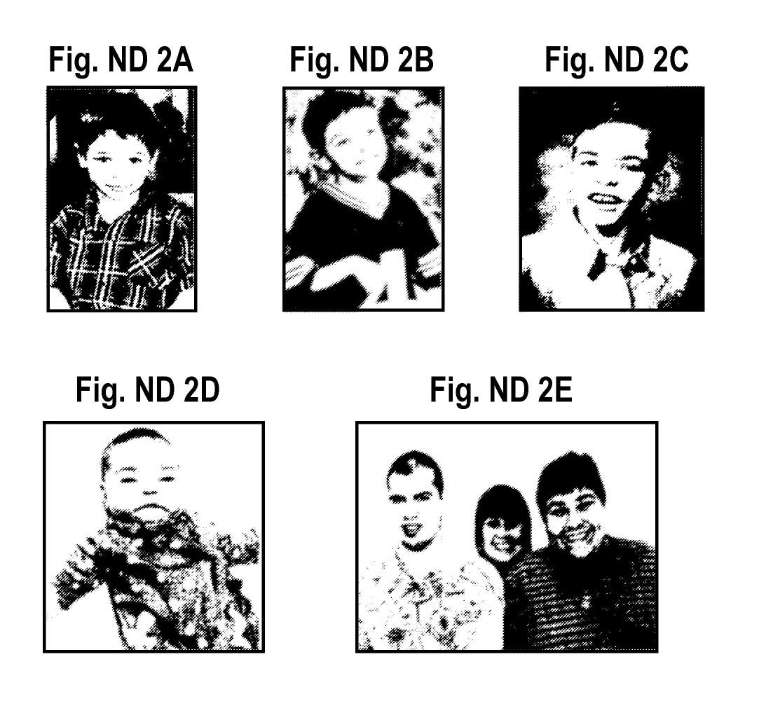

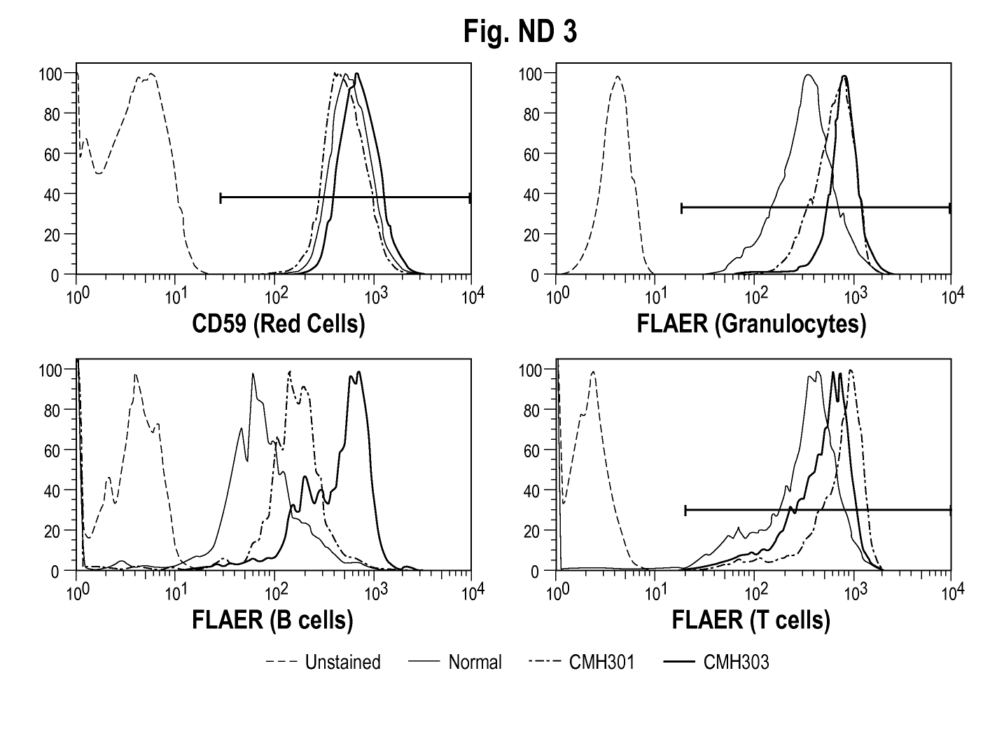

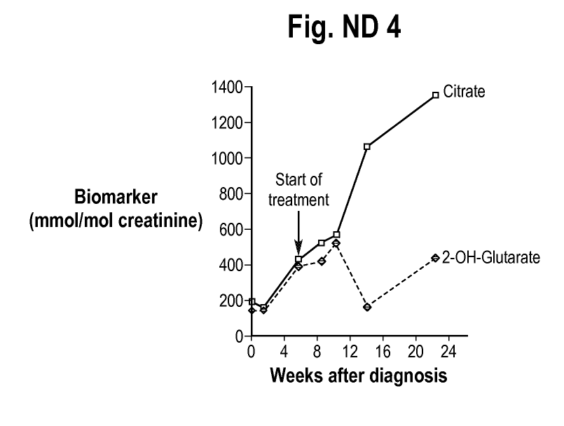

The specificity of the pipelines in the same samples were compared. Genome-wide array genotypes of common single nucleotide polymorphisms (SNPs) are frequently used for calibration of genome sequencing variant calls. The Diagnostic pipeline had 4.9% greater sensitivity for highly polymorphic SNP genotypes than the Published pipeline, while increasing false positives by only 0.17% (FIG. 2, Tables s1, s2). This result was reproducible, and independent of alignment algorithm. Thus, when applied to deep genome sequencing of single samples, the Diagnostic pipeline had a more suitable balance of sensitivity and specificity for common SNPs.

When used to benchmark genome sequencing, common SNP arrays can overestimate true genotype sensitivity and underestimate accuracy. Therefore, the sensitivity and accuracy of the pipelines in 47 whole fold genome sequencing of a European female (NA12878) were compared for whom there is an accurate consensus set of 2.3 billion genotypes. The Diagnostic pipeline yielded 17% more genotypes than the Published method. 28% of the added genotypes were in the consensus set and correct, while 8.2% were present and incorrect (See FIG. 2, Tables s1 and s2). Genome-wide, the specificity of the Diagnostic pipeline was 99.99%, and the proportionate increase in false positives was inconsequential (<0.01%). The apparent disparity between the decrement in accuracy in the NA12878 consensus set and SNP array results (<0.01% and 0.17%, respectively) reflected differences in the proportion of assayed nucleotides with reference genotypes (See FIG. 2). The ratio of nucleotide transitions to transversions (Ti/Tv) has been used as a proxy for accuracy. The Ti/Tv of variant calls varied little between pipelines, but differed considerably between rare (MAF<1%) and common variants (FIG. s4).

Segregation analysis of parent-child genotypes often aids in identification of rare genetic diseases in a proband. Therefore, the pipelines in genome sequencing of four trios were compared. Remarkably, 95% of an average 6.5 million variants added by the Diagnostic pipeline had concordant genotypes in trios (See Table s4 below). In agreement with singleton genome sequencing comparisons, the new calls were enriched for rare variants, especially those that were known or likely to cause genetic diseases (90% increase in rare ACMG category 1-3 variants). Notably, 69% of these had concordant genotypes in trios. These were especially likely to be true positives, since the prior probability of their being false calls was <0.0001. In contrast, there was only a 21% increase in rare, likely pathogenic false positive variants. However, the latter was likely an overestimate, since it was unadjusted for true positive de novo variants. In summary, two lines of evidence suggested that the Diagnostic pipeline reported twice as many variants in singleton, deep genome sequencing that could potentially cause rare genetic diseases, without an obfuscating increase in false positives.

TABLE s4

| | | Published Pipeline | | | |
|---|---|---|---|---|---|
| | | Rare Cat | % Rare Cat | Cumulative | |
| Genotype | | 1-3 Variant | 1-3 Variant | Nucleotide | % Cumulative |
| Segregation | Assumption | Calls | Calls | Variant Calls | Variant Calls |
| Concordant in trio | True Positive | 4,820 | 88.13% | 18,940,209 | 86.47% |
| Parents +/+, child +/− | False Neg. | 1 | 0.02% | 12,040 | 0.05% |
| Parent +/+, child −/− | False Neg. | 154 | 2.82% | 1,063,400 | 4.85% |
| Child +/+, parents −/− | False Pos. | 27 | 0.49% | 228,415 | 1.04% |
| Incomplete | Indeterminate | 35 | 0.64% | 738,237 | 3.37% |
| “de novo” in child | False Pos. | 432 | 7.90% | 922,733 | 4.21% |
| Any | | 5,469 | 100% | 21,905,034 | 100% |

TRIO DETAILS

| concordant | | 1,466 | 89.55 | 5,256,336 | 88.68 |
|---|---|---|---|---|---|
| parent_hom_child_het | | 0 | 0.00 | 1,893 | 0.03 |
| not_called_in_child | | 51 | 3.12 | 255,594 | 4.31 |
| not_called_in_parent | | 9 | 0.55 | 52,085 | 0.88 |
| indeterminate | | 10 | 0.61 | 217,807 | 3.67 |
| child_de_novo | | 101 | 6.17 | 143,840 | 2.43 |
| TOTAL: | | 1,637 | | 5,927,555 | |
| concordant | | 1,474 | 90.76 | 5,283,848 | 89.06 |
| parent_hom_child_het | | 0 | 0.00 | 1,756 | 0.03 |
| not_called_in_child | | 41 | 2.52 | 234,205 | 3.95 |
| not_called_in_parent | | 8 | 0.49 | 55,489 | 0.94 |
| indeterminate | | 13 | 0.80 | 208,417 | 3.51 |
| child_de_novo | | 88 | 5.42 | 149,397 | 2.52 |
| TOTAL: | | 1,624 | | 5,933,112 | |
| concordant | | 1,213 | 86.40 | 4,429,991 | 85.05 |
| parent_hom_child_het | | 0 | 0.00 | 3,185 | 0.06 |
| not_called_in_child | | 46 | 3.28 | 354,046 | 6.80 |
| not_called_in_parent | | 9 | 0.64 | 52,848 | 1.01 |
| indeterminate | | 9 | 0.64 | 170,728 | 3.28 |
| child_de_novo | | 127 | 9.05 | 198,004 | 3.80 |
| TOTAL: | | 1,404 | | 5,208,802 | |
| concordant | | 667 | 82.96 | 3,970,034 | 82.10 |
| parent_hom_child_het | | 1 | 0.12 | 5,206 | 0.11 |
| not_called_in_child | | 16 | 1.99 | 219,555 | 4.54 |
| not_called_in_parent | | 1 | 0.12 | 67,993 | 1.41 |
| indeterminate | | 3 | 0.37 | 141,285 | 2.92 |
| child_de_novo | | 116 | 14.43 | 431,492 | 8.92 |
| TOTAL: | | 804 | | 4,835,565 | |
| | | Diagnositc Pipeline | | | |
| | | Rare Cat | % Rare Cat | Cumulative | |
| Genotype | | 1-3 Variant | 1-3 Variant | Nucleotide | % Cumulative |
| Segregation | Assumption | Calls | Calls | Variant Calls | Variant Calls |
| Concordant in trio | True Positive | 8,224 | 79.11% | 23,077,844 | 87.92% |
| Parents +/+, child +/− | False Neg. | 13 | 0.13% | 34,821 | 0.13% |
| Parent +/+, child −/− | False Neg. | 406 | 3.91% | 787,476 | 3.00% |
| Child +/+, parents −/− | False Pos. | 46 | 0.44% | 188,197 | 0.72% |
| Incomplete | Indeterminate | 256 | 2.46% | 931,516 | 3.55% |
| “de novo” in child | False Pos. | 1451 | 13.96% | 1,229,455 | 4.68% |
| Any | | 10,396 | 100% | 26,249,309 | 100% |

TRIO DETAILS

| | | | | |
|---|---|---|---|---|
| concordant | 2,620 | 81.70 | 6,358,058 | 90.11 |
| parent_hom_child_het | 7 | 0.22 | 6,692 | 0.09 |
| not_called_in_child | 120 | 3.74 | 183,581 | 2.60 |
| not_called_in_parent | 16 | 0.50 | 42,588 | 0.60 |
| indeterminate | 71 | 2.21 | 265,452 | 3.76 |
| child_de_novo | 373 | 11.63 | 199,824 | 2.83 |
| TOTAL: | 3,207 | | 7,056,195 | |
| concordant | 2,563 | 81.91 | 6,364,650 | 90.22 |
| parent_hom_child_het | 3 | 0.10 | 5,851 | 0.08 |
| not_called_in_child | 136 | 4.35 | 181,250 | 2.57 |
| not_called_in_parent | 15 | 0.48 | 45,678 | 0.65 |
| indeterminate | 117 | 3.74 | 258,942 | 3.67 |
| child_de_novo | 295 | 9.43 | 198,177 | 2.81 |
| TOTAL: | 3,129 | | 7,054,548 | |
| concordant | 2,020 | 82.69 | 5,437,198 | 88.13 |
| parent_hom_child_het | 1 | 0.04 | 7,681 | 0.12 |
| not_called_in_child | 107 | 4.38 | 259,494 | 4.21 |
| not_called_in_parent | 14 | 0.57 | 46,086 | 0.75 |
| indeterminate | 57 | 2.33 | 228,040 | 3.70 |
| child_de_novo | 244 | 9.99 | 191,092 | 3.10 |
| TOTAL: | 2,443 | | 6,169,591 | |
| concordant | 1,021 | 63.14 | 4,917,938 | 82.39 |
| parent_hom_child_het | 2 | 0.12 | 14,597 | 0.24 |
| not_called_in_child | 43 | 2.66 | 163,151 | 2.73 |
| not_called_in_parent | 1 | 0.06 | 53,845 | 0.90 |
| indeterminate | 11 | 0.68 | 179,082 | 3.00 |
| child_de_novo | 539 | 33.33 | 640,362 | 10.73 |
| TOTAL: | 1,617 | | 5,968,975 | |

| | | | % Change in | |
|---|---|---|---|---|
| | | | Diagnositc | % Change in |
| | | | Published Rare | Diagnositc |
| Genotype | | | Cat 1-3 Variant | Published Total |
| Segregation | Assumption | | Calls | Variant Calls |
| Concordant in trio | True Positive | % FN | 5% | −6% |
| Parents +/+, child +/− | False Neg. | % FP | 21% | 1% |
| Parent +/+, child −/− | False Neg. | % TP | 69% | 95% |
| Child +/+, parents −/− | False Pos. | Any | 90% | 20% |
| Incomplete | Indeterminate | | | |
| “de novo” in child | False Pos. | | | |
| Any | | | | |

TRIO DETAILS

| | | |
|---|---|---|
| concordant | #child | cmh000184 |
| parent_hom_child_het | #parent1 | cmh000186 |
| not_called_in_child | #parent2 | cmh000202 |
| not_called_in_parent | | |
| indeterminate | | |
| child_de_novo | | |
| TOTAL: | | |
| concordant | #child | cmh000185 |
| parent_hom_child_het | #parentl | cmh000186 |
| not_called_in_child | #parent2 | cmh000202 |
| not_called_in_parent | | |
| indeterminate | | |
| child_de_novo | | |
| TOTAL: | | |
| concordant | #child | CMH00531 |
| parent_hom_child_het | #parentl | CMH00532 |
| not_called_in_child | #parent2 | CMH000533 |
| not_called_in_parent | | |
| indeterminate | | |
| child_de_novo | | |
| TOTAL: | | |
| concordant | #child | CMH000569 |
| parent_hom_child_het | #parentl | cmh000570 |
| not_called_in_child | #parent2 | cmh000571 |
| not_called_in_parent | | |
| indeterminate | | |
| child_de_novo | | |
| TOTAL: | | |

Table s4 is a comparison of concordant and discordant variant genotypes in whole genome sequencing of four sets of trios with the Published and Diagnostic pipelines, showing results for rare, pathogenic variants and all variants.

Recent studies have shown that variants identified by alignment algorithms and variant callers have less overlap than anticipated, challenging the notion of a single, gold standard pipeline. In light of this, a dual pipeline that reported the superset of two alignment algorithms and variant callers were evaluated. The iSAAC aligner and associated starling variant caller (Rapid pipeline) were 8-fold faster than other methods, conforming to another major attribute of genome sequencing for neonatal diagnosis. The Rapid pipeline did identify variants other than those reported by the Published pipeline (FIG. 1, Tables s1, s2). Gratifyingly, 526,927 (43%) of the variants added by the Rapid and Diagnostic pipelines were common to both, providing further evidence of their veracity. The Dual pipeline reported an average of 4.9 million variants, 3% more than the Diagnostic pipeline, and 8% more rare, potentially pathogenic variants (FIG. 1, Tables s1 and s2). The Dual pipeline had a remarkable 96% sensitivity both for genome-wide genotypes and arrayed, common SNPs, with concomitant genotype accuracy of 99.9% and 97.5%, respectively (FIG. 2, Tables s1 and s2). Collectively, these findings have profound implications for diagnostic genome sequencing, since hitherto it has been believed that much deeper coverage, longer read lengths or combined exome and genome sequencing would be necessary for high sensitivity. Instead, optimized, dual variant detection provided a 1.7-fold gain in sensitivity for rare variants of types that were known or likely to be pathogenic in genetic diseases when used with typical, singleton genome sequencing.

### Implications for Genome Evolution

With the caveat of a modest increase in false positives, these results have implications for human genome evolution. Two common measures of this are variant density and heterozygosity. The Dual pipeline accessed 28% more of the reference genome than that reported in 91 prior whole genome sequences, and the variant density and heterozygosity were 1.71/kb and 1.09/kb, respectively, which were increases of 15% and 25% (See Table s2).

The increase in rare, potentially pathogenic variants was even greater (2.7-fold, FIG. 1). These findings are in agreement with a recent report of increased rare and deleterious variants in drug target and disease exomes. Recent exome sequencing studies have shown that de novo mutations, the principal source of these, are common causes of genetic diseases (Soden et al., Sci Transl Med. 2014 Dec. 3; 6(265): 265ra168.PMID; 25473036). Interspecies comparisons have shown these variants to be subject to strong purifying selection. However, the de novo mutations that accompany explosive growth of human populations may be outpacing the effects of purifying selection. If so, accelerating population growth may be increasing the diversity of rare, deleterious variants.

24-Hour Whole Genome Sequencing for Genetic Disease Diagnosis

For practical use in guidance of management of acute illness in hospitalized children with suspected genetic diseases, genomic diagnosis must be extremely rapid. While it was recently demonstrated the feasibility of genomic diagnosis of rare genetic diseases in 50 hours, the practical time-to-result for a trio was typically five to seven days. This reflected the time for necessary discussion and decision making by physicians and parents, the consent process, and the practicalities of trio phlebotomy and trio sequencing. Therefore, a two track, expedited diagnostic genome sequencing workflow was developed, whereby a first result was obtained in the proband with the Rapid pipeline after 24-hours, with subsequent results from the Diagnostic pipeline (See FIG. s2). 24-hour time-to-result was achieved by further automation of genome sequencing, bioinformatics-based gene-variant characterization and clinical interpretation. Specifically, PCR-free sample preparation for genome sequencing was shortened from 4.5 to 3 hours. 2×100 cycle genome sequencing, including on-board cluster generation, was shortened from 26 to 18 hours. This was achieved by faster cycling time and use of modified sequencing reagents. The quality, quantity and alignment of sequence reads obtained in 18 hours was at least as good as that yielded by the standard 26-hour run (See Tables s1 and s2, and Table s5 below, FIG. s5-s8). Cluster density, not run time, was the major covariate for sequence yield and quality (See Table s5 below). Subsequently, the Rapid pipeline generated annotated variant calls in ˜2 hours, yielding an average of 542 rare, potentially pathogenic variants per individual (See FIG. 1, See Tables s1 and s2).

TABLE s5

| | | | | | | | | Reads |
|---|---|---|---|---|---|---|---|---|
| | | | | | Nucleotides | Reads | Raw | aligned by |
| | Run | Sequence | | Cluster | with Q | Passing | Error | GSNAP |
| | Time | Yield | | Density | score | Filter | rate | with mapQ |
| Sample | (hr) | (GB) | Total Reads | (K/mm²) | >30 (%) | (%) | (%) | >2 (%) |
| CMH_184 | 26 | 137 | | 1044 | 90 | 89 | 0.65 | n.d. |
| CMH_185 | 26 | 117 | | 849 | 93 | 93 | 0.5 | n.d. |
| CMH_531 | 26 | 103 | 1,015,355,810 | 746 | 90.2 | 92.4 | n.d. | 97.7% |
| CMH_569 | 26 | 101 | 995,793,286 | 1120 | 80.2 | 60.3 | 1.61 | 80.56% |
| | 26 | 139 | 1,600,532,150 | 1085 | 89 | 87 | 0.55 | 91.63% |
| UDT_73 | 18 | 106 | 966,794,602 | 760 | 92.4 | 94 | 0.5 | 97.93% |
| NA12878 | 18 | >140 | 1,330,334,428 | >1100 | 85 | 85 | 1.2^{R2} | 97.41% |
| UDT_103 | 18 | 130 | 1,215,158,762 | 970 | 90 | 90.7 | 0.56^{R2} | 97.92% |

| | | | | Passing | |
|---|---|---|---|---|---|
| | Sequence | Cluster Density | | Filter | |
| Metric | Yield (GB) | (K/mm²) | % > Q30 | (%) | Error rate (%) |
| Correlation with cluster | 0.64 | | −0.72 | −0.59 | 0.69 |
| density | | | | | |
| Mean of 18 Runs (n = 3) | 126.7 | 976.7 | 89.1 | 89.9 | 0.8 |
| Mean of 26 Runs (n = 5) | 119.4 | 968.8 | 88.5 | 84.3 | 0.8 |

Table s5 is a comparison of the metrics of sequence yield and quality of 18- and 26-hour genome sequencing (HiSeq 2500 2×100 nt rapid-run mode). In portion a of Table s5, R2 refers to read 2. 18 hour runs had marginally better quality than 26 hour runs, given slight differences in average cluster density. This might have been due to the shorter time of slide exposure to laser light and lesser loss in reagent stability. Portion b of Table s5 is a comparison of 18- and 26-hour genome sequencing metrics (HiSeq 2500 2×100 nt rapid-run mode), showing correlations between cluster density and metrics of sequence yield and quality. Cluster density explained much of the variability in yield, quality score, error rate and % reads passing filter.

An extreme bottleneck in diagnostic genome sequencing has been variant interpretation. To focus first on relevant variant interpretation, a healthcare provider entered the clinical features present in the neonate into clinicopathological correlation tools that mapped them to the corresponding diseases and genes. Interpretation of genome sequencing-derived variants and provisional molecular diagnosis were performed in less than one hour with VIKING interpretation software, which integrated the superset of relevant disease mappings and annotated variant genotypes, and allowed dynamic filtering of variants based on variables such as ACMG category, MAF, genotype, gene or inheritance pattern (See FIG. s9, s10). In the absence of a likely diagnosis, the Diagnostic pipeline, which ran in parallel, gave high sensitivity, annotated genotypes at all sites at hour 40. Absence of a provisional diagnosis also prompted genome sequencing on parental samples (See FIG. s2). It should be noted that if a genomic diagnosis was not apparent upon trio analysis, a broad analysis was performed that required days of expert review. Having established the feasibility of individual steps, the entire process was performed in 24 hours in two samples (See Supp. Material Boxes 1, 2 provided at the end of this application). In the first, a known diagnosis of Menkes disease (Mendelian inheritance in man (MIM) #309400) ATP7A c.2555C>T, p.P852L was recapitulated by genome sequencing in 23 hours and 11 minutes. In a second, blinded sample, a diagnosis of type 3 hemophagocytic lymphohistiocytosis (MIM#608898) was recapitulated in 23 hours and 55 minutes. The patient, UDT-103, had compound heterozygosity for two novel, predicted pathogenic mutations (UNC13D c.2955-2A>G and c.859-3C>A).

Diagnostic Yield in a Prospective Case Series

Feasibility studies do not necessarily convey clinical utility. To assess the diagnostic utility of rapid genome sequencing, 56 individuals from 17 families were prospectively enrolled, with 21 undiagnosed newborns, stillborns or infants with symptoms and signs that suggested a genetic disorder (See Tables 1 and s6 below). Probands were selected for an assumed high pretest probability of genetic diagnosis and disease acuity, and were from three tertiary-care children's hospitals. Definitive molecular diagnoses in 48% (10) of affected individuals were identified. All potentially disease causing variants were confirmed by Sanger sequencing. Remarkably, five different patterns of inheritance were observed, and causative mutations occurred de novo in three probands. Consistent with this, recent data has suggested a surfeit of de novo mutations causing genetic diseases (Soden et al., in preparation). The spectrum of presentations was very broad and the clinical features prompting nomination for genome sequencing were frequently atypical for the condition that was diagnosed (See Table s6 below). A novel, plausible candidate disease gene was identified in two of eighteen probands.

Molecular diagnoses do not necessarily alter clinical care or improve outcomes. It was found that rapid diagnoses of genetic diseases in acutely ill neonates aided in selection for palliative care and genetic counseling for avoidance of unplanned recurrence. In addition, timely genomic diagnosis favorably altered the clinical management of three probands (See Table 1 below).

TABLE 1

| Samples (white = since | | | | Causal | Pattern of |
|---|---|---|---|---|---|
| STM paper) | Type | Dx | Description of illness | Gene | Inheritance |
| CMH64 | Single | Y | Erosive dermatitis | GJB2 | De novo dominant |
| CMH76 | Single | N | Mitochondrial disorder | ? | ? |
| UDT2, retrospective | Single | Y | Tay Sachs Disease | HEXA | Recessive |
| UDT173 (X4), | Single | Y | Menkes disease | ATP7A | XLR |
| retrospective | | | | | |
| CMH172 | Single | Y | Neonatal epilepsy | BRAT1 | Recessive |
| CMH184, 185, 186, 202 | Tetrad | Y | Heterotaxy | BCL9L | Recessive, Novel |
| CMH222, 223, 224 | Trio | N | Choanal atresia | MAP3K15 | XLR, Novel |
| CMH248, 249, MG12- | Tetrad | Y | Lethal multiple pterygium syndrome | NEB | Recessive |
| 1259, MG12-1258 | | | | | |
| CMH396, 397, 398 | Trio | N | Liver failure | ? | ? |
| CMH 436, 437, 438 | Trio | Y | Gastroschisis, arthrogryposis and | ? | ? |
| | | | pulmonary hypertension | | |
| CMH 487, 488, 489 | Trio | Y | Omphalocele, liver failure | PRF1 | Recessive |
| CMH 531, 532, 533 | Trio | N | Omphalocele, nephrotic syndrome | ? | ? |
| CMH 545, 546, 547 | Trio | Y | Chylothorax, colonic perforation | PTPN11 | De novo Dominant |
| CMH 557, 563 | Pair | ? | GERD, bradycardia, sudden death | ? | ? |
| CMH 569, 570, 571 | Trio | Y | Hypoglycemia, hypermsulinemia | ABCC8 | Paternal |
| CMH578, 579, 580 | Trio | Y | Hypertrophic cardiomyopathy | PTPN11 | De novo Dominant |
| OBS72, 73, 74 | Trio | Y | Centronuclear myopathy | RYR1 | Recessive |

Table 1 is a prospective assessment of the utility of rapid genome sequencing for molecular diagnosis and treatment of 21 acutely ill neonates and infants in 17 families. Rapid genome sequencing or exome sequencing was performed on 56 individuals.

CMH586, a two month old infant with normal results on expanded newborn screening, presented with failure to thrive, lactic acidemia and hypoglycemia. An interim clinical diagnosis of pyruvate dehydrogenase complex (PDHC) deficiency was made based on worsening lactic acidemia with intravenous dextrose, and a ketogenic diet was initiated. Genome sequencing did not detect mutations in PDHC, but identified a homoplasmic mutation in both the proband and maternal mitochondrial DNA indicative of a diagnosis of transient cytochrome C oxidase deficiency (MIM #500009). Upon diagnosis, the ketogenic diet was discontinued and other interventions were considered. CMH569, a neonate with persistent hypoglycemia and congenital hyperinsulinism, was found to have uniparental, paternal isodisomy for a mutation in sulfonylurea receptor 1 (ABCC8), which causes focal insulin overproduction in pancreatic β cells (MIM #256450). This diagnosis led to a curative, subtotal pancreatectomy. Had this diagnosis not been made, the neonate would likely have undergone total pancreatectomy, leading to lifelong insulin dependent diabetes mellitus. CMH487 was a two month old that developed laboratory signs consistent with hemophagocytic lymphohistiocytosis (HLH) but with a confusing clinical picture. He was found to have compound heterozygous mutations in perforin 1 (PRF1), confirming HLH, type 2 (MIM #603553), was treated with immunosupressants, and his liver function improved.

In summary, 24-hour genomic diagnosis is possible for neonatal genetic diseases. In a small case series, timely genomic diagnoses were made in one half of affected individuals, and these diagnoses influenced clinical management in ˜30% of patients. This preliminary evidence suggests that the burden of undiagnosed genetic diseases in intensive care nurseries is greater than anticipated, although these cases were carefully selected for inclusion. Larger, prospective studies have recently begun to evaluate the potential benefits and harms of medical genome sequencing in apparently healthy, as well as acutely ill, newborns. Despite the improvements in diagnostic sensitivity for nucleotide variants described herein, there remain substantial needs for diagnosis of genomic structural and copy number variants, particularly in the one hundred to one million nucleotide range. Concomitant mRNA sequencing may provide functional evidence for pathogenicity of variants of uncertain significance, hypothesis generation in patients whose genome sequences are uninformative, and identification of molecular pathway targets for possible, novel interventions. Further development of web-based tools for candidate disease nomination and genome interpretation may enable democratization of the neonatal genome. Local hospital-based genome sequencing could be married with centralized, expert diagnostic interpretation and orphan treatment guidance. Finally, there is an immediate, profound need for the development of skills and best practices for conveying actionable genomic information both to healthcare providers and parents. Without genomic counselors and genomic neonatologists, the diagnostic genome cannot become the new standard-of-level IV NICU care for orphan genetic diseases.

Methods Summary: Informed written consent was obtained from adult subjects and parents of living children. The 56 prospective samples were from 17 families with 21 affected probands and siblings that presented in infancy, were without molecular diagnoses, and were enrolled for rapid genome sequencing (See Tables s6-s8 listed out below). 26-hour genome sequencing was performed as described. For 18-hour genome sequencing, isolated genomic DNA was sheared using a Covaris S2 Biodisruptor, end repaired, A-tailed and adaptor ligated. PCR was omitted. Libraries were purified using SPRI beads (Beckman Coulter). Samples for genome sequencing were each loaded onto two flowcells, and sequenced with 2×101 cycles on Illumina HiSeq2500 instruments in rapid run mode (26 hours) or with customized faster flowcell scanning times (18 hours). Isolated genomic DNA was prepared for Illumina TruSeq/Nextera exome sequencing using standard protocols and sequenced on HiSeq 2000 or 2500 instruments with TruSeq v3 or TruSeq Rapid reagents to a depth of >8 GB. Sequences were analyzed as described or as noted in the text and detailed in the supplementary methods.

Case Selection

The study was conducted at a children's hospital with 314 beds, including 70 level IV NICU beds. In 2011, the NICU had 86% bed occupancy. Retrospective samples, UDT103 and UDT173, were blinded validation samples with known molecular diagnoses for a genetic disease. Sample NA12878 was obtained from the Coriell Institute repository. The 56 prospective samples were from 17 families with 21 affected probands and siblings that presented in infancy, were without molecular diagnoses, and were enrolled for rapid genome sequencing (See Table s6 below).

TABLE s6

| Family | Sample | Description of Illness | HPO terms | Causal Number | Gene | HGVS-c |
|---|---|---|---|---|---|---|
| 1 | CMH64 | Erosive Dermatitis | Erythroderma | HP:0001019 | G/82 | NM_004004.5:c.85_87del |
| | | | Abnormal blistering of skin | HP:0008066 | | |
| | | | Absent eyebrow | HP:0002223 | | |
| | | | Absent eyelashes | HP:0000561 | | |
| | | | Anemia | HP:0001903 | | |
| | | | Neutropenia | HP:0001875 | | |
| | | | Thrombocytopenia | HP:0001873 | | |
| | | | Nail dystrophy | HP:0008404 | | |
| | CMH65 | | | | | |
| | CMH66 | | | | | |
| 2 | CMH76 | Mitochondrial disorder | Narrow forehead | HP:0000341 | | |
| | | | Short neck | HP:0000470 | | |
| | | | Non-compaction cardiomyopathy | HP:0011664 | | |
| | | | Hypertrophic cardiomyopathy | HP:0001639 | | |
| | | | Wide anterior fontanel | HP:0000260 | | |
| | | | Comeal opacity | HP:00-8057 | | |
| | | | 3-Methyglutaric aciduria | HP:0003535 | | |
| | | | 3-Methylglutaconic aciduria | HP:0003344 | | |
| | | | Posteriorly rotated ears | HP:0000358 | | |
| | | | Congential lactic acidosis | HP:0004902 | | |
| | | | Decreased fetal movement | HP:0001558 | | |
| | | | Elevated serum creatine | HP:0003236 | | |
| | | | Phosphokinase | | | |
| | | | Microvesicular hepatic steatosis | HP:0001414 | | |
| | | | Basal ganglia calcification | HP:0002135 | | |
| | | | Pulmonary hypertension | HP:0002092 | | |
| | | | EEG with burst suppression | HP:0010851 | | |
| | | | Hypocholesterolemia | HP:0003146 | | |
| | | | Increased serum pyruvate | HP:0003542 | | |
| | | | Accessory spleen | HP:0001747 | | |
| | | | Long fingers | HP:0100807 | | |
| | | | Hand clenching | HP:0001188 | | |
| | CMH77 | | | | | |
| | CMH78 | | | | | |
| | CMH172 | Neonatal epilepsy | Focal seizures | HP:0007359 | BRAT1 | NM_152743.3:c.453_454InsATCTTC |
| | | | | | | TC |
| 3 | | | | | | NM_152743.3:c.453_454InsATCTTC |
| | | | | | | TC |
| | | | Narrow forehead | HP:0000341 | | |
| | | | Depressed nasal bridge | HP:0005280 | | |
| | | | Low posterior hairline | HP:0002162 | | |
| | | | Labial hypoplasia | HP:0000066 | | |
| | | | Upslanted palpebral fissure | HP:0000582 | | |
| | | | Hand clenching | HP:0001188 | | |
| | | | Ankle clonus | HP:0011448 | | |
| | | | Congenital microcephaly | HP:0011451 | | |
| | | | Micrognathia | HP:0000347 | | |
| | | | Anteverted nares | HP:0000463 | | |
| | | | Uplifted earlobe | HP:0009909 | | |
| | | | 2-3 toe syndactyly | HP:0004691 | | |
| | | | Thin lips | HP:0000213 | | |
| | | | Hypertonia | HP:0001276 | | |
| | | | Small for gestational age | HP:0001518 | | |
| | CMH237 | | | | BRAT1 | NM_152743.3:c.453_454InsATCTTC |
| | | | | | | TC |
| | CMH238 | | | | BRAT1 | NM_152743.3:c.453_454InsATCTTC |
| | | | | | | TC |
| | CMH184 | Heterotaxy | Transposition of the great arteries with ventricular septal defect | HP:0011607 | BCL9L | NM_182557.2:c.2102G > A |
| | | | | | | NM_182557.2:c.554C > T |
| 4 | CMH185 | Heterotaxy | Cardiac total anomalous pulmonary venous connection | HP:0011720 | BCL9L | NM_182557.2:c.2102G > A |
| | | | Dextrocardia | | | NM_182557.2:c.554C > T |
| | | | Abdominal situs inversus | HP:0001651 | | |
| | | | Pulmonary valve atresia | HP:0003363 | | |
| | | | Interrupted inferior vena cava with azveous continuation | HP:0010882 | | |
| | | | | HP:0011671 | | |
| | | | Sacral dimple | | | |
| | | | Mongolian blue spot | HP:0000960 | | |
| | | | | HP:0011369 | | |
| | CMH186 | | | | BCL9L | NM_1852557.2:c.2102G > A |
| | CMH202 | | | | BCL9L | NM_182557.2:c.554C > T |
| 5 | CMH222 | Choanal atresia | Bilateral choanal atresia | HP:0004502 | MAP3 | NM_001001671.3:c.1787T > C |
| | | | Pierre-Robin sequence | HP:0000201 | K15 | |
| | | | Lower eyelid coloboma | HP:0000652 | | |
| | | | Duane anomaly | HP:0009921 | | |
| | | | Neuroblastoma | HP:0003006 | | |
| | CMH223 | Choanal atresia | Bilateral choanal atresia | HP:0004502 | | |
| | | | Micrognathia | HP:0000347 | | |
| | | | Malar flattening | HP:0000272 | | |
| | | | Preauricular skin tag | HP:0000384 | | |
| | | | Secundum atrial septal defect | HP:0001684 | | |
| | CMH224 | | | | MAP3 | Nm_001001671.3:c.1787T > C |
| | | | | | K15 | |
| | MG12-1259 | Lethal multiple | Arthrogryposis multiplex congenita | HP:0002804 | NEB | NM_004543.4:c.13878C > G |
| | | pterygium | | | | NM_004543.4:c.13683C > G |
| 6 | MG12-1258 | Syndrome | | | | |
| | | | Fetal cystic hygroma | HP:0010878 | | |
| | | | Short neck | HP:0000470 | | |
| | | | Webbed neck | HP:0000465 | | |
| | | | Hypertelorism | HP:0000316 | | |
| | | | Prominent epicanthal folds | HP:0007930 | | |
| | | | Kyphosis | HP:0002808 | | |
| | | | Increased nuchal translucency | HP:0010880 | | |
| | | | Alkinesia | HP:0002304 | | |
| | | | Absence of stomach bubble on fetal sonography | HP:0010963 | | |
| | | | Decreased fetal movement | HP:0001558 | | |
| | CMH248 | | | | NEB | NM_004543.4:c.13878C > G |
| | CMH249 | | | | NEB | NM_001164507.1:c.18786C > G |
| 7 | CMH396 | Liver failure | Acute hepatic failure | HP:0006554 | Unknown | |
| | | | Abnormality of Iron homestasis | HP:0011031 | | |
| | CMH397 | | | | | |
| | CMH398 | | | | | |
| | CMH487 | Omphalocele | Omphalocele | HP:0001539 | PRF1 | NM_001083116.1:c.1310C > T; NM_005041.4: |
| | | | | | | c.1310C > T |
| 8 | | | | | | NM_005041.4:c.407C > T; NM_001083116.1; |
| | | | | | | c.433C > T |
| | | Liver failure | Hemophagocytosis | HP:0012156 | | |
| | | | Ventilator dependence with inability to wean | HP:0005946 | | |
| | | | Bronchodysplasia | HP:0006533 | | |
| | | | Cholestasis | HP:0001396 | | |
| | | | Chronic lung disease | HP:0006528 | | |
| | | | Cryptorchidism | HP:0000028 | | |
| | | | Duplicated collecting system | HP:0000081 | | |
| | | | Hydronephrosis | HP:0000126 | | |
| | | | Hydrocele testis | HP:0000034 | | |
| | | | Single umbillican artery | HP:0001195 | | |
| | | | Interrupted inferior vena cava withazveous continuation Gastroesophageal | HP:0011671 | | |
| | | | reflux | | | |
| | | | Ventricular hypertrophy | HP:0002020 | | |
| | | | Hypertelorism | HP:0001714 | | |
| | | | Infra-orbital crease | HP:0000316 | | |
| | | | Low-set, posteriorly rotated ears | HP:0100876 | | |
| | | | Chin dimple | HP:0000368 | | |
| | | | Nevus flammeus | HP:0010751 | | |
| | | | Thoracolumbar scollosis | HP:0001052 | | |
| | | | Feeding difficulties in infancy | HP:0002944 | | |
| | | | Maternal diabetes | HP:0008872 | | |
| | | | Elevated maternal serum xfetoprotein | HP:0009800 | | |
| | | | | HP:0005984 | | |
| | CMH488 | | | | | NM_001083116.1:c.1310C > T; NM_005041.4: |
| | | | | | | c.1310C > T |
| | CMH489 | | | | | NM_5041.4:c.407C > T; NM_001083116.1: |
| | | | | | | c.433C > T |
| 9 | CMH531 | Omphalocele | Omphalocele | HP:0001539 | Unknown | |
| | | Nephrotic syndrome | Single umbillical artery | HP:0001195 | | |
| | | Eosinophilla | Nephrotic syndrome | HP:0000100 | | |
| | | | Cryptorchidism | HP:0000028 | | |
| | | | Congenital hypothyroidism | HP:0000851 | | |
| | | | Muscular ventricular septal defect | HP:0011623 | | |
| | CMH532 | | | | | |
| | CMH533 | | | | | |
| 10 | CMH545 | Chylothorax | Fetal ascites | HP:0001791 | PTPN11 | NM_080601.1:c.922A > G |
| | | | Pericardial effusion | HP:0001698 | | |
| | | | Pleural effusion | HP:0002202 | | |
| | | | Absent septum pellucidum | HP:0001331 | | |
| | | | Partial agenesis of the corpus callosum | HP:0001338 | | |
| | | | Abnormality of the Mesentery | HP:0100016 | | |
| | | | Neonatal hypoglycemia | HP:0001998 | | |
| | | | Chylothorax | HP:0010310 | | |
| | | | Retrognathia | HP:0000278 | | |
| | | | High forehead | HP:0000348 | | |
| | | | Abnormality of the metopic suture | HP:0005556 | | |
| | | | Sparse eyebrow | HP:0000535 | | |
| | | | Low-set, posteriorly rotated ears | HP:0000368 | | |
| | | | Pointed helix | HP:0100810 | | |
| | | | Almond-shaped palpebral fissure | HP:0007874 | | |
| | | | Prominent epicanthal folds | HP:0007930 | | |
| | | | Sparse eyelashes | HP:0000653 | | |
| | | | Wide nasal bridge | HP:0000431 | | |
| | | | Short nose | HP:0003196 | | |
| | | | Anteverted nares | HP:0000463 | | |
| | | | Bulbous nose | HP:0000414 | | |
| | | | Redundant neck skin | HP:0005989 | | |
| | | | Wide Intermamillary distance | HP:0006610 | | |
| | | | Redundant skin in infancy | HP:0007595 | | |
| | | | Neonatal hypotonia | HP:0001319 | | |
| | | | Soft, doughy skin | HP:0001027 | | |
| | CMH546 | | | | | |
| | CMH547 | | | | | |
| 11 | CMH563 | GERD | Hypokalemia | HP:0002900 | Unknown | |
| | CMH557 | Hypokalemia | Dysphagia | HP:0002015 | | |
| | CMH560 | Apnea | Gastroesophageal reflux | HP:0002020 | | |
| | | Bradycardia | Bradycardia | HP:0001662 | | |
| | | sudden death | EEG abnormality | HP:0002353 | | |
| | | | Central apnea | HP:0002871 | | |
| | CMH558 | | | | | |
| | CMH559 | | | | | |
| | CMH561 | | | | | |
| | CMH562 | | | | | |
| 12 | CMH569 | Hypoglycemia | Acute hyperammonemia | HP:0008281 | ABCC8 | NM_000352.3:c.3640C > T |
| | | Hyperinsulinemia | Hyperinsulinemic hypoglycemia | HP:0000825 | | NM_000352.3:c.3640C > T |
| | | | Hypoketotic hypoglycemia | HP:0001985 | | |
| | | | Lactic acidosis | HP:0003128 | | |
| | | | Recurrent Infantile hypoglycemia | HP:0004914 | | |
| | CMH570 | | | | | |
| | CMH571 | | | | ABCCB | NM_0003562.3:c.3640C > T |
| 13 | CMH578 | Hypertrophic | Neonatal hypoglycemia | HP:0001998 | PTPN11 | NM_002834.3:c.1391G > C |
| | | cardiomyopathy | Hepato-splenomegaly | HP:0001433 | | |
| | | | Hypertrophic cardiomyopathy | HP:0001639 | | |
| | | | Apneic episodes in infancy | HP:0005949 | | |
| | | | Large for gestational age | HP:0001520 | | |
| | CMH579 | | | | | |
| | CMH580 | | | | | |
| | OBS72 | Congenital myopathy | Myopathy | HP:0003198 | RYR1 | NM_001042723.1:c.7487C > 000540.2: |
| | | | | | | c.7487C > G |
| | | | | | | NM_001042723.1:c.1001G > T; NM_000540.2: |
| | | | | | | c.1001G > T |
| | | | | | | NM_000540.2:c.1186G > T; NM_001042723.1: |
| | | | | | | c.1186G > T |
| | | | | | | NM_001042723.1:c.1187A > C; NM_000540.2: |
| | | | | | | c.1187A > C |
| 14 | | | Neonatal hypotonia | HP:0001319 | | |
| | OBS73 | | | | | NM_001042723.1:c.7487C > G; NM_000540.2: |
| | | | | | | c.7487C > G |
| | | | | | | NM_001042723.1:c.1001G > T; NM_000540.2: |
| | | | | | | c.1001G > T |
| | | | | | | NM_000540.2?:c.1186G > T; NM_001042723.1: |
| | | | | | | c.1186G > T |
| | OBS74 | | | | | NM_001042723.1:c.1187A > C; NM_000540.2: |
| | | | | | | c.1187A > C |
| | KSQ | Hydrops | Leukopenia | HP:0001882 | Unknown | |
| | | | Thrombocytopenia | HP:0001873 | | |
| | | | Hydrops fetalls | HP:0001789 | | |
| | | | Ascites | HP:0001541 | | |
| 15 | | | Hypospadias | HP:0000047 | | |
| | KS2 | | | | | |
| | KS3 | | | | | |
| | CMH586 | Mitochondrial disorder | Hypoglycemia | HP:0001943 | MT-TE | m.14674T > C |
| 16 | | | Lactic acidosis | HP:0003128 | | |
| | | | Elevated hepatic transaminases | HP:0002910 | | |
| | | | Generalized hypotonia | HP:0001290 | | |
| | | | Severe failure to thrive | HP:0001525 | | |
| | CMH587 | | | | | m.14674T > C |
| 17 | CMH597 | Hypoglycemia | Hypoglycemia | HP:0001943 | Unknown | |
| | | Hyperinsulinemia | Hyperinsulinemia | HP:0000842 | | |
| | | Diazoxide responsive | Premature birth | HP:0001622 | | |
| | | | Intrauterine growth retardation | HP:0001511 | | |
| | | | Neonatal hyperbillrubinemia | HP:0003265 | | |
| | CMH598 | | | | | |
| | CMH599 | | | | | |

Second Part of Table s6

| Family | HGTVS-p | Pattern of Inheritance | Related syndrome |
|---|---|---|---|
| 1 | NP_003995.2:p.Phe29del | De novo dominant | Hystrix-like ichthyosis with deeamess (OMIM) |
| 2 | | | |
| | NP_689956.2:p.Leu15211efsX70 | Recessive | Rigidity and multifocal seizure syndrome, |
| | NP_689956.2:p.Leu15211efsX70 | | lethal neonatal (MIM#614498) |
| 3 | | | |
| | NP_689956.2:p.Leu152llefsX70 | | |
| | NP_689956.2:p.Leu152llefsX70 | | |
| | NP_872363.1:p.Gly701Asp NP_872363.1:p.Ala185Val | Recessive | N/A |
| 4 | NP_872363.1:p.Gly701Asp NP_872363.1:p.Ala185Val | Recessive | |
| | NP_872363.1:p.Gly701Asp | | |
| | NP_872363.1:p.Ala185Val | | |
| 5 | NP_001001671.3:p.Val596Ala | X-linked recessive | N/A |
| | NP_001001671.3:p.Val596Ala | | |
| | NP_004534.2:p.Tyr4626X NP_004534.2:p.Tyr4561X | Recessive | Nemaline myopathy 2 (MIM#256030) |
| 6. | | | |
| | NP_004534.2:p.Tyr4626X | | |
| | NP_004534.2:p.Tyr4561X | | |
| 7 | | | |
| | NP_005032.2:p.Ala437Val;NP_001076585.1:p.Ala437Val | Recessive | Hemophagocytic lymphohistiocytosis, |
| 8 | NP_005032.2:p.Ala91Val;NP_001076585.1.p.Ala91Val | | familial, 2 (MIM#603553) |
| | NP_005032.2:p.Ala437Val;NP_001076585.1:p.Ala437Val | | |
| | NP_005032.2:p.Ala91Val;NP_001076585.1:p.Ala91Val | | |
| 9 | | | |
| 10 | NP_542168.1p.Asn308Asp | De novo dominant | Noonan syndrome (MIM#163950) |
| 11 | | | N/A |
| 12 | NP_000343.2:p.Arg1214Trp NP_000343.2:p.Arg1214Trp | Paternal uniparental | Hyperinsulinemic hypoglycemia, familial, 1 |
| | NP_000343.2:p.Arg1214Trp | | |
| 13 | NP_002825.3:p.Gly464Ala | De novo dominant | Noonan syndrome (MIM#163950) |
| | NP_000531.2:p.Pro2496Arg;NP_001036188.1:p.Pro2496Arg | Recessive | Neuromuscular disease, congenital, with |
| | | | uniform type 1 fiber (MIM#117000) |
| | NP_001036188.1:p.Gly334Val;NP_000531.2:p.Gly334Val | | |
| | NP_000531.2:p.Glu396X;NP_001036188.1:p.Glu396X | | |
| | NP_001036188.1:p.Glu396Ala;NP_000531.2:p.Glu396Ala | | |
| 14 | | | Central core disease (MIM#117000) |
| | NP_000531.2:p.Pro2496Arg;NP_001036188.1:p.Pro2496Arg | | |
| | NP_001036188.1:p.Gly334Val;NP_000531.2:p.Gly334Val | | |
| | NP_000531.2.p.Glu396X;NP_001036188.1:p.Glu396X | | |
| | NP 001036188.1:p.Glu396Ala:NP000531.2:p.Glu396AJa | | |
| | | | N/A |
| 15 | | | |
| | | Maternal; homoplasmv | Mitochondria Myopathy, Infantile, |
| | | | Transient (MIM#500009) |
| 16 | | | |
| | | | N/A |
| 17 | | | |

Table s6 is a prospective assessment of the utility of rapid genome sequencing for molecular diagnosis and treatment of 21 acutely ill neonates and infants in 17 families. Rapid whole genome sequencing or exome sequencing was performed on 56 individuals. The electronic medical record was examined for each affected individual and the clinical features of the patient's illness were recorded using Human Phenotype Ontology (HPO) terms. Gene symbols, cDNA coordinates and polypeptide coordinates are recorded for mutation alleles.

### Genome and Exome Sequencing

The below Tables s7 and s8 below list all of the experimental data generated herein.

TABLE s7

| | | DNA | HiSeq | |
|---|---|---|---|---|
| | | preparation | 2500 run | Aligners and |
| Proband | Family samples | Time (hr) | time (hr) | variant callers |
| CMH_184 | CMH_185, CMH_186, CMH_187 | 4.5 | 26 | GG, GG-V |
| CMH_531 | CMH_532, CMH_533 | 4.5 | 26 | GG, GG-V |
| CMH_569 | CMH_570, CMH_571 | 4.5 | 26 | GG, GG-V |
| UDT_103 | NA | 3 | 18 | I, GG, GG-V |
| UDT_173 | NA | 4.5 & 3 | 26 & 18 | I, GG, GG-V |
| NA12878 | NA | 3 | 18 | I, GG, GG-V |

Table s7 shows a summary of experimental data related to comparisons of 18-hour and 26-hour HiSeq 2500 2×100 cycle runs. I refers to iSAAC with starling, GG refers to GSNAP and GATK with best practices, NGG refers to GSNAP and GATK without VQSR. GSNAP is the Genomic Short-read Nucleotide Alignment Program. The Genome Analysis Tool Kit (GATK) is a software library for variant identification and genotyping. The final stage in the GATK best practices with ˜40× human genome sequencing is to use known variants as training data to establish the probability of each variant's accuracy (Variant Quality Score Recalibration, VQSR), and removal of low-probability variants. iSAAC and starling are an extremely rapid read alignment and variant calling method pair. High sensitivity for rare variant identification was obtained herein by use of the superset of variants generated by two alignment and variant identification pipelines (GSNAP version 2012.07.12 with GATK version 1.6.13 without VQSR, and iSAAC version 01.13.01.31 with starling version 2.0.2). Rare or novel variants do not overlap sufficiently with extant training data to provide a statistically significant prior, so VQSR was not included.

TABLE s8

| Sample | Run Number | Status | Gb | Avg PF | %>O30 | % Aligned |
|---|---|---|---|---|---|---|
| UDT_173 | Essex | affected | 139 | 87% | 89% | 92% |
| UDT_173 - 18 hour | Essex | affected | 106 | 94% | 92.4% | 98% |
| UDT_103 - 18 hour | Essex | affected | 130 | 91% | 90% | |
| NA12878 - 18 hour | Essex | control | 140 | 85% | 85% | 97% |
| UDT_103 | Essex | affected | | | | 98% |
| cmh000076 | Essex | affected | 134 | | 89% | |
| cmh000172 | Essex | affected | 113 | | 91% | |
| cmh000184 | Essex | affected | 137 | 89% | 90% | |
| cmh000185 | Essex | affected | 117 | 93% | 93% | |
| cmh000186 | Essex | family | 113 | | 93% | |
| crah000202 | Essex | family | 116 | | 93% | |
| cmh000222 | Essex | affected | 112 | | 93% | |
| cmh000223 | Essex | affected | 111 | | 93% | |
| cmh000224 | Essex | family | 124 | | 91% | |
| cmh000248 | Essex | family | 115 | | 92% | |
| cmh000249 | Essex | family | 112 | | 93% | |
| MGL_12_1258 | Essex | affected | 111 | | 93% | |
| MGL_12_1259 | Essex | affected | 128 | | 92% | |
| cmh000446 | Essex | affected | | | | |
| cmh000447 | Essex | affected | | | | |
| cmh000396 | Essex | affected | 113 | 93% | 93% | |
| cmh000397 | Essex | family | 114 | 94% | 94% | |
| cmh000398 | Essex | family | 107 | 92% | 93% | |
| cmh000436 | 186/187 | affected | 125 | 64.34% | 73.20% | 94.35% |
| cmh000437 | 188/189 | family | 124 | 87.13% | 87.00% | 95.96% |
| cmh000438 | 192/193/194 | family | 119 | 74.49% | 84.73% | 91.01% |
| cmh000487 | 201/202 | affected | 99 | 83.79% | 84.05% | 89.67% |
| cmh000488 | 205/206 | family | 77 | 88.68% | 84.30% | 82.00% |
| cmh000489 | 203/204 | family | 84 | 85.35% | 87.30% | 88.08% |
| cmh000531 | 218/219 | affected | 103 | 92.46% | 90.20% | 97.79% |
| cmh000532 | 220/221 | family | 114 | 80.75% | 86.10% | 96.09% |
| CMH000533 | 237/238 | family | 119 | 86.47% | 85.05% | 93.73% |
| cmh000545 | 222/223 | affected | 131 | 88.54% | 85.35% | 95.91% |
| cmh000546 | n.d. | family | | | | |
| cmh000547 | n.d. | family | | | | |
| cmh000557 | 230/231 | affected | 119 | 89.97% | 89.60% | 96.29% |
| cmh000560 | n.d. | family | | | | |
| cmh000561 | n.d. | family | | | | |
| cmh000563 | 224/225 | affected | 110 | 90.44% | 89.00% | 94.60% |
| cmh000569 | 243/244 | affected | 101 | 59.71% | 61.00% | 84.08% |
| cmh000570 | 245/245 | family | 56 | 68.02% | 84.50% | 96.86% |
| cmh000571 | 247/248/249 | family | 88 | 53.74% | 81.87% | 75.47% |
| cmh000578 | 255/256/258 | affected | 103 | 62.06% | 81.70% | 95.76% |
| cmh000579 | 262/263 | family | 58 | 73.76% | 87.40% | 98.38% |
| cmh000580 | 264/265 | family | 120 | 89.37% | 90.65% | 97.51% |
| cmh000586 | 296/297 | affected | 117 | 87.09% | 83.25% | 92.29% |
| cmh000587 | 303/304 | family | 118 | 84.11% | 80.80% | 94.88% |
| cmh000597 | 306/308 | affected | 119 | 88.55% | 90.75% | 97.41% |
| cmh000598 | 310/311/312/315 | family | 96 | 81.87% | 87.83% | 98.27% |
| cmh000599 | 307/309 | family | 111 | 90.25% | 90.55% | 97.01% |
| KS001-KW | 281/284/288 | family | 120 | 72.00% | 82.00% | 96.06% |
| KS002-KW | 282/284/289/292 | family | 109 | 73.80% | 82.95% | 96.88% |
| KS003-KW | 279/280/283 | affected | 116 | 66.85% | 81.03% | 95.74% |
| OBS_072 | 268/269/274 | affected | 68 | 63.67% | 86.23% | 98.35% |
| OB5_073 | 270/275 | family | 57 | 67.41% | 82.70% | 95.66% |
| OBS_074 | 271/275 | family | 53 | 64.83% | 80.95% | 96.65% |

Table s8 shows a summary of genome sequencing data generated for the current study. All samples were sequenced in two flowcells in single runs on HiSeq 2500 instruments with 2×100 cycles. Unless otherwise noted, genome sequencing was performed in rapid run mode (26 hours). PF: reads passing filter. %>Q30: percent nucleotides with Phred-like quality score greater or equal to 30.

For 26-hour genome sequencing, isolated genomic DNA was prepared for rapid genome sequencing using the TruSeq PCR-Free sample preparation (Illumina Inc.). Briefly, 1000-1500 ng of DNA was sheared using a Covaris LE220 focused-ultrasonicator, end repaired, A-tailed and adaptor ligated. No PCR amplification was performed. Libraries were purified using Ampure beads. Libraries were assessed for appropriate size with a 2100 Bioanalyzer (Agilent). Quantitation was carried out by real-time PCR or a Qubit 2.0 Fluorometer (Life Technologies). Libraries were denatured using 2N NaOH and diluted to between 5 and 20 pM (average 12.5 pM) in hybridization buffer. Approximately 1% PhiX library (Illumina) was spiked in as a real-time control.

For 18-hour genome sequencing, isolated genomic DNA was prepared using a modification of the standard Illumina TruSeq sample preparation. Briefly, DNA was sheared using a Covaris S2 Biodisruptor, end repaired, A-tailed and adaptor ligated. PCR was omitted. Libraries were purified using SPRI beads (Beckman Coulter). For 18-hour genome sequencing, the amount of DNA used was optimized, based on experience of varying the input from representative DNA samples, and allowed a concentration to be selected that produced a known cluster density after the library was denatured using 0.1M NaOH and presented to the flowcell.

Samples for rapid genome sequencing were each loaded onto two flowcells, followed by sequencing on Illumina HiSeq2500 instruments that were set to rapid run mode (26 hour run) or with customized faster flowcell scanning times (18 hour run). Cluster generation, followed by two×101 cycle sequencing reads, separated by paired-end turnaround, were performed automatically on the instrument.

Isolated genomic DNA was prepared for Illumina TruSeq/Nextera exome sequencing using standard Illumina TruSeq/Nextera protocols. Samples were enriched twice and sequenced on HiSeq 2000 or 2500 instruments with TruSeq v3 or TruSeq Rapid reagents to a depth of >8 GB of 2×100 nt reads.

Genome and exome sequencing were performed as research, not in a manner that complies with routine diagnostic tests as defined by the CLIA guidelines.

Sequence Analysis

The basal (Published pipeline) method of sequence analysis for 50-hour diagnostic genome sequencing was alignment to the reference nuclear and mitochondrial genome sequences (Hg19 and GRCH37 [NC_012920.1], respectively) using GSNAP version 2012.1.27 or BWA version 0.6.2 and variant identification and genotyping with GATK version 1.4.5 with best practices. GSNAP is the Genomic Short-read Nucleotide Alignment Program. The Genome Analysis Tool Kit (GATK) is software for variant identification and genotyping. A set of well supported bam⁺, vcf⁻ variants were identified in disease genes to guide parameter tuning and optimization of genome sequencing pipeline components, versions and parameters for sensitivity (FIG. s2). Parameters developed to cure rare variant loss (the Diagnostic pipeline) were GSNAP version 2012.07.12 and GATK version 1.6.13 without variant quality score recalibration (VQSR). 2-hour genome sequencing alignment and variant detection were performed with iSAAC with starling, respectively (version 01.13.01.31 and 2.0.2, respectively). For 2 hour iSAAC alignment of genome sequencing, computational hardware was adapted to use a Dell R820 with a CPU of 4×E5-4650 32 core 2.7 Ghz and having a memory of 128 GB 1600 Mhz and a storage of 2×800 GB Intel 910 SSD0. Nucleotide variants were annotated with RUNES (Rapid Understanding of Nucleotide Variant Effect Software), which incorporated ENSEMBL's VEP (Variant Effect Predictor), comparisons to NCBI dbSNP, known disease mutations from the Human Gene Mutation Database, and additional in silico prediction of variant consequences using NCBI gene annotations. RUNES assigned each variant an American College of Medical Genetics (ACMG) pathogenicity category and an allele frequency. The latter was based on 2,466 individual DNA samples sequenced since October 2011.

The following Table 3 is a table of selected short-read DNA sequence alignment methods.

TABLE 3

| | | paired- | | | |
|---|---|---|---|---|---|
| | | end | Use FASTQ | | Multi- |
| Name | Description | option | quality | Gapped | threaded |
| BarraCUDA | A GPGPU accelerated Burrows- | Yes | No | Yes | Yes (POSIX |
| | Wheeler transform (FM-index) short | | | | Threadsand |
| | read alignment program based on | | | | CUDA) |
| | BWA, supports alignment of indels | | | | |
| | with gap openings and extensions. | | | | |
| BFAST | Explicit time and accuracy tradeoff | | | | Yes (POSIX |
| | with a prior accuracy estimation, | | | | Threads) |
| | supported by indexing the reference | | | | |
| | sequences. Optimally compresses | | | | |
| | indexes. Can handle billions of short | | | | |
| | reads. Can handle insertions, | | | | |
| | deletions, SNPs, and color errors (can | | | | |
| | map ABI SOLiD color space reads). | | | | |
| | Performs a full Smith Waterman | | | | |
| | alignment. | | | | |
| BLASTN | BLAST'S nucleotide alignment | | | | |
| | program, slow and not accurate for | | | | |
| | short reads, and uses a sequence | | | | |
| | database (EST, sanger sequence) | | | | |
| | rather than a reference genome. | | | | |
| BLAT | Made by Jim Kent. Can handle one | | | | Yes |
| | mismatch in initial alignment step. | | | | (client/server). |
| Bowtie | Uses a Burrows-Wheeler transform to | | | | Yes (POSIX |
| | create a permanent, reusable index of | | | | Threads) |
| | the genome; 1.3 GB memory footprint | | | | |
| | for human genome. Aligns more than | | | | |
| | 25 million Illumina reads in 1 CPU | | | | |
| | hour. Supports Maq-like and SOAP- | | | | |
| | like alignment policies | | | | |
| BWA | Uses a Burrows-Wheeler transform to | Yes | No | Yes | Yes |
| | create an index of the genome. It's a | | | | |
| | bit slower than bowtie but allows indels | | | | |
| | in alignment. | | | | |
| CASHX | Quantify and manage large quantities | | | | No |
| | of short-read sequence data. CASHX | | | | |
| | pipeline contains a set of tools that can | | | | |
| | be used together or as independent | | | | |
| | modules on their own. This algorithm | | | | |
| | is very accurate for perfect hits to a | | | | |
| | reference genome. | | | | |
| Cloudburst | Short-read mapping using Hadoop | | | | Yes |
| | MapReduce | | | | (HadoopMapReduce) |
| CUDA-EC | Short-read alignment error correction | | | | Yes (GPU |
| | using GPUs. | | | | enabled) |
| CUSHAW | A CUDA compatible short read aligner | Yes | Yes | No | Yes (GPU |
| | to large genomes based on Burrows- | | | | enabled) |
| | Wheeler transform. | | | | |
| CUSHAW2 | Gapped short-read and long-read | Yes | No | Yes | Yes |
| | alignment based on maximal exact | | | | |
| | match seeds. This aligner supports | | | | |
| | both base-space (e.g. from Illumina, | | | | |
| | 454, Ion Torrent and PacBio | | | | |
| | sequencers) and ABI SOLiD color- | | | | |
| | space read alignments. | | | | |
| CUSHAW2- | GPU-accelerated CUSHAW2 short- | Yes | No | Yes | Yes |
| GPU | read aligner. | | | | |
| drFAST | Read mapping alignment software that | Yes | Yes (for | Yes | No |
| | implements cache obliviousness to | | structural | | |
| | minimize main/cache memory | | variation) | | |
| | transfers like mrFAST and mrsFAST, | | | | |
| | however designed for the SOLiD | | | | |
| | sequencing platform (color space | | | | |
| | reads). It also returns all possible map | | | | |
| | locations for improved structural | | | | |
| | variation discovery. | | | | |
| ELAND | Implemented by Illumina. Includes | | | | |
| | ungapped alignment with a finite read | | | | |
| | length. | | | | |
| ERNE | Extended Randomized Numerical | Yes | Low quality | Yes | Multithreading |
| | alignEr for accurate alignment of NGS | | bases trimming | | and MPI- |
| | reads. It can map bisulfite-treated | | | | enabled |
| | reads. | | | | |
| GNUMAP | Accurately performs gapped alignment | | Yes (also | | Multithreading |
| | of sequence data obtained from next- | | supports | | and MPI- |
| | generation sequencing machines | | Illumina *_int.txt | | enabled |
| | (specifically that of Solexa/Illumina) | | and *_prb.txt | | |
| | back to a genome of any size. | | files with all 4 | | |
| | Includes adaptor trimming, SNP calling | | quality scores | | |
| | and Bisulfite sequence analysis. | | for each base) | | |
| GEM | High-quality alignment engine | Yes | Yes | Yes | Yes |
| | (exhaustive mapping with substitutions | | | | |
| | and indels). More accurate and | | | | |
| | several times faster than BWA or | | | | |
| | Bowtie ½. Many standalone | | | | |
| | biological applications (mapper, split | | | | |
| | mapper, mappability, and other) | | | | |
| | provided. | | | | |
| GensearchNGS | Complete framework with user-friendly | Yes | No | Yes | Yes |
| | GUI to analyse NGS data. It integrates | | | | |
| | a proprietary high quality alignment | | | | |
| | algorithm as well as plug-in capability | | | | |
| | to integrate various public aligner into | | | | |
| | a framework allowing to import short | | | | |
| | reads, align them, detect variants and | | | | |
| | generate reports. It is geared towards | | | | |
| | re-sequencing projects, namely in a | | | | |
| | diagnostic setting. | | | | |
| GMAP and | Robust, fast short-read alignment. | Yes | Yes | Yes | Yes |
| GSNAP | GMAP: longer reads, with multiple | | | | |
| | indels and splices (see entry above | | | | |
| | under Genomics analysis); GSNAP: | | | | |
| | shorter reads, with a single indel or up | | | | |
| | to two splices per read. Useful for | | | | |
| | digital gene expression, SNP and indel | | | | |
| | genotyping. Developed by Thomas Wu | | | | |
| | at Genentech. Used by the National | | | | |
| | Center for Genome | | | | |
| | Resources (NCGR) in Alpheus. | | | | |
| Geneious | Fast, accurate overlap assembler with | | | | Yes |
| Assembler | the ability to handle any combination | | | | |
| | of sequencing technology, read length, | | | | |
| | any pairing orientations, with any | | | | |
| | spacer size for the pairing, with or | | | | |
| | without a reference genome. | | | | |
| iSAAC | iSAAC has been designed to take full | Yes | Yes | Yes | Yes |
| | advantage of all the computational | | | | |
| | power available on a single server | | | | |
| | node. As a result iSAAC scales well | | | | |
| | over a broad range of hardware | | | | |
| | architectures, and alignment | | | | |
| | performance improves with hardware | | | | |
| | capabilities | | | | |
| LAST | | Yes | Yes | Yes | |
| MAQ | Ungapped alignment that takes into | | | | |
| | account quality scores for each base. | | | | |
| mrFAST and | Gapped (mrFAST) and ungapped | Yes | Yes (for | Yes | No |
| mrsFAST | (mrsFAST) alignment software that | | structural | | |
| | implements cache obliviousness to | | variation) | | |
| | minimize main/cache memory | | | | |
| | transfers. They are designed for the | | | | |
| | Illumina sequencing platform and they | | | | |
| | can return all possible map locations | | | | |
| | for improved structural variation | | | | |
| | discovery. | | | | |
| MOM | MOM or maximum oligonucleotide | | | | Yes |
| | mapping is a query matching tool that | | | | |
| | captures a maximal length match | | | | |
| | within the short read. | | | | |
| MOSAIK | Fast gapped aligner and reference- | | | | Yes |
| | guided assembler. Aligns reads using | | | | |
| | a bandedSmith-Waterman algorithm | | | | |
| | seeded by results from a k-mer | | | | |
| | hashing scheme. Supports reads | | | | |
| | ranging in size from very short to very | | | | |
| | long. | | | | |
| MPscan | Fast aligner based on a filtration | | | | |
| | strategy (no indexing, use q-grams | | | | |
| | and Backward | | | | |
| | Nondeterministic DAWG Matching) | | | | |
| Novoalign & | Gapped alignment of single end and | Yes | Yes | Yes | Multi- |
| NovoalignCS | paired end Illumina GA I & II, ABI | | | | threading |
| | Colour space & ION Torrent reads.. | | | | and MPI |
| | High sensitivity and specificity, using | | | | versions |
| | base qualities at all steps in the | | | | available |
| | alignment. Includes adapter trimming, | | | | with paid |
| | base quality calibration, Bi-Seq | | | | license. |
| | alignment, and option to report | | | | |
| | multiple alignments per read. | | | | |
| NextGENe | NextGENe ® software has been | Yes | Yes | Yes | Yes |
| | developed specifically for use by | | | | |
| | biologists performing analysis of next | | | | |
| | generation sequencing data from | | | | |
| | Roche Genome Sequencer FLX, | | | | |
| | Illumina GA/HiSeq, Life Technologies | | | | |
| | Applied BioSystems' SOLiD ™ System, | | | | |
| | PacBio and Ion Torrent platforms. | | | | |
| Omixon | The Omixon Variant Toolkit includes | Yes | Yes | Yes | Yes |
| | highly sensitive and highly accurate | | | | |
| | tools for detecting SNPs and indels. It | | | | |
| | offers a solution to map NGS short | | | | |
| | reads with a moderate distance (up to | | | | |
| | 30% sequence divergence) from | | | | |
| | reference genomes. It poses no | | | | |
| | restrictions on the size of the | | | | |
| | reference, which, combined with its | | | | |
| | high sensitivity, makes the Variant | | | | |
| | Toolkit well-suited for targeted | | | | |
| | sequencing projects and diagnostics. | | | | |
| PALMapper | PALMapper, efficiently computes both | | | | Yes |
| | spliced and unspliced alignments at | | | | |
| | high accuracy. Relying on a machine | | | | |
| | learning strategy combined with a fast | | | | |
| | mapping based on a banded Smith- | | | | |
| | Waterman-like algorithm it aligns | | | | |
| | around 7 million reads per hour on a | | | | |
| | single CPU. It refines the originally | | | | |
| | proposed QPALMA approach. | | | | |
| Partek | Partek ® Flow software has been | Yes | Yes | Yes | Multiproces- |
| | developed specifically for use by | | | | sor/Core, |
| | biologists and bioinformaticians. It | | | | Client- |
| | supports un-gapped, gapped and | | | | Server |
| | splice-junction alignment from single | | | | installation |
| | and paired-end reads from Illumina, | | | | possible |
| | Life technologies Solid TM, Roche 454 | | | | |
| | and Ion Torrent raw data (with or | | | | |
| | without quality information). It | | | | |
| | integrates powerful quality control on | | | | |
| | FASTQ/Qual level and on aligned | | | | |
| | data. Additional functionality include | | | | |
| | trimming and filtering of raw reads, | | | | |
| | SNP and InDel detection, mRNA and | | | | |
| | microRNA quantification and fusion | | | | |
| | gene detection. | | | | |
| PASS | Indexes the genome, then extends | Yes | Yes | Yes | Yes |
| | seeds using pre-computed alignments | | | | |
| | of words. Works with base space as | | | | |
| | well as color space (SOLID) and can | | | | |
| | align genomic and spliced RNA-seq | | | | |
| | reads. | | | | |
| PerM | Indexes the genome with periodic | | | | Yes |
| | seeds to quickly find alignments with | | | | |
| | full sensitivity up to four mismatches. It | | | | |
| | can map Illumina and SOLiD reads. | | | | |
| | Unlike most mapping programs, speed | | | | |
| | increases for longer read lengths. | | | | |
| PRIMEX | Indexes the genome with a k-mer | | | | No |
| | lookup table with full sensitivity up to | | | | |
| | an adjustable number of mismatches. | | | | |
| | It is best for mapping 15-60 bp | | | | |
| | sequences to a genome. | | | | |
| QPalma | Is able to take advantage of quality | | | | Yes |
| | scores, intron lengths and computation | | | | (client/server) |
| | splice site predictions to perform and | | | | |
| | performs an unbiased alignment. Can | | | | |
| | be trained to the specifics of a RNA- | | | | |
| | seq experiment and genome. Useful | | | | |
| | for splice site/intron discovery and for | | | | |
| | gene model building. (See PALMapper | | | | |
| | for a faster version). | | | | |
| RazerS | No read length limit. Hamming or edit | | | | |
| | distance mapping with configurable | | | | |
| | error rates. Configurable and | | | | |
| | predictable sensitivity | | | | |
| | (runtime/sensitivity tradeoff). Supports | | | | |
| | paired-end read mapping. | | | | |
| REAL, cREAL | REAL is an efficient, accurate, and | | Yes | | Yes |
| | sensitive tool for aligning short reads | | | | |
| | obtained from next-generation | | | | |
| | sequencing. The programme can | | | | |
| | handle an enormous amount of single- | | | | |
| | end reads generated by the next- | | | | |
| | generation Illumina/Solexa Genome | | | | |
| | Analyzer. cREAL is a simple extension | | | | |
| | of REAL for aligning short reads | | | | |
| | obtained from next-generation | | | | |
| | sequencing to a genome with circular | | | | |
| | structure. | | | | |
| RMAP | Can map reads with or without error | Yes | Yes | Yes | |
| | probability information (quality scores) | | | | |
| | and supports paired-end reads or | | | | |
| | bisulfite-treated read mapping. There | | | | |
| | are no limitations on read length or | | | | |
| | number of mismatches. | | | | |
| rNA | A randomized Numerical Aligner for | Yes | Low quality | Yes | Multithreading |
| | Accurate alignment of NGS reads | | bases trimming | | and MPI- |
| | | | | | enabled |
| RTG | Extremely fast, tolerant to high indel | Yes | Yes, for variant | Yes | Yes |
| Investigator | and substitution counts. Includes full | | calling | | |
| | read alignment. Product includes | | | | |
| | comprehensive pipelines for variant | | | | |
| | detection and metagenomic analysis | | | | |
| | with any combination of Illumina, | | | | |
| | Complete Genomics and Roche 454 | | | | |
| | data. | | | | |
| Segemehl | Can handle insertions, deletions and | Yes | No | Yes | Yes |
| | mismatches. Uses enhanced suffix | | | | |
| | arrays. | | | | |
| SeqMap | Up to 5 mixed substitutions and | | | | |
| | insertions/deletions. Various tuning | | | | |
| | options and input/output formats. | | | | |
| Shrec | Short read error correction with a | | | | Yes (Java) |
| | Suffix trie data structure. | | | | |
| SHRiMP | Indexes the reference genome as of | Yes | Yes | Yes | Yes |
| | version 2. Uses masks to generate | | | | (OpenMP) |
| | possible keys. Can map ABI SOLiD | | | | |
| | color space reads. | | | | |
| SLIDER | Slider is an application for the Illumina | | | | |
| | Sequence Analyzer output that uses | | | | |
| | the “probability” files instead of the | | | | |
| | sequence files as an input for | | | | |
| | alignment to a reference sequence or | | | | |
| | a set of reference sequences. | | | | |
| SOAP, | SOAP: Robust with a small (1-3) | Yes | No | SOAP3-dp: | Yes (POSIX |
| SOAP2, | number of gaps and mismatches. | | | Yes | Threads), |
| SOAP3 and | Speed improvement over BLAT, uses | | | | SOAP3, |
| SOAP3-dp | a 12 letter hash table. SOAP2: using | | | | SOAP3-dp |
| | bidirectional BWT to build the index of | | | | need GPU |
| | reference, and it is much faster than | | | | with CUDAsupport. |
| | the first version. SOAP3: GPU- | | | | |
| | accelerated version that could find all | | | | |
| | 4-mismatch alignments in tens of | | | | |
| | seconds per one million reads. | | | | |
| | SOAP3-dp, also GPU accelerated, | | | | |
| | supports arbitrary number of | | | | |
| | mismatches and gaps according to | | | | |
| | affine gap penalty scores. | | | | |
| SOCS | For ABI SOLiD technologies. | | | | Yes |
| | Significant increase in time to map | | | | |
| | reads with mismatches (or color | | | | |
| | errors). Uses an iterative version of the | | | | |
| | Rabin-Karp string search algorithm. | | | | |
| SSAHA and | Fast for a small number of variants. | | | | |
| SSAHA2 | | | | | |
| Stampy | For Illumina reads. High specificity, | Yes | Yes | Yes | No |
| | and sensitive for reads with indels, | | | | |
| | structural variants, or many SNPs. | | | | |
| | Slow, but speed increased | | | | |
| | dramatically by using BWA for first | | | | |
| | alignment pass). | | | | |
| SToRM | For Illumina or ABI SOLiD reads, | No | Yes | Yes | Yes |
| | with SAM native output. Highly | | | | (OpenMP) |
| | sensitive for reads with many errors, | | | | |
| | indels (from 1 to 16). Uses spaced | | | | |
| | seeds and a SSE/SSE2/AVX2banded | | | | |
| | alignment filter. Experimental; Authors | | | | |
| | recommend SHRiMP2. | | | | |
| Subread and | Superfast and accurate read aligners. | Yes | Yes | Yes | Yes |
| Subjunc | Subread can be used to map both | | | | |
| | gDNA-seq and RNA-seq reads. | | | | |
| | Subjunc detects exon-exon junctions | | | | |
| | and maps RNA-seq reads. They | | | | |
| | employ a novel mapping paradigm | | | | |
| | called “seed-and-vote”. | | | | |
| Taipan | de-novo Assembler for Illumina reads | | | | |
| UGENE | Visual interface both for Bowtie and | | | | |
| | BWA, as well as an embedded aligner | | | | |
| VelociMapper | FPGA-accelerated reference | Yes | Yes | Yes | Yes |
| | sequence alignment mapping tool | | | | |
| | from TimeLogic. Faster than Burrows- | | | | |
| | Wheeler transform-based algorithms | | | | |
| | like BWA and Bowtie. Supports up to 7 | | | | |
| | mismatches and/or indels with no | | | | |
| | performance penalty. Produces | | | | |
| | sensitive Smith-Waterman gapped | | | | |
| | alignments. | | | | |
| XpressAlign | FPGA based sliding window short read | | | | |
| | aligner which exploits the | | | | |
| | embarrassingly parallel property of | | | | |
| | short read alignment. Performance | | | | |
| | scales linearly with number of | | | | |
| | transistors on a chip (i.e. performance | | | | |
| | guaranteed to double with each | | | | |
| | iteration of Moore's Law without | | | | |
| | modification to algorithm). Low power | | | | |
| | consumption is useful for datacentre | | | | |
| | equipment. Predictable runtime. Better | | | | |
| | price/performance than software | | | | |
| | sliding window aligners on current | | | | |
| | hardware, but not better than software | | | | |
| | BWT-based aligners currently. Can | | | | |
| | cope with large numbers (>2) of | | | | |
| | mismatches. Will find all hit positions | | | | |
| | for all seeds. Single-FPGA | | | | |
| | experimental version, needs work to | | | | |
| | develop it into a multi-FPGA | | | | |
| | production version. | | | | |
| ZOOM | 100% sensitivity for a reads between | | | | Yes (GUI) |
| | 15-240 bp with practical mismatches. | | | | No (CLI). |
| | Very fast. Support insertions and | | | | |
| | deletions. Works with Illumina & | | | | |
| | SOLiD instruments, not 454. | | | | |

The following table is a table of selected DNA sequence variant identification methods.

| Name | Reference |
|---|---|
| GATK with best | Herein |
| practice guidelines | |
| GATK with custom | Herein |
| guidelines (VQSR | |
| omitted) | |
| SAMTools | Li, H. et al. The Sequence Alignment/Map format and SAMtools. Bioinformatics |
| | 25, 2078-9 (2009). |
| Variant Caller with | Shigemizu D, Fujimoto A, Akiyama S, Abe T, Nakano K, Boroevich K A, |
| Multinomial | Yamamoto, Yujiro, Furuta M, Kubo M, Nakagawa H, Tsunoda T. A practical |
| probabilistic Model | method to detect SNVs and indels from whole genome and exonne sequencing |
| (VCMM) | data. Sci. Rep. 2013/07/08/online http://dx.doi.org/10.1038/srep02161 |
| Starling | http://supportres.illumina.com/documents/documentation/software_documentation/ |
| | miseqreporter/miseqreporter_userguide_15028784_g.pdf |

Genome sequencing refers to methods that decode the sequence of those regions of the genome that are relevant for disease diagnosis. The following table is a table of selected genome sequencing methods that are relevant for disease diagnosis.

| Name | Reference |
|---|---|
| Whole | Herein |
| genome | |
| sequencing | |
| Whole exome | Herein; |
| sequencing | http://res.illumina.com/documents/products/datasheets/datasheet_illumina_exomes_comparative_table.pdf |
| TaGSCAN | Saunders C J, Miller N A, Soden S E, Dinwiddie D L, Noll A, Alnadi N A, Andraws N, |
| sequencing | Patterson M L, Krivohlavek L A, Fellis J, Humphrey S, Saffrey P, Kingsbury Z, Weir J C, |
| | Betley J, Grocock R J, Margulies E H, Farrow E G, Artman M, Safina N P, Petrikin J E, Hall |
| | K P, Kingsmore S F. Rapid whole-genome sequencing for genetic disease diagnosis in |
| | neonatal intensive care units. Sci Transl Med. 2012 Oct 3; 4(154): 154ra135. doi: |
| | 10.1126/scitranslmed.3004041. |
| | https://www.childrensmercy.org/TaGSCAN/ |
| TruSight | http://res.illumina.com/documents/products/datasheets/datasheet_trusight_overview.pdf |
| ONEsequencing | http://res.illumina.com/documents/products/datasheets/datasheet_illumina_exomes_comparative_table.pdf |
| Mendelian | Bell C J, Dinwiddie D L, Miller N A, Hateley S L, Ganusova E E, Mudge J, Langley R J, |
| disease gene | Zhang L, Lee C C, Schilkey F D, Sheth V, Woodward J E, Peckham H E, Schroth G P, Kim |
| sequencing | R W, Kingsmore S F. Carrier testing for severe childhood recessive diseases by next- |
| | generation sequencing. Sci Transl Med. 2011 Jan 12; 3(65): 65ra4. doi: |
| | 10.1126/scitranslmed.3001756. |
| Nextera | http://res.illumina.com/documents/products/datasheets/datasheet_illumina_exomes_comparative_table.pdf |
| Expanded | |
| Exome | |
| sequencing | |
| TruSight | http://res.illumina.com/documents/products/datasheets/datasheet_trusight_overview.pdf |
| Tumor | |
| sequencing | |
| TruSight | http://res.illumina.com/documents/products/datasheets/datasheet_trusight_overview.pdf |
| Cancer | |
| sequencing | |
| TruSight | http://res.illumina.com/documents/products/datasheets/datasheet_trusight_overview.pdf |
| Cardiomyopathy | |
| sequencing, | |
| TruSight | http://res.illumina.com/documents/products/datasheets/datasheet_trusight_overview.pdf |
| Autism | |
| sequencing | |
| TruSight | http://res.illumina.com/documents/products/datasheets/datasheet_trusight_overview.pdf |
| Inherited | |
| Disease | |
| sequencing | |
| SureSelect | http://www.genomics.agilent.com/article.jsp?crumbAction=push&pageId=3047 |
| Kinome | |
| sequencing | |
| HaloPlex | http://www.genomics.agilent.com/en/HaloPlex-DNA/HaloPlex-Panels/?cid=cat100006&tabId=prod110012 |
| Cancer | |
| sequencing | |
| HaloPlex | http://www.genomics.agilent.com/en/HaloPlex-DNA/HaloPlex-Panels/?cid=cat100006&tabId=prod110012 |
| Cardiomyopathy | |
| sequencing, | |
| Transcriptome | Eswaran J, Cyanam D, Mudvari P, Reddy S D, Pakala SB, Nair S S, Florea L, Fuqua S A, |
| sequencing | Godbole S, Kumar R. Transcriptomic landscape of breast cancers through mRNA |
| | sequencing. Sci Rep. 2012; 2: 264. doi: 10.1038/srep00264. |
| | lacobucci I, Ferrarini A, Sazzini M, Giacomelli E, Lonetti A, Xumerle L, Ferrari A, |
| | Papayannidis C, Malerba G, Luiselli D, Boattini A, Garagnani P, Vitale A, Soverini S, |
| | Pane F, Baccarani M, Delledonne M, Martinelli G. Application of the whole- |
| | transcriptome shotgun sequencing approach to the study of Philadelphia-positive acute |
| | lymphoblastic leukemia. Blood Cancer J. 2012 Mar; 2(3): e61. doi: 10.1038/bcj.2012.6. |
| mRNA | Baranzini S E, Mudge J, van Velkinburgh J C, Khankhanian P, Khrebtukova I, Miller N A, |
| sequencing | Zhang L, Farmer A D, Bell C J, Kim R W, May G D, Woodward J E, Caillier S J, McElroy J P, |
| | Gomez R, Pando M J, Clendenen L E, Ganusova E E, Schilkey F D, Ramaraj T, Khan O A, |
| | Huntley J J, Luo S, Kwok P Y, Wu T D, Schroth G P, Oksenberg J R, Hauser S L, |
| | Kingsmore S F. Genome, epigenome and RNA sequences of monozygotic twins |
| | discordant for multiple sclerosis. Nature. 2010 Apr 29; 464(7293): 1351-6. doi: |
| | 10.1038/nature08990. |

Clinicopatholigic Correlation

The features of the patients' diseases were mapped to likely candidate genes. This was performed manually by a board certified pediatrician and medical geneticist, or automatically by entry of terms describing the patients presentations into the clinico-pathological correlation tools, SSAGA or Phenomizer. This system was designed to enable physicians to delimit whole genome sequencing analyses to genes of causal relevance to individual clinical presentations, in accord with published guidelines for genetic testing in children. Upon entry of the clinical features of an individual patient, SSAGA or Phenomizer identified the corresponding superset of relevant diseases and genes, rank ordered by number of matching terms or probability.

VIKING (Variant Integration and Knowledge Interpretation in Genomes)

VIKING is a software tool for interpreting a patient's genome sequencing results that integrates raw sequencing results, variant characterization results and patient symptoms. Sequencing results are presented as a list of nucleotide variants, or places where the patient's genome sequence differs from that of the human reference genome. These variants are characterized by the RUNES pipeline, which seeks to determine the significance of each variant through comparison to known databases and other in silico predictions. Patient symptoms are loaded from SSAGA along with the SSAGA-predicted diseases and genes that are associated with the symptoms.

VIKING uses the information from SSAGA and RUNES to sort and filter the list of variants detected in genome sequencing so that only variants in genes indicated by the patient symptoms are displayed, and, further, so that genes are ordered by the number of SSAGA terms associated to them. This allows a researcher to quickly get a list of the most relevant nucleotide variants for the patients' symptoms.

VIKING offers several additional features to assist in the interpretation of sequencing results including dynamic filtering results by gene, disease or term, filtering by minor allele frequency so that only rare variants are displayed, filtering by genes that have a compound heterozygote variant or a homozygous variant and the ability to display all RUNES annotations for each variant. Aligned sequences containing variants of interest were inspected for veracity in pedigrees using the Integrative Genomics Viewer.

VIKING is implemented as a Java (jdk 1.6) Swing application that connects to the RUNES and S SAGA databases using the Java Database Connectivity (JDBC) API. The VIKING client application is cross-platform and can run on Windows, Mac OSX and Linux environments.

Clinical Study 1

Characteristics of Enrolled Patients—A biorepository was established at a children's hospital in the central United States for families with one or more children suspected of having a monogenetic disease, but without a definitive diagnosis. Over a 33 month period, 155 families with heterogeneous clinical conditions were enrolled into the repository and analyzed by WGS or WES for diagnostic evaluation. Of these, 100 families had 119 children with NDD and were the subjects of the analysis reported herein (ND Table 1). Standard WES or rapid WGS were performed based on acuity of illness: 85 families with affected children followed in ambulatory clinics received non-expedited WES, followed by non-expedited WGS if WES was unrevealing; 15 families with infants who were symptomatic at or shortly after birth and in neonatal intensive care units (NICU) or pediatric intensive care units (PICU) received immediate, rapid WGS (ND Table 1). The mean age of the affected children in the ambulatory clinic group was approximately 7 years at enrollment (ND Table 2). Symptoms were apparent at an average of less than one year of age in most children (ND Table 2). The clinical features of each affected child were ascertained by examination of electronic health records and communication with treating clinicians, and translated into Human Phenotype Ontology terms. The most common features of the 119 affected children from these families were global developmental delay/intellectual disability, encephalopathy, muscular weakness, failure to thrive, microcephaly, and developmental regression (ND Table 1). The most common phenotype among children in the non-acute group was global developmental delay/intellectual disability (61%). Among infants enrolled from intensive care units, seizures, hypotonia, and morphological abnormalities of the central nervous system were most common. Consanguinity was noted in only 4 families. Our intention was to enroll and test parent-child trios; in practice an average of 2.55 individuals were tested per family.

| | | ND TABLE 1 | | |
|---|---|---|---|---|
| | | Number | | |
| | | | | Rapid |
| | | Total | Exome | Genome |
| Families | | 100 | 85 | 15 |
| Affected children | | 119 | 103 | 16 |
| Consanguineous families | | 4 | 4 | 0 |
| NICU enrollments | | 11 | 0 | 11 |
| Clinical features by family | HPO id(s) | | | |
| Acidosis/encephalopathy | 0001941/0001298 | 11 | 9 | 2 |
| Ataxia | 0001251 | 8 | 8 | 0 |
| Autism Spectrum Disorder | 000729 | 10 | 10 | 0 |
| Dystonia | 0001332 | 3 | 2 | 1 |
| Global Developmental Delay/Intellectual | 0001263/0001249 | 52 | 52 | 0 |
| disability | | | | |
| Intrauterine growth retardation/Failure to thrive | 0001511/0001508 | 27 | 23 | 4 |
| Macrocephaly | 0000256 | 9 | 8 | 1 |
| Microcephaly | 0000252 | 22 | 21 | 1 |
| Morphological abnormality of the Central | 0007319 | 18 | 11 | 7 |
| Nervous System | | | | |
| Muscle weakness/severe muscular hypotonia | 0001324/0001252 | 35 | 27 | 8 |
| Neurodegeneration/developmental regression | 0002180/0002376 | 22 | 21 | 1 |
| Seizures | 0001250 | 39 | 32 | 7 |
| Visual and/or sensorineural hearing impairment | 0000505/0000407 | 17 | 15 | 2 |

ND TABLE 2

| | Exome Sequencing | | Rapid Genome | | |
|---|---|---|---|---|---|
| | (months) | | Sequencing (days)* | | |
| | Mean | Range | Mean | Median | Range |
| Symptom Onset | 6.6 | 0-90 | 8.2 | 0 | 0-90 |
| Enrollment | 83.8 | 1-252 | 43.2 | 38 | 2-154 |
| Molecular | 95.3 | 16-262 | 107.5 | 50 | 8-521 |
| Diagnosis | | | | | |

WES and WGS Data—

WES was performed in 16 days, to a depth of >8 gigabases (GB) (mean coverage >80-fold; Table S1). Six ambulatory patients received rapid WGS by HiSeq X Ten after negative analysis of WES. Rapid WGS (STATseq) was performed in acutely ill patients, and employed a 50-hour protocol and was to an average depth of at least 30-fold (ND Table s1). Nucleotide (nt) variants were identified with a pipeline optimized for sensitivity to detect rare new variants, yielding 4,855,911 variants per genome and 196,280 per exome (ND Table s1). Variants with allele frequencies <1% in a database of ˜3,500 individuals previously sequenced at our center, and of types that are potentially pathogenic, as defined by the American College of Medical Genetics, averaged 560 variants per exome and 835 per genome (ND Table s1).

ND TABLE s1

| | | | | | | | Category 1-3 |
|---|---|---|---|---|---|---|---|
| | | | | | | | nucleotide |
| | | | Aligned | | | Category | variants with |
| | | Gigabases | gigabases | Aligned gigabases | | 1-3 | allele |
| Exome | | of | passing | passing filters | Nucleotide | nucleotide | frequency |
| sample | Reads | sequence | filters | with Q score >20 | variants | variants | <0.01 |
| 001 | 176561230 | 17 | 15 | 12 | 91119 | 1710 | 414 |
| 002 | 182681475 | 17 | 16 | 13 | 93542 | 1716 | 403 |
| 006 | 99195798 | 10 | 9 | 8 | 100761 | 2067 | 496 |
| 007 | 195624514 | 19 | 17 | 14 | 92566 | 1808 | 459 |
| 010 | 104852335 | 10 | 10 | 8 | 102787 | 1974 | 389 |
| 011 | 91619545 | 9 | 8 | 7 | 100740 | 1966 | 378 |
| 016 | 80661413 | 8 | 7 | 6 | 100930 | 2025 | 414 |
| 017 | 118389716 | 11 | 11 | 9 | 110531 | 2129 | 428 |
| 021 | 150932016 | 15 | 14 | 12 | 129591 | 2242 | 406 |
| 026 | 145878554 | 14 | 13 | 0 | 162753 | 3408 | 961 |
| 027 | 125789303 | 12 | 11 | 0 | 171512 | 3438 | 1037 |
| 029 | 103046705 | 10 | 9 | 0 | 158420 | 3358 | 995 |
| 034 | 91225102 | 9 | 8 | 0 | 153535 | 3441 | 1149 |
| 035 | 74317135 | 7 | 7 | 5 | 117231 | 2987 | 1643 |
| 036 | 99445605 | 10 | 9 | 0 | 150772 | 3256 | 933 |
| 037 | 49270201 | 4 | 4 | 4 | 87621 | 1899 | 371 |
| 042 | 134322697 | 13 | 13 | 11 | 139022 | 2308 | 373 |
| 056 | 82327557 | 8 | 8 | 7 | 135145 | 2208 | 345 |
| 060 | 104072293 | 10 | 9 | 8 | 115190 | 2276 | 736 |
| 062 | 95740456 | 9 | 9 | 8 | 212915 | 3732 | 1361 |
| 067 | 73376982 | 7 | 7 | 5 | 105487 | 2204 | 391 |
| 072 | 87711714 | 8 | 8 | 7 | 108116 | 2309 | 555 |
| 079 | 135175041 | 13 | 13 | 10 | 143282 | 3379 | 1775 |
| 087 | 132714068 | 13 | 12 | 10 | 132994 | 2204 | 428 |
| 090 | 105607213 | 10 | 10 | 8 | 122639 | 2156 | 382 |
| 096 | 132986872 | 13 | 12 | 10 | 133294 | 2175 | 415 |
| 099 | 41062489 | 4 | 4 | 3 | 130775 | 2221 | 367 |
| 102 | 154451004 | 15 | 14 | 12 | 136848 | 2284 | 414 |
| 103 | 101281162 | 10 | 9 | 8 | 115649 | 2175 | 356 |
| 111 | 118198449 | 11 | 11 | 9 | 117457 | 2136 | 358 |
| 112 | 65526572 | 6 | 6 | 5 | 109798 | 2097 | 383 |
| 117 | 178361390 | 18 | 17 | 14 | 140748 | 2212 | 366 |
| 127 | 186624572 | 18 | 18 | 15 | 144373 | 2248 | 382 |
| 130 | 76617800 | 7 | 7 | 6 | 180700 | 2944 | 480 |
| 132 | 101127843 | 10 | 10 | 8 | 206566 | 3527 | 1191 |
| 133 | 102143363 | 10 | 9 | 8 | 546786 | 5806 | 1277 |
| 134 | 146296386 | 14 | 14 | 12 | 141480 | 2383 | 448 |
| 135 | 182419403 | 18 | 18 | 15 | 146866 | 2298 | 423 |
| 145 | 115865196 | 11 | 11 | 9 | 201581 | 2911 | 382 |
| 146 | 155304088 | 15 | 15 | 12 | 141299 | 2210 | 357 |
| 150 | 189093481 | 19 | 18 | 15 | 145249 | 2348 | 396 |
| 154 | 181800082 | 18 | 17 | 15 | 149823 | 2273 | 384 |
| 158 | 71299031 | 7 | 6 | 5 | 108016 | 2134 | 366 |
| 160 | 83383816 | 8 | 8 | 6 | 109243 | 2102 | 365 |
| 169 | 114937569 | 11 | 11 | 9 | 120858 | 2169 | 374 |
| 190 | 142919122 | 14 | 13 | 11 | 119177 | 2241 | 388 |
| 193 | 161098813 | 16 | 15 | 13 | 147330 | 3316 | 1657 |
| 194 | 146796968 | 14 | 14 | 11 | 116782 | 2216 | 378 |
| 196 | 114224820 | 11 | 11 | 9 | 117865 | 2326 | 436 |
| 199 | 139901560 | 14 | 13 | 11 | 121754 | 2241 | 371 |
| 203 | 74778839 | 7 | 7 | 6 | 111473 | 2175 | 369 |
| 221 | 37238400 | 3 | 3 | 3 | 183642 | 3972 | 1728 |
| 226 | 76812765 | 7 | 7 | 6 | 186007 | 2898 | 378 |
| 230 | 340206467 | 34 | 32 | 27 | 366800 | 2758 | 403 |
| 233 | 139257542 | 14 | 13 | 11 | 224720 | 2880 | 605 |
| 239 | 84975704 | 8 | 8 | 7 | 171605 | 2875 | 392 |
| 242 | 95800489 | 9 | 9 | 8 | 186504 | 2957 | 402 |
| 254 | 93034542 | 9 | 9 | 7 | 194235 | 3001 | 435 |
| 255 | 74163955 | 7 | 7 | 6 | 186193 | 2987 | 414 |
| 259 | 128956308 | 13 | 12 | 11 | 204406 | 3040 | 451 |
| 264 | 85288554 | 8 | 8 | 7 | 156739 | 2258 | 362 |
| 277 | 74032038 | 7 | 7 | 6 | 192377 | 2958 | 392 |
| 280* | 81750824 | 8 | 8 | 7 | 148709 | 2171 | 343 |
| 301 | 48175515 | 4 | 4 | 3 | 133371 | 3076 | 507 |
| 311 | 131516692 | 13 | 13 | 11 | 252005 | 3114 | 439 |
| 312 | 107769508 | 10 | 10 | 9 | 253226 | 3045 | 399 |
| 320 | 128140633 | 12 | 12 | 11 | 153932 | 2399 | 416 |
| 321 | 85759524 | 8 | 8 | 7 | 144497 | 2277 | 303 |
| 324 | 113198063 | 11 | 11 | 9 | 247033 | 3085 | 489 |
| 334 | 33443639 | 3 | 3 | 2 | 159910 | 2440 | 446 |
| 335 | 71220714 | 7 | 6 | 5 | 178599 | 2457 | 445 |
| 341 | 129948478 | 13 | 12 | 10 | 187410 | 3233 | 1013 |
| 350 | 189551295 | 19 | 16 | 14 | 509544 | 5004 | 606 |
| 360 | 163749728 | 16 | 16 | 13 | 165405 | 2846 | 633 |
| 361 | 148723626 | 15 | 14 | 12 | 182049 | 2941 | 638 |
| 373 | 174630768 | 17 | 17 | 14 | 189458 | 2867 | 464 |
| 376* | 165225838 | 16 | 16 | 14 | 166421 | 2855 | 399 |
| 382* | 147332184 | 14 | 14 | 12 | 645537 | 5284 | 618 |
| 383 | 28137346 | 2 | 2 | 2 | 148024 | 3566 | 495 |
| 392 | 105066638 | 10 | 10 | 9 | 144839 | 2256 | 325 |
| 402* | 98407832 | 9 | 9 | 8 | 129215 | 2144 | 333 |
| 403 | 106828444 | 10 | 10 | 9 | 132256 | 2202 | 349 |
| 418 | 114505872 | 11 | 11 | 10 | 163215 | 2216 | 364 |
| 425 | 84392744 | 8 | 8 | 7 | 414158 | 5960 | 802 |
| 430 | 91853516 | 9 | 9 | 8 | 154286 | 2185 | 343 |
| 439 | 104171672 | 10 | 10 | 9 | 136487 | 3242 | 699 |
| 444* | 101088438 | 10 | 10 | 8 | 203873 | 3562 | 497 |
| 445 | 91868344 | 9 | 9 | 7 | 204475 | 3501 | 469 |
| 471* | 82154192 | 8 | 8 | 7 | 167194 | 3218 | 396 |
| 482 | 71608262 | 7 | 7 | 6 | 173856 | 3377 | 419 |
| 502 | 81785971 | 8 | 7 | 6 | 351295 | 4756 | 756 |
| 514 | 70812840 | 7 | 7 | 6 | 204212 | 3571 | 589 |
| 564 | 70241943 | 7 | 6 | 6 | 201020 | 3465 | 432 |
| 574 | 152541209 | 15 | 13 | 11 | 500455 | 4985 | 563 |
| 600 | 76899344 | 7 | 7 | 6 | 306005 | 5896 | 816 |
| 605 | 90862849 | 9 | 8 | 7 | 535549 | 4473 | 815 |
| 606 | 82905641 | 8 | 7 | 6 | 429534 | 4032 | 528 |
| 613 | 38689989 | 3 | 3 | 2 | 182619 | 3823 | 525 |
| 619 | 91066528 | 9 | 8 | 7 | 520219 | 5474 | 704 |
| 621 | 60178440 | 6 | 5 | 4 | 297870 | 5185 | 833 |
| 647 | 57657834 | 5 | 5 | 4 | 477687 | 4550 | 728 |
| 697 | 83887360 | 8 | 7 | 7 | 466438 | 5759 | 762 |
| Mean | 111266416 | 10.8 | 10.3 | 8.4 | 196280 | 2998 | 560 |

Genomic Diagnostic Results—

A definitive molecular diagnosis of an established genetic disorder was identified in 45 of the 100 NDD families (53 of 119 affected children) and confirmed by Sanger sequencing (Table s3). In contrast, one diagnosis was made by clinical Sanger sequencing during the three year study period concurrent with genomic sequencing. That patient, CMH725, had CHD7 (Chromodomain Helicase DNA-binding protein 7)—associated CHARGE (Coloboma, Heart Anomaly, Choanal Atresia, Retardation, Genital and Ear anomalies) syndrome (Mendelian Inheritance in Man [MIM] #214800). The characteristics of families receiving diagnoses by WGS and WES were explored (ND Tables s2 and s3). Diagnoses occurred more commonly when the clinical history included failure to thrive or intrauterine growth retardation (p=0.04) (ND Table s3). No other clinical characteristic examined was associated with a change in rate of molecular diagnosis (ND Table s3). The diagnostic rate differed between the acutely ill infants and non-acutely ill older patients. 73% (11 of 15) of families with critically ill infants were diagnosed by rapid WGS. 40% (34 of 85) of families with children followed in ambulatory care clinics, who had been refractory to traditional diagnosis, received diagnoses: 33 by WES and one by WGS after negative WES. Rapid WGS in infants was performed at or near symptom onset. The non-acute, ambulatory clinic patients were older children (average age 83.6 months) and had received a much longer period of subspecialty care and considerable prior diagnostic testing (ND Table s4). These patients had received an average of 13.3 prior tests/panels (range 4-36) with a mean cost of $19,100, whereas the acute care group had received, on average, 7 prior diagnostic tests (range 1-15) with a mean cost of $9,550. In patients who received diagnoses, the inheritance of causative variants was autosomal dominant in 51% (44% de novo, 7% inherited), autosomal recessive in 33% (22% compound heterozygous, 11% homozygous), X-linked in 9% (2% de novo, 7% inherited), and mitochondrial in 6.6% (4.4% de novo, 2.2% inherited) (Table 3). De novo mutations accounted for 51% (23 of 45) of diagnoses overall and 62% (23 of 37) of diagnoses in families without a prior history of NDD. Paternity was confirmed by segregation analysis of private variants in all diagnoses associated with de novo mutations in trios.

ND TABLE s2

| ID | Gene | Rank* | P Value^{#} | Score | OMIM ID | Disease name |
|---|---|---|---|---|---|---|
| 001 | APTX | 136 | 0.08 | 1.67 | 208920 | ATAXIA, EARLY-ONSET, W OCULOMOTOR APRAXIA AND |
| 002 | APTX | 62 | 0.002 | 2.77 | 208920 | HYPOALBUMINEMIA |
| 007 | PYCR1 | 2 | 0.03 | 2.25 | 612940 | CUTIS LAXA, AUTOSOMAL RECESSIVE, TYPE IIB; |
| 021 | GNAS | 59 | 0.38 | 2.38 | 104580 | PSEUDOHYPOPARATHYROIDISM, 1A |
| 036 | COQ2 | 1021 | 1 | 1.17 | 607426 | COENZYME Q10 DEFICIENCY, PRIMARY, 1 |
| 042 | CACNA1A | 79 | 0.006 | 2.02 | 108500 | EPISODIC ATAXIA, TYPE 2 |
| 060 | TBX1 | 314 | 0.098 | 2.11 | 192430 | VELOCARDIOFACIAL SYNDROME |
| 062 | ASPM | 15 | 1.0E−04 | 1.87 | 608716 | MICROCEPHALY 5, PRIMARY, AR |
| 067 | MTATP6 | 51 | 5.8E−02 | 1.70 | 256000 | LEIGH SYNDROME |
| 099 | IGHMBP2 | 1 | 3.9E−03 | 2.97 | 604320 | SPINAL MUSCULAR ATROPHY, DISTAL, AUT. RECESSIVE, 1 |
| 102 | NEB | 159 | 0.08 | 1.76 | 256030 | NEMALINE MYOPATHY 2 |
| 103 | NEB | 159 | 0.08 | 1.76 | 256030 | |
| 146 | KIAA2022 | 1289 | 0.90 | 1.03 | NET:85277 | INTELLECTUAL DEFICIT, XL, CANTAGREL TYPE |
| 150 | COL6A1 | 291 | 0.15 | 1.79 | 158810 | BETHLEM MYOPATHY |
| 169 | STXBP1 | 147 | 0.03 | 1.12 | 612164 | EPILEPTIC ENCEPHALOPATHY, EARLY INFANTILE, 4 |
| 172 | BRAT1 | 385 | 0.64 | 0.73 | 614498 | RIGIDITY AND MULTIFOCAL SEIZURE SYNDROME, LETHAL |
| | | | | | | NEONATAL |
| 190 | TRPV4 | 137 | 0.61 | 1.56 | 600175 | SPINAL MUSCULAR ATROPHY, DISTAL, CONGENITAL |
| | | | | | | NONPROGRESSIVE |
| 194 | ARID1B | 5 | 0.006 | 1.17 | 614562 | MENTAL RETARDATION, AD 12 |
| 230 | ANKRD11 | 315 | 0.15 | 1.90 | 148050 | KBG SYNDROME |
| 254 | NDUFV1 | 78 | 0.20 | 1.87 | 252010 | MITOCHONDRIAL COMPLEX I DEFICIENCY |
| 255 | NDUFV1 | 119 | 0.92 | 3.64 | 252010 | MITOCHONDRIAL COMPLEX I DEFICIENCY |
| 259 | RMND1 | 576 | 0.47 | 0.88 | 614922 | COMBINED OXIDATIVE PHOSPHORYLATION DEFICIENCY 11 |
| 301 | PIGA | 1740 | 1 | 1.05 | 300868 | MULTIPLE CONGENITAL ANOMALIES-HYPOTONIA- |
| | | | | | | SEIZURES SYNDROME 2 |
| 311 | PQBP1 | 3 | 0.01 | 1.36 | 309500 | RENPENNING SYNDROME |
| 312 | PQBP1 | 3 | 0.01 | 1.36 | 309500 | RENPENNING SYNDROME |
| 334 | MECP2 | 4 | 1.0E−04 | 2.42 | 300055 | MENTAL RETARDATION, X-LINKED, SYNDROMIC 13 |
| 335 | MECP2 | 24 | 4.0E−04 | 0.82 | 300055 | MENTAL RETARDATION, X-LINKED, SYNDROMIC 13 |
| 350 | STXBP1 | 5 | 1.2E−03 | 1.64 | 612164 | EPILEPTIC ENCEPHALOPATHY, EARLY INFANTILE, 4 |
| 430 | ND3 | 234 | 0.009 | 1.61 | 256000 | LEIGH SYNDROME |
| 502 | SNAP29 | 401 | 0.02 | 1.32 | 609528 | CEREBRAL DYSGENESIS, NEUROPATHY, ICHTHYOSIS, AND |
| | | | | | | PALMOPLANTAR KERATODERMA SYNDROME |
| 545 | PTPN11 | 205 | 0.50 | 2.31 | 163950 | NOONAN SYNDROME |
| 564 | UPF3B | 350 | 0.36 | 0.70 | 300298 | MENTAL RETARDATION, X-LINKED, SYNDROMIC 14 |
| 578 | PTPN11 | 1408 | 1 | 1.19 | 176876 | LEOPARD SYNDROME |
| 605 | TSC1 | 1114 | 1 | 1.34 | 191100 | TUBEROUS SCLEROSIS-1 |
| 629 | SCN2A | 3103 | 0.90 | 0.53 | 607745 | SEIZURES, BENIGN INFANTILE, 3 |
| 659 | KAT6B | 2 | 0.04 | 3.30 | 606170 | GENITOPATELLAR SYNDROME |
| 663 | SLC25A1 | 22 | 0.007 | 1.66 | 615182 | COMBINED D-2- AND L-2-HYDROXYGLUTARIC ACIDURIA |
| 672 | KCNQ2 | 305 | 0.10 | 0.62 | 613720 | EPILEPTIC ENCEPHALOPATHY, EARLY INFANTILE 7 |
| 678 | GNPTAB | 60 | 1 | 2.00 | 252500 | MUCOLIPIDOSIS II ALPHA/BETA |
| 680 | SCN2A | 81 | 0.03 | 0.61 | 613721 | EPILEPTIC ENCEPHALOPATHY, EARLY INFANTILE, 11 |
| 725 | CHD7 | 4 | 1 | 2.55 | 214800 | CHARGE SYNDROME |

ND TABLE 3

| ID | Gene | MIM | Phenotype Name | Inheritance | de novo | Allele 1 | Allele 2 |
|---|---|---|---|---|---|---|---|
| 001 | APTX | 208920 | Ataxia, with oculomotor apraxia (22) | AR | | c.837G > A | c.837G > A |
| 002 | | | | | | | |
| 006 | PYCR1 | 612940 | Cutis Laxa type IIB (22) | AR | | c.120_121delCA | c.120_121delCA |
| 007 | | | | | | | |
| 021 | GNAS | 103580 | Pseudohypoparathyroidism, 1a | AD | x | c.536T > C | n/a |
| 034 | CLPB | 815750* | None | AR | | c.961A > T | c.1249C > T |
| 036 | COQ2 | 607426 | Coenzyme Q10 deficiency, 1 (58) | AR | | c.437G > A | c.1159C > T |
| 042 | CACNA1A | 108500 | Episodic Ataxia, Type 2 | AD | | c.574C > T | n/a |
| 060 | TBX1 | 192430 | Velocardiofacial syndrome | AD | | c.928G > A | n/a |
| 062 | ASPM | 608716 | Primary Microcephaly | AR | | c.637delA | c.637delA |
| 067 | MT ATP6 | 256000 | Leigh Syndrome (58) | M | x | m.8993T > G | n/a |
| 079 | ASXL3 | 615485 | Bainbridge-Ropers syndrome (12) | AD | x | c.1897_1898delC | n/a |
| | | | | | | A | |
| 096 | MTOR | 601231* | None (59) | AD | x | c.4448G > T | n/a |
| 099 | IGHBMP2 | 604320 | Distal Spinal Muscular Atrophy | AR | | c.1478C > T | c.1808G > A |
| 102 | NEB | 256030 | Nemaline myopathy, 2 | AR | | c.3874A > G | c.15150delT |
| 103 | | | | | | | |
| 146 | KIAA2022 | 300524 * | XL Intellectual Disability | XL | x | c.2566C > T | n/a |
| 150 | COL6A1 | 158810 | Bethlem Myopathy | AD | x | c.877G > A | n/a |
| 169 | STXBP1 | 612164 | EEEI 4 | AD | x | c.1217G > A | n/a |
| 172 | BRAT1 | 614498 | Rigidity and multifocal seizure | AR | | c.453_454ins | c.453_454ins |
| | | | syndrome, lethal neonatal (16) | | | ATCTTCTC | ATCTTCTC |
| 190 | TRPV4 | 600175 | Spinal Muscular Atrophy | AD | | c.1656delC | n/a |
| 193 | PNPLA8 | 612123 * | None | AR | | c.334_337delAAT | c.1975_1976delA |
| | | | | | | T | G |
| 194 | ARID1B | 614525 | Intellectual disability, AD 12 | AD | x** | c.6354C > A | n/a |
| 230 | ANKRD11 | 148050 | KBG syndrome | AD | x | c.1385_1388delC | n/a |
| | | | | | | AAA | |
| 254 | NDUFV1 | 252010 | Mitochondrial Complex 1 Deficiency | AR | | c.736G > A | c.349G > A |
| 255 | | | (59) | | | | |
| 259 | RMND1 | 614922 | COPD | AR | | c.713A > G) | c.1317 + 1G > T |
| 301 | PIGA | 300868 | MCAHSS | XL | | c.68dupG | n/a |
| 311 | PQBP1 | 309500 | Renpenning syndrome | XL | | c.459_462delAG | n/a |
| 312 | | | | | | AG | |
| 320 | AHCY | 613752 | Hypermethioninemia w def of S- | AR | | c.293C > T | c.428A > G |
| 321 | | | adenosylhomocysteine hydrolase | | | | |
| 334 | MECP2 | 300055 | Intellectual disability, X-Linked, | XL | | c.419C > T | n/a |
| 335 | | | Syndromic 13 | | | | |
| 350 | STXBP1 | 612164 | EEEI type 4 | AD | x | c.170-2 A > G | n/a |
| 382 | MAGEL2 | 615547 | Prader-Willi-like syndrome | AD | † | c.1996dupC | n/a |
| 383 | | | | | | | |
| 430 | MT ND3 | 256000 | Leigh syndrome | M | x | m.10158T > C | n/a |
| 471 | KMT2D | 147920 | Kabuki syndrome 1 | AD | x | c.4366dupT | n/a |
| 502 | SNAP29 | 609528 | CEDNIK syndrome | AR | | c.520 + 1G > T | c.520 + 1G > T |
| 545 | PTPN11 | 163950 | Noonan syndrome | AD | x | c.922A > G | n/a |
| 564 | UPF3B | 300676 | Intellectual disability, X-linked, 14 | AD | x | c.1091_1094delA | n/a |
| | | | | | | GAG | |
| 574 | KCNB1 | 600397* | None | AD | x | c.1133T > C | n/a |
| 578 | PTPN11 | 176876 | LEOPARD syndrome | AD | x | c.1391G > C | n/a |
| 586 | MTTE | 590025 | Reversible COX Deficiency | M | | m.14674T > C | n/a |
| 605 | TSC1 | 191100 | Tuberous sclerosis-1 | AD | x** | c.196G > T | n/a |
| 629 | SCN2A | 607745 | Seizures, benign fam infantile, 3 | AD | x | c.4877G > A | n/a |
| 659 | KAT6B | 606170 | Genitopatellar syndrome | AD | x** | c.3603_3606delA | n/a |
| | | | | | | CAA | |
| 663 | SLC25A1 | 615182 | D-2- and L-2-OH glutaricaciduria | AR | | C.578C > G | c.82G > A |
| 672 | KCNQ2 | 613720 | EEEI type 7 | AD | x | c.913T > C | n/a |
| 678 | GNPTAB | 252500 | Mucolipidosis II alpha/beta | AR | | c.1017_1020dup | c.1001G > A |
| | | | | | | TGCA | |
| 680 | SCN2A | 613721 | EEEI type 11 | AD | x | c.2635G > A | n/a |
| 725 | CHD7 | 214800 | CHARGE syndrome | AD | x | c.1234C > T | n/a |

Total

| | New finding | | Clinical Impact | | | | |
|---|---|---|---|---|---|---|---|
| ID | Gene | Atypical Phenotype | New treatment | Treatment Discontinued | Comorbidity Evaluated | Change in impression | Other |
| 001 | | | 2 | | | | |
| 002 | | | | | | | |
| 006 | | | | | | | |
| 007 | | | | | | | |
| 021 | | | | | | 1 | |
| 034 | X | | | | | | |
| 036 | | | | | | | |
| 042 | | | | | 1 | | |
| 060 | | | | 2 | 3 | 1 | |
| 062 | | | | | | | |
| 067 | | | 1 | | 1 | | 1 |
| 079 | | | | | 1 | 1 | |
| 096 | | | 1 | | | | |
| 099 | | | | | | | |
| 102 | | | 1 | | 3 | | 3 |
| 103 | | | | | | | |
| 146 | | x | | | | | |
| 150 | | | | | | | |
| 169 | | | | | | | |
| 172 | | | | | | | |
| 190 | | | | | 2 | 1 | |
| 193 | X | | | | 1 | 1 | |
| 194 | | | | | | 1 | 1 |
| 230 | | x | | | | 1 | 1 |
| 254 | | | | | | | |
| 255 | | | | | | | |
| 259 | | x | 2 | | | 1 | 1 |
| 301 | | x | 1 | 1 | | | |
| 311 | | | | | | | 1 |
| 312 | | | | | | | |
| 320 | | | | | 1 | | |
| 321 | | | | | | | |
| 334 | | | | | | 1 | |
| 335 | | | | | | | |
| 350 | | | | | | | |
| 382 | | | | | | | |
| 383 | | | | | | | |
| 430 | | | | | | | |
| 471 | | | | | | | |
| 502 | | | | | | | |
| 545 | | | | | | | |
| 564 | | | | | | | |
| 574 | X | | | | | | |
| 578 | | | | | | | |
| 586 | | | 2 | 2 | | 1 | 2 |
| 605 | | X | | | 5 | 1 | |
| 629 | | | | | | | |
| 659 | | | | | | | |
| 663 | | | 1 | | | 1 | |
| 672 | | | | | | | 1 |
| 678 | | | | | | | |
| 680 | | | 1 | | | | |
| 725 | | | | | | | |
| Total | 3 | 5 | 12 | 5 | 18 | 12 | 11 |

ND TABLE s3

| | | Association with |
|---|---|---|
| Characteristic | N | molecular diagnosis |
| Acidosis/Encephalopathy | 10 | FT p = 0.47 |
| Ataxia | 12 | FT p = 0.25 |
| Analyzed as a familial trio^{†} | 64 | χ² = 0.999 p = 0.32 |
| Autism Spectrum Disorder | 13 | χ² = 0.545, p = 0.46 |
| Consanguinity | 4 | FT p = 1.0 |
| Dystonia | 4 | FT p = 0.27 |
| Failure to thrive/intrauterine growth | 32 | χ² = 4.222, p = 0.04* |
| retardation | | |
| Global developmental delay/intellectual | 68 | χ² = 0.951, p = 0.33 |
| disability | | |
| Macrocephaly | 12 | FT, p = 1 |
| Metabolic encephalopathy | 11 | FT p = 0.47 |
| Microcephaly | 25 | χ² = 0.474, p = 0.491 |
| Morphologic abnormality of the CNS | 21 | χ² = 0.057, p = 0.81 |
| Muscle weakness/severe hypotonia | 42 | χ² = 1.176, p = 0.278 |
| Positive family history | 20 | χ² = 0.951, p = 0.33 |
| Proband analyzed without relatives | 12 | FT p = 1.0 |
| Progressive Neurologic Disorder | 23 | χ² = 3.415 p = 0.065 |
| Seizures | 48 | χ² = 0.031, p = 0.86 |
| Vision and/or sensorineural hearing | 21 | χ² = 3.007 p = 0.083 |
| impairment | | |

For patients receiving diagnoses, the degree of overlap between the canonical clinical features expected for that disease and the observed clinical features in the patient was sought. Human Phenotype Ontology terms for the clinical features in each of the 51 affected children were mapped to ˜5,300 MIM diseases and ˜2,900 genes (ND Table s2). The Phenomizer rank of the correct diagnosis among the prioritized list of diseases matching the observed clinical features was a measure of the goodness of fit between the observed and expected presentations. Among the 41 affected children for whom the rank of the molecular diagnosis on the Phenomizer-derived candidate gene list was available, the median rank was 136^{th} (range 1^{st} to 3103^{rd}, ND Table s2).

As anticipated, the time to diagnosis with 50-hour WGS was much shorter than routine WES or WGS (ND Table 2). Among the 11 families receiving 50-hour WGS, the fastest times to final report of a confirmed diagnosis were 6 days (n=1), 8 days (n=1) and 10 days (n=2) (Table 2). Time to diagnosis was longer for recently described or previously undescribed genetic diseases and in patients whose phenotypes were atypical for the causal gene, as measured by high Phenomizer ranking or divergence from the expected disease course, such as in case CMH301 presented below.

In addition to the 45 families receiving definitive molecular diagnoses, potentially pathogenic nucleotide variants were identified in candidate disease genes in 9 families. In the future, validation studies will determine whether these are indeed new disease genes. Three candidate disease genes identified during the study were subsequently validated and were included in the 45 definite diagnoses (ND Table 3).

Financial Impact of Genomic Diagnoses—

As a surrogate for cost effectiveness, it was determined the total cost of prior negative diagnostic testing for children who received a diagnosis. Laboratory tests, radiologic procedures, electromyograms and nerve conduction velocity studies performed for diagnostic purposes were included (ND Table s4, s5). The mean total charge for prior testing was $19,100 per family enrolled from the ambulatory care clinics (range $3,248-$55,321; ND Table s4). The diagnostic testing at outside institutions, tests necessary for patient management (such as electroencephalograms), physician visits, phlebotomy, and other healthcare charges and costs was omitted. To determine the cost at which, assuming a rate of diagnosis of 40% and an average charge for prior testing of $19,100 per family, WGS or WES sequencing would be cost-effective was sought. Excluding all costs other than that of prior tests, genomic sequencing of ambulatory care patients was cost-effective at a cost of no more than $7,640 per family (Table S4, S5). Assuming WES of an average of 2.55 individuals per family, as occurred when it was sought to enroll trios, it would be cost-effective as long as the cost was no more than $2,996 per individual.

ND TABLE S4

| | | Specialty | Onset | Enrolled | Diagnosis |
|---|---|---|---|---|---|
| Study ID | Prior tests ($) | Visits | (months) | | |
| 1 | 36,217 | D, G, N, R | 18 | 108 | 114 |
| 2 | | D, G, N. R | 19 | 71 | 77 |
| 6 | 20294 | G | 0 | 197 | 203 |
| 7 | | G | 0 | 119 | 126 |
| 21 | 13,663 | G* | 0 | 18 | 28 |
| 34 | 18,663 | G, N | 0 | PM | PM |
| 36 | 18,302 | G, N | 0 | PM | PM |
| 42 | 7,020 | N | 36 | 96 | 107 |
| 60 | 15,428 | G | 5 | 66 | 72 |
| 62 | 5,208 | D, G, N | 0 | 166 | 178 |
| 67 | 19,295 | G, R | 0 | 36 | 39 |
| 79 | 14,895 | D, G, R | 0 | 75 | 91 |
| 96 | 15,083 | G, N, R | 0 | 5 | 16 |
| 99 | 27,114 | G, N, R | 2 | 169 | 175 |
| 102 | 3,248 | G, R, N | 0 | 83 | 89 |
| 103 | | G, R, N | 0 | 108 | 121 |
| 146 | 14,843 | G, N | 12 | 103 | 120 |
| 150 | 33,795 | G, N, R | 0 | 54 | 57 |
| 169 | 50,506 | G, N, R | 0 | 26 | 41 |
| 190 | 7,626 | G, R | 0 | 73 | 90 |
| 193 | 19,160 | G, N | 12 | 61 | 79 |
| 194 | 18,722 | G, N | 0 | 48 | 53 |
| 230 | 13,659 | G, N | 0 | 14 | 27 |
| 254 | 3,312 | G | 0 | PM | PM |
| 255 | | G | 0 | PM | PM |
| 259 | 21,240 | G | 0 | 53 | 64 |
| 301 | 16,655 | D, G, N, | 6 | 117 | 130 |
| 311 | 14,553 | G, N | 0 | 80 | 84 |
| 312 | | G | 0 | 80 | 84 |
| 320 | 23,064 | G, R, N | 0 | 43 | 22 |
| 321 | | G, R, N | 0 | 1 | 56 |
| 334 | 55,321 | G, N | 90 | 212 | 222 |
| 335 | | G, N | 24 | 252 | 262 |
| 350 | 15,635 | N* | 4 | 40 | 60 |
| 382 | 37,260 | D, G, N, R | 0 | 100 | 124 |
| 383 | | G, N, R | 0 | 66 | 90 |
| 430 | 9,512 | G, N | 0 | 5 | 17 |
| 471 | 11,207 | G, N | 12 | 85 | 108 |
| 502 | 20,314 | N, R | 0 | 96 | 119 |
| 564 | 12,397 | G, N | 4 | 31 | 34 |
| 574 | 21,546 | G, N, R | 0 | 23 | 35 |
| 605 | 14,646 | D, N | 8 | 204 | 209 |
| Average** | $19,100 | | 6.6 | 83.8 | 95.3 |
| | | | Onset | Enrolled | Diagnosis |
| Study ID | Prior tests ($) | ICU | (days) | | |
| 172 | 14,605 | NICU | 0 | 37 | *86 |
| 545 | 3,873 | NICU | 0 | 57 | 69 |
| 578 | 10,736 | NICU | 0 | 2 | 8 |
| 586 | 8,570 | NICU | 0 | 64 | 98 |
| 629 | 13,200 | NICU | 0 | 45 | 212 |
| 659 | 9,162 | NICU | 0 | 38 | 61 |
| 663 | 11,907 | PICU | 90 | 154 | 521 |
| 672 | 9,273 | NICU | 0 | 4 | 26 |
| 678 | 10,253 | NICU | 0 | 18 | 28 |
| 680 | 5,169 | NICU | 0 | 14 | 24 |
| 725 | 8,298 | NICU | 0 | 42 | 50 |
| Median | $9,273 | | 0 | 38 | 50 |
| Average | $9,550 | | 8.2 | 43.2 | 107.5 |

ND TABLE S5

| ID | Prior clinical testing |
|---|---|
| 001 | AFP, ATM seq, ammonia, AcylCP, aCGH, Brain MRI(2) MRS, copper, EMG/NCV, FRDA |
| 002 | repeat, GFAP seq, HRC, lactate (2, MELAS/MERRF, PAA, pyruvate (3), pyruvate |
| | carboxylase, T4/TSH, UAA, UOA (2) |
| 006 | FraX, CHO intermediates, Expanded NBS, COH1/VPS13Bseq, aCGH, 7-DHC, Head |
| 007 | CT, HRC, N-glycan and CHO transferrin, PWS/AS Meth, U CHO, U MPS, U oligo, U |
| | oligos |
| 021 | Renal US, FGFR3 seq, HRC, Head CT, FGF23, aCGH, T4/TSH |
| 034 | N-glycan and CHO transferring, mito24 NGS, myopathy screen, mitochondrial DNA copy |
| | number, aCGH, 7-DHC, PAA, Skeletal Survey, TAZ seq, UAA, UOA, VLCFA |
| 036 | POLG1 seq, INS seq, lactate, KCNJ11 seq, GCK seq, ABCC8 seq, pyruvate, pyruvate |
| | dehydrogenase, SCO2 seq |
| 042 | aCGH, HRC, N-glycan and CHO transferrin, PWS/AS Meth, UOA |
| 060 | aCGH, Brain MRI, Brain MRS, FraX, HRC, Lactate, PAA, pyruvate, pyruvate |
| | dehydrogenase, UAA, UOA |
| 062 | Brain MRI, HRC, PWS/AS Meth, T4/TSH |
| 067 | AcylCP, ammonia, Brain MRI, Brain MRS, carnitine, cortisol, CPK, lactate, |
| | MELAS/MERRF, mito24 NGS, myopathy screen, N-glycan and CHO transferrin, PAA, |
| | pyruvate, T4/TSH, U oligo |
| 079 | aCGH, Brain MRI, FraX, HRC, MECP2 del/dup, MECP2 seq |
| 096 | aCGH, AcylCP, α-fucosidase, α-hexosaminidase, ammonia, Brain MRI, FGFR3 seq, |
| | HRC, lactate, PAA, PTEN, pyruvate, Skeletal Survey, VLCFA |
| 099 | congenital MD panel, Expanded NBS, EMG/NCV (2), lactate, muscle biopsy (2), |
| | myopathy screen, PMP22 del/dup |
| 102 | aldolase (2), CPK (2), EMG/NCV (2), PAA (2) |
| 103 | |
| 146 | aCGH, Brain MRI, CSF AA, CSF neurotransmitters, HRC, MECP2 del/dup, MECP2 seq, |
| | PAA |
| 150 | aCGH, AcylCP, Brain MRI, congenital MD panel, CPK, EMG/NCV, ETHE1 seq, GATM |
| | seq, lactate, lysosomal hydrolase enzymes, MELAS/MERRF, myopathy screen, myotonic |
| | dystrophy panel |
| 169 | AcylCP, ALDH71A seq, ammonia, Brain MRI, Brain MRS, carnitine, CDKL5 |
| | del/dup, CDKL5 seq, CSF AA, CSF neurotransmitters, FISH X/Y, FOXG1 del/dup, FOXG1 |
| | seq, FraX,, GJC2 seq, HRC, lactate, lysosomal hydrolase enzymes, MECP2 del/dup, |
| | MECP2 seq, mito24 NGS, N-glycan and CHO transferrin, PAA, POLG1 seq, PWS/AS |
| | Meth, pyruvate, SCN1A seq, sulfite oxidase def., U oligo, UOA, VLCFA |
| 172 | aCGH, ammonia, Brain MRI (2), CSF glycine, ERCC6, HRC, PAA, Skeletal Survey |
| 190 | HRC, aCGH, AcylCP, ammonia, carnitine, CPK, lactate, Muscle biopsy, Pyruvate |
| 193 | aCGH, Brain MRI, CPK, HRC, mito24 NGS, mtDNA depletion studies, Muscle biopsy, |
| | myopathy screen, PAA, UOA |
| 194 | aCGH, AcylCP, Brain MRI, CPK, lactate, lysosomal hydrolase enzymes, Muscle biopsy, |
| | PWS/AS Meth, SPTLC1/HSN1, VLCFA, ZEB2 del/dup, ZEB2 seq |
| 230 | Head CT, aCGH, Brain MRI, Brain MRS N-glycan and CHO transferrin, O-glycan profile, |
| | Skeletal Survey |
| 254 | AcylCP, ammonia, β-hydroxybutyric acid, carnitine, FISH X/Y, lactate, PAA, pyruvate, |
| 255 | UOA |
| 259 | aCGH, AcylCP, ammonia, carnitine, CPK, HRC, lactate, MELAS/MERRF, mito24 NGS, |
| | Muscle biopsy, myopathy screen, N-glycan and CHO transferrin, PAA, pyruvate, U CHO, |
| | U oligos, U purine/pyrimidine, UAA, UOA |
| 301 | aCGH, AcylCP, ammonia, Brain MRI, CPK, HRC, lactate, MECP2 seq, PAA, pyruvate, U |
| | MPS, U oligos, UBE3A, UOA |
| 311 | 7-DHC, aCGH, Brain MRI, chromosome breakage studies, creatine disorders panel, |
| 312 | FISH 22q11, FraX, GATM seq, homocysteine, HRC, PAA, PWS/AS Meth |
| 320 | aCGH, AcylCP (2), Brain MRI (3), Brain MRS, CK (10), CKMB (2), GAA (2), HRC (2), |
| 321 | PAA (4), pyruvate, UOA (2), ammonia, lactate, muscle biopsy, PWS/AS Meth, SMA gene |
| | analysis, |
| 334 | aCGH, AIRE seq, Brain MRI (4), Brain MRS, ceruloplasmin, copper, creatine disorders |
| 335 | panel, FraX, GATM seq, Head CT, HRC, lactate, MELAS/MERRF, methylmalonic acid, |
| | mitochondrial DNA copy number, myopathy screen, PAA, POLG1 seq, PWS/AS Meth, |
| | pyruvate (2), SLC6A8 seq, subtelomere FISH, SUCLA2 seq, TK2 seq, U MPS, UAA, |
| | UOA (2) |
| 350 | aCGH, HRC, mito24 NGS |
| 382 | aCGH(2), HRC(2), subtelomere FISH, Myotonic dystrophy, acylcarnitine profile, |
| 383 | expanded newborn screen, UOA (2), PAA (2), lactate (4), adrenal ultrasound, 7-DHC, |
| | cholesterol, total and free carnitine, ammonia, CPK, VLCFA (2), brain MRI, N-glycan and |
| | CHO transferrin (2), quantitative and qualitative O-glycan, KCNJ11, GCK, ABCC8, |
| | GLUD1 gene sequencing; CSF amino acids, lysosomal enzyme panel, urine |
| | oligosaccharides |
| 430 | AcylCP, Brain MRI, Brain MRS, carnitine, CPK, lactate, myopathy screen, PAA, |
| | pyruvate, UOA |
| 471 | aCGH, HRC, brain MRI, head CT, |
| 502 | aCGH, AcylCP, Brain MRI (2), EMG/NCV, HRC, lactate, N-glycan and CHO transferrin, |
| | PAA, POMT1, POMT2, POMGNT1, FKRP, FKTN, LARGE analysis, UOA |
| 545 | aCGH, CFTR targeted analysis, fecal a1A |
| 564 | abdominal US, aCGH, Brain MRI, HRC, PAA, PWS/AS Meth, Skeletal Survey, U MPS, U |
| | oligo, UAA, UOA |
| 574 | aCGH, HRD, PET scan, brain MRI (x2), PET scan, PWS/AS Meth, Infantile epilepsy |
| | panel, comprehensive epilepsy panel, N-glycan and CHO transferrin, VLCFA, 7-DHC, |
| | Urine oligosaccharides, UOA |
| 578 | aCGH, carnitine, CPK, HRC, lactate, N-glycan & CHO transferrin, PAA, pyruvate, |
| | Skeletal Survey, U MPS, U oligos, UAA, UOA, VLCFA |
| 586 | HRC, aCGH, AcylCP, alpha-fucosidase, lactate, PAA, TaGSCAN, UOA |
| 605 | AcylCP, Brain MRI, CHRNA2, CHRNA4, CHRNB2 analyses, FraX, HRC, PAA, UOA |
| 629 | aCGH, Brain MRI, HRC, multiple pterygium syndrome panel, myopathy screen, SMN1 |
| | deletion |
| 659 | aCGH, Brain MRI, FISH X/Y, HRC |
| 663 | aCGH, Ach Receptor Aby, mUSK Aby, AcylCP, Brain MRI, CPK, EMG/NCV, HRC, |
| | lactate, PAA, PWS/AS Meth, pyruvate, UAA, UOA |
| 672 | aCGH, AcylCP, ceruloplasmin, copper, CSF AA, CSF neurotransmitters, HRC, lysosomal |
| | hydrolase enzymes, PAA, UOA, VLCFA |
| 678 | 7-DHC, aCGH, Brain MRI, HRC, Skeletal Survey, VLCFA |
| 680 | aCGH, AcylCP, CSF glycine, Infant epilepsy panel, PAA, UOA |
| 725 | aCGH, Brain MRI, CHARGE gene panel, HRC |

For 11 families enrolled from the NICU and PICU, the mean total charge of conventional diagnostic tests was $9,550 (range $3,873-$14,605; Table S4). All other costs of intensive care potentially saved by earlier diagnosis, either through withdrawal of care where the prognosis rendered medical care futile, or as a result of institution of an effective treatment upon diagnosis was omitted.

Clinical Impact of Genomic Diagnoses—

Among ambulatory care clinic patients, the mean age at symptom onset was 6.6 months (range 0-90 months), enrollment was at 83.7 months (range 1-252 months), and confirmed and reported diagnosis at 95.3 months (range 16-262 months) (Table 2). Among infants who received a diagnosis via rapid WGS sequencing, the median age of symptom onset was 0 days (mean 8.2 days, range 0-90), median age at enrollment was 38 days (range 2-154 days), and median age at confirmed and reported diagnosis was 50 days (range 8-521 days).

As a surrogate measure of clinical effectiveness, the short-term clinical impact of diagnoses by chart reviews and interviews with referring physicians was assessed. Diagnoses changed patient management and/or clinical impression of the pathophysiology in 49% of the 45 families (n=22, ND Tables 3 and ND Table s6). Drug or dietary treatments were started or planned in ten children. In two, both of whom were diagnosed in infancy, there was a favorable response to the treatment. One of these, CMH663, is presented in detail below. The other, CMH680, was diagnosed with early infantile epileptic encephalopathy, type 11 (MIM #613721), and was started on a ketogenic diet with resultant decrease in seizures. Siblings CMH001 and CMH002, with advanced ataxia with oculomotor apraxia type 1 (MIM #208920), were treated with oral CoQ10 supplements; however, no reversal of existing morbidity was reported. Three diagnoses enabled discontinuation of unnecessary treatments, and nine prompted evaluation for possible disease complications.

ND TABLE S6

| Gene | Disorder | New | Stop | Co-morbidity. | New | Other | Change |
|---|---|---|---|---|---|---|---|
| AHCY | Hypermethioninemia | | | 1 | | | Monitor liver function tests & plasma methionine level |
| | with S- | | | | | | |
| | adenosylhomocysteine | | | | | | |
| | hydrolase deficiency | | | | | | |
| ANKRD11 | KBG syndrome | | | | 1 | 1 | Previously thought to have CGD or peroxisomal |
| | | | | | | | disorder. Could have avoided muscle biopsy. Atypical |
| | | | | | | | presentation. |
| APTX | Ataxia with oculomotor | 2 | | | | | Started on a low cholesterol, high protein diet, & oral |
| | apraxia | | | | | | CoQ10. [8] |
| ARID1B | MR, AD 12 | | | | 1 | 1 | Neuromuscular disease suspected prior to Dx. Could |
| | | | | | | | have avoided biopsy. |
| ASXL3 | Bainbridge-Ropers | | | 1 | 1 | | Removed Atypical Rett syndrome Dx. Obtained ECG. |
| | syndrome | | | | | | Symptoms previously attributed to ABCC8 |
| | | | | | | | hyperinisulinism, a concomitant 2nd disease. |
| CACNA1A | Episodic Ataxia, Type 2 | | | 1 | | | Brain MRI to assess for progressive cerebellar ataxia |
| GNAS | Pseudohypoparathyroidism | | | | 1 | | Change in Dx from congenital hypothyroidism & |
| | 1a | | | | | | primary GH def. |
| KCNQ2 | EEEI 7 | | | | | 1 | Urine & serum sulfocysteine levels |
| MECP2 | MR, X-Linked, 13 | | | | 1 | | Mitochondrial disease & creatine disorders suspected |
| | | | | | | | before Dx |
| MTTE | Reversible | 2 | 2 | | 1 | 2 | Started CoQ10 & carnitine. Changed from ketogenic |
| | Cytochrome C Oxidase | | | | | | diet to regular formula which converted ng- to po |
| | Deficiency | | | | | | feeds. Taken off polycitra. Provided guidance that |
| | | | | | | | very good outcome is likely. |
| MTATP6 | Leigh syndrome | 1 | | 1 | | 1 | Started creatine. Instructed to avoid valproic acid, |
| | | | | | | | barbiturates, & DCA. Recommended annual ECG & Echo. |
| MTOR | Megalencephaly | 1 | | | | | Rapamycin trial recommended. Patient expired prior |
| | | | | | | | to initiation [29] |
| NEB | Nemaline myopathy, 2 | 1 | | 3 | | 3 | Dx in 3rd affected sibling via Sanger sequencing. |
| | | | | | | | Avoided muscle biopsy. Cardiology Eval for |
| | | | | | | | cardiomyopathy. Pulmonology Eval for PFTs, |
| | | | | | | | assessment for nocturnal hypoxia, baseline CXR; |
| | | | | | | | monitor for scoliosis. Cautioned to avoid |
| | | | | | | | neuromuscular blocking agents due to risk for |
| | | | | | | | malignant hyperthermia. Cautioned that immobility |
| | | | | | | | may markedly exacerbate muscle weakness. Trial of |
| | | | | | | | tyrosine recommended. |
| PIGA | Multiple Congenital | 1 | 1 | | | | Started pyridoxine [25]; evaluated due to risk of |
| | Anomalies Hypotonia | | | | | | coagulopathy |
| | Seizure syndrome | | | | | | |
| PNPLA8 | Novel | | | 1 | 1 | | Cardiology Eval due to risk of failure, Previous Dx of |
| | | | | | | | mitochondrial myopathy |
| PQBP1 | Renpenning syndrome | | | | | 1 | Recommended Cardiology Eval for mother due to risk |
| | | | | | | | for CHD |
| RMND1 | Combined Oxidative | 2 | | | 1 | 1 | Guidance to avoid treatments (1), Muscle & kidney |
| | Phosphorylation Def. | | | | | | tissue Eval, Reassess risks/benefits of kidney |
| | | | | | | | transplant, Caution advised with anesthetics, |
| | | | | | | | Recommended HCO₃ & CoQ10. Eval by Cardiology, |
| | | | | | | | Pulmonology, GI, Renal, Hearing, Ophthalmology, |
| | | | | | | | Orthopedics, Rehab, & Neurology. Previous Dx |
| | | | | | | | dystonia. |
| SCN2A | EEEI 11 | 1 | | | | | Ketogenic diet started after Dx which decreased |
| | | | | | | | seizure activity |
| SLC25A1 | Combined D-2- and L- | 1 | | | 1 | | Citrate improved biochemical markers, head control, |
| | 2-hydroxyglutaric | | | | | | muscle tone & ptosis |
| | aciduria | | | | | | |
| TBX1 | Velocardiofacial | | 2 | 3 | 1 | | Mitochondrial myopathy suspected prior to Dx. |
| | syndrome | | | | | | Discontinued bicitra & mitochondrial dietary |
| | | | | | | | supplements. Eval for CHD, pharyngeal/laryngeal |
| | | | | | | | anomalies, parathyroid dysfunction. |
| TRPV4 | Spinal Muscular | | | 2 | 1 | | Symptoms previously misattributed to known Dx of |
| | Atrophy, distal, | | | | | | Klinefelter syndrome. Annual cardiology Eval & PFTs. |
| | nonprogressive | | | | | | |
| TSC1 | Tuberous sclerosis-1 | | | 5 | 1 | | Atypical phenotype (no CNS or cutaneous lesions). |
| | | | | | | | Ophthalmology Eval for hamartomas, Echo, abdominal US, |
| | | | | | | | chest CT, brain MRI |

| | | | | | |
|---|---|---|---|---|---|
| Total | 12 | 5 | 18 | 12 | 11 |

### Case Examples

### CMH301

CMH301 illustrated the utility of WES for diagnosis in a patient with an atypical, non-acute presentation of a recently-described cause of NDD. This patient was asymptomatic until six months of age when he developed tonic-clonic seizures. At 1½ years of age, he became withdrawn and developed motor stereotypies. He was diagnosed with autism spectrum disorder. Seizures occurred up to 30 times daily, despite antiepileptic treatment and a vagal nerve stimulator. At 3 years of age, he developed a tremor and unsteady gait. By age 10, he had frequent falls, loss of protective reflexes, and required a wheelchair for distances. Physical examination was notable for a long thin face, thin vermilion of the upper lip, and repetitive hand movements, including midline wringing. Gait was slow and unsteady. Electroencephalogram demonstrated a left hemisphere epileptogenic focus and atypical background activity with slowing. Extensive neurologic, laboratory and imaging evaluations were not diagnostic. WES revealed a new hemizygous variant in the class-A phosphatidylinositol glycan anchor biosynthesis protein (PIGA, c.68dupG (p.Ser24LysfsX6). His unaffected mother (CMH303) was heterozygous with a random pattern (54:46) of X-chromosome inactivation. PIGA has recently been associated with X-linked Multiple Congenital Anomalies-Hypotonia-Seizures syndrome 2, causing death in infancy (MIM #300868). However, Belet et al. demonstrated that an early stop mutation in PIGA results in a hypomorphic protein with initiation at p.Met37. This truncated PIGA partially restores surface expression of glycosylphosphatidylinositol (GPI)-anchored proteins, consistent with the less severe phenotype in CMH301, whose variant preserves the alternative start codon. A GPI-anchored protein assay confirmed decreased expression on granulocytes, T-cells, and B-cells, and normal erythrocyte expression consistent with the absence of hemolysis. Pyridoxine, an effective antiepileptic for at least one other GPI-anchor biosynthesis disorder, was trialed but was not efficacious.

### CMH230

CMH230 underscored the power of WES to provide a molecular diagnosis in a clinically heterogeneous, non-acute disorder. This patient was born at 37 weeks after detection of a complex congenital heart defect, growth restriction, and liver calcifications in utero. A complete atrioventricular canal defect was identified on postnatal echocardiography. Dysmorphic features included two posterior hair whorls, tall skull, short forehead, low anterior hairline, flat midface, prominent eyes, periorbital fullness, down-slanting palpebral fissures, sparse curly lashes, brows with medial flare, bluish sclerae, large protruding ears, a high nasal root, bulbous nasal tip, inverted nipples, taut skin on the lower extremities and hypotonia. Notable were the absence of wide spaced eyes or macrodontia. Complete repair of the atrioventricular canal was performed at 7 months of age, after which her growth improved. She was diagnosed with partial complex seizures at 15 months. By 2 years she was able to walk independently and began to develop expressive language. Karyotype and aCGH testing were not diagnostic. The clinical findings suggested a peroxisomal disorder or congenital glycosylation defect. Very long chain fatty acids, urine oligosaccharides and transferrin studies were not diagnostic. Two N-glycan profiles demonstrated a mild increase in monogalactosylated glycan, but were not consistent with a primary congenital glycosylation defect. O-glycan profile was initially suggestive of a multiple glycosylation defect, but repeat testing was normal.

WES revealed a de novo frameshift variant in the ankyrin repeat domain 11 (ANKRD11) gene (c.1385_1388delCAAA, p.Thr462LysfsX47) in the proband, consistent with a diagnosis of KBG Syndrome (MIM #148050). CMH230 did not present with the typical features of KBG, which is classically characterized by hypertelorism, macrodontia, short stature, skeletal findings and developmental delay.

### CMH663

CMH663 illustrated the diagnostic utility of rapid WGS (STATseq) in a rare cause of NDD that resulted in a change in patient management. This patient underwent evaluation at 6 months of age for delayed attainment of developmental milestones, hypotonia, mildly dysmorphic facies, and frequent episodes of respiratory distress. Extensive neurologic, laboratory and imaging evaluations were not diagnostic. An episode of acute respiratory decompensation necessitated intubation and transfer to an intensive care unit. EEG revealed generalized slowing. Rapid WGS identified compound heterozygous missense variants in the mitochondrial malate/citrate transporter (SLC25A1 c.578C>G, p.Ser193Trp and c.82G>A, p.Ala28Thr). D-2- and L-2-hydroxyglutaric acid were elevated in plasma and urine, confirming the diagnosis of combined D-2- and L-2-hydroxyglutaric aciduria (MIM #615182). This disorder is associated with a poor prognosis: 8 of 13 reported patients died by 8 months of age. Although no standardized treatment existed, Mühlhausen et al. successfully treated an affected patient with daily Na—K-citrate supplements, with subsequent decrease in biomarker concentrations and stabilization of apneic seizure-like activity that required respiratory support. CMH663 was started on oral Na—K-citrate (1500 mg/kg/day of citrate). After 6 weeks, 2-OH-glutaric acid excretion decreased and citric acid excretion increased. Muscle tone, head control, ptosis, and alertness improved, but she subsequently developed episodes of eye twitching and upper extremity extension, correlated with left temporal and occasional right temporal spike, sharp and slow waves suggestive of epilepsy. However, at 15 months of age, she has had no further episodes of respiratory decompensation.

### CMH382 & CMH383

CMH382 and CMH383 illustrated the utility of routine WGS for molecular diagnosis in patients with NDD in whom WES failed to yield a diagnosis. CMH382 was the first child born to healthy Caucasian, non-consanguineous parents. Pregnancy was complicated by hyperemesis and preterm labor resulting in birth at 32 weeks; size was appropriate for gestational age (AGA). She was hypotonic and lethargic after delivery. Hyperinsulinemic hypoglycemia was detected, and she spent 5 months in the NICU for respiratory and feeding support and blood sugar control. Physical examination was notable for ptosis, exotropia, high palate, smooth philtrum, inverted nipples, short upper arms with decreased elbow extension and wrist mobility, hypotonia, low muscle mass and increased central distribution of body fat. She was diagnosed with autism spectrum disorder at age 3. Developmental Quotients at ages 3 and 5 were less than 50. She required diazoxide treatment for hyperinsulinism until age 6. At age 7 she developed premature adrenarche, and an advanced bone age of 10 years was identified.

CMH383, the sibling of CMH382, was born at 34 weeks; size was AGA. Neonatal course was complicated by apnea, bradycardia, poor feeding, hyperinsulinemic hypoglycemia and seizures. Physical exam was notable for marked hypotonia, finger contractures and dysmorphic features similar to her sister's. She had gross developmental delays and autistic features. Extensive neurologic, laboratory and imaging evaluations were nondiagnostic. WES of both affected siblings and their unaffected parents did not reveal any shared pathogenic variants in NDD candidate genes. Subsequently, WGS was performed on CMH382 (HiSeq X Ten) and identified 156 rare, potentially pathogenic variants not disclosed by WES. Variant reanalysis revealed a new heterozygous, truncating variant in MAGE-like-2 (MAGEL2, c.1996dupC, p.Gln666Profs*47). Further investigation revealed incomplete coverage of the MAGEL2 coding domain with WES but not WGS. The variant was predicted to cause a premature stop codon at amino acid 713. Although this variant has not been reported in the literature, it is of a type expected to be pathogenic, leading to loss of protein function through either nonsense-mediated mRNA decay or production of a truncated protein.

Sanger sequencing confirmed the presence of the p.Gln666Profs*47 variant in CMH382 and her affected sibling, CMH383. The variant was undetectable in DNA from the blood of either parent, suggesting gonadal mosaicism of this paternally expressed gene. MAGEL2 is a GC-rich (61%), intronless gene which maps within the Prader-Willi Syndrome critical region on chromosome 15q11-q13. Truncating, de novo, paternally-derived variants in MAGEL2 have recently been linked to Prader-Willi-like syndrome (PWLS; OMIM#615547) (29). Because MAGEL2 is imprinted and exhibits paternal monoallelic expression in the brain, the findings are consistent with a loss of MAGEL2 function. Although parental gonadal mosaicism is rare, this case highlighted the need to include analysis of de novo disease-causing variants in families with multiple affected siblings.

### CMH334 and CMH 335

Siblings CMH334 and CMH335 demonstrated that clinical heterogeneity in NDD can hinder molecular diagnosis by conventional methods and be circumvented by WES. CMH334 had a history of intellectual disability, a mixed seizure disorder with possible myoclonic epilepsy, and thrombocytopenia of unknown etiology. Scores on the Wechsler Intelligence Scale for Children (3rd Edition) revealed a Verbal IQ of 63, a Performance IQ of 65, and a Full Scale IQ of 61 (1^{st} percentile). At age 17, after a sedated dental procedure, he developed a lower extremity tremor which progressed to tremulous movements and facial twitching. A decline in school performance and development of severe anxiety led to further evaluation. Physical features included synophrys and prominent eyebrow ridges. Neurologic findings included saccadic eye movements, a resting upper extremity tremor, a perioral tremor, and tongue fasciculations. Deep tendon reflexes were brisk, but muscle tone, bulk and strength were maintained. Speech was slow. Heel to toe gait was unsteady, but Romberg sign was negative. Laboratory studies suggested a possible creatine biosynthesis disorder; however, GATM (arginino: glycine amidinotransferase) and SLC6A8 (creatine transporter) sequencing was negative, and magnetic resonance spectroscopy revealed CNS creatine levels to be normal.

CMH335, a full-brother, was also diagnosed with Attention Deficit Hyperactivity Disorder, intellectual disability, and epilepsy. Notable features included macrocephaly, bitemporal narrowing, obesity, hypotonia, intention tremor and tongue fasciculations. At age 9 he had an episode of acute psychosis and transient loss of some cognitive skills, including inability to recognize family members. He had complete resolution of these symptoms after approximately 3 weeks. At age 16, he was again hospitalized for neuropsychiatric decompensation and a subacute decline in reading skills. He was found to have euthyroid thyroiditis with thyroglobulin antibodies at 2565 IU/mL (normal<116 IU/mL), resulting in a diagnosis of Hashimoto's Encephalopathy. He also underwent a lengthy diagnostic evaluation which included negative methylation studies for Prader-Willi/Angelman syndrome and an X-Linked-Intellectual Disability panel.

WES revealed a known pathogenic hemizygous variant in the methyl CpG binding protein 2 gene (MECP2 c.419C>T, p.A140V) in both boys; their asymptomatic mother was heterozygous. This variant has been previously reported as a hypomorphic allele that, unlike many MECP2 variants, is compatible with life in affected males. Such males exhibit Rett-like symptoms (MIM #312750); carrier females may have mild cognitive impairment or no symptoms.

Here high rates of monogenetic disease diagnosis in children with neurodevelopmental disorders by acuity-guided WGS or WES of trios were reported. Retrospective estimates of clinical and cost effectiveness of WGS- and WES-based diagnosis of NDD were also reported. Because NDD affects more than 3% of children, these results have broad implications for pediatric medicine.

The 45% rate of molecular diagnosis of NDD, reported herein, was modestly higher than previous reports, in which 8-42% of individuals or families received diagnoses by WGS or WGS. The high diagnostic rate reported here reflected, in part, the use of rapid WGS in critically ill infants, who had very little prior testing, with a resultant diagnosis rate of 73% (11 of 15 families). Nevertheless, the diagnostic yield in ambulatory patients who had received extensive prior testing (34 of 85 families; 40%) was also high in view of exclusion of readily diagnosed causes, low rate of consanguinity (4%), and inclusion criteria similar to prior studies. Cases CMH382 and CMH383 highlighted the potential for WGS to detect variants missed by WES, particularly variants in GC-rich exons. However, a broader comparison of the diagnostic sensitivity of WGS and WES was precluded by the two distinct populations tested in this study. At present, there is no generalizable evidence for the superiority of 40-fold WGS or deep WES for diagnosis of monogenetic disorders. This may change with maturation of tools for identification of pathogenic non-exonic variants and understanding of the burden of causal chimerism and somatic mutations in genetic diseases.

Two other methodological characteristics may have contributed to the high overall diagnostic sensitivity. Firstly, de novo mutations were the most common genetic cause of childhood NDD, accounting for 23 (51%) diagnoses (37). With the exception of curated known variants, such cases benefit from trio enrollment. Secondly, clinicopathologic software was used to translate individual symptoms into a comprehensive set of disease genes that was initially examined for causality. Such software helped to solve the immense interpretive problem of broad genetic and clinical heterogeneity of NDD. This was exemplified in many of the cases reported (for example CMH001, CMH002, CMH079, CMH096, CMH301, CMH334, and CMH335), where the clinical overlap with classic disease descriptions was modest, as objectively measured by the rank of the molecular diagnosis on the list of differential diagnosis derived from the clinical features with the Phenomizer tool. A consequence is that it will be challenging to recapitulate dynamic, clinical-feature-driven interpretive workflows in remote reference laboratories, where most molecular diagnostic testing is currently performed.

Broad adoption of acuity-guided allocation of WGS or WES for NDD will require prospective analyses of the incremental cost-effectiveness versus traditional testing. Decision-analytic models should include the total cost of implementation by healthcare systems and long-term comparisons of overall cost of care, given the chronicity of NDD. Here, as a retrospective proxy, the total charge for prior, negative diagnostic tests in families who received WES- or WES and WGS-based diagnoses was identified. The average cost of prior testing, $19,100, appeared representative of tertiary pediatric practice in the United States. Assuming the observed rate of diagnosis (40%) in the ambulatory group, sequencing was found to be a cost-effective replacement diagnostic test up to $7,640 per family or $2,996 per individual. Although $2,996 is at the lower end of the cost of clinical WES today, next-generation sequencing continues to decline in cost. Furthermore, the cost-effectiveness estimates reported herein excluded potential changes in healthcare cost associated with earlier diagnosis.

Two families powerfully illustrated the impact of WES on the cost and length of the NDD diagnostic odyssey. The first enrollees, CMH001 and CMH002, were sisters with progressive cerebellar atrophy. Prior to enrollment they had 45 subspecialist visits during seven years of progressive ataxia, and their cost of negative diagnostic studies exceeded $35,000. WES yielded a diagnosis of ataxia with oculomotor apraxia type 1. In contrast, one year later, siblings CMH102 and CMH103 were enrolled for WES at the first subspecialist visit. The cost of their diagnostic studies was $3,248. WES yielded a diagnosis of nemaline myopathy. A third affected sibling was diagnosed by Sanger sequencing of the causative variants.

Another prerequisite for broad acceptance and adoption of WGS and WES for diagnosis of childhood NDD is demonstration of clinical effectiveness. The premise of genomic medicine is that early molecular diagnosis enables institution of mechanism-targeting, useful treatments before the occurrence of fixed functional deficits. Prospective clinical effectiveness studies with randomization and comparison of morbidity, quality of life and life expectancy related to NDD have not yet been undertaken. Here, as preliminary surrogates, the time to diagnosis and changes in care upon return of new molecular diagnoses were retrospectively examined. In the ambulatory patient group, patients had been symptomatic for 77 months, on average, prior to enrollment. WES, if performed at symptom onset, would have had the potential to truncate the diagnostic odyssey in such cases. Time-to-diagnosis rates reported herein (WES 11.5 months, rapid WGS 43 days, Table 2) predict that use of rapid WGS could accelerate diagnosis by an additional 10 months. For children with progressive NDD for which treatments exist, outcomes are likely to be markedly improved by treatment institution months to years earlier than would have otherwise occurred.

Another well-established benefit of a molecular diagnosis is genetic counseling of families for recurrence risk. In the current study, there were five genetic disorder recurrences in four of the families who received diagnoses. Of equal importance, the 23 families with causative de novo variants could have been counseled earlier that, barring gonadal mosaicism, recurrence was not expected. Affected children in 49% of families receiving diagnoses by WGS or WES were reported by their physicians to have had a change in clinical management and/or clinical impression (ND Tables 3 and 6). A change in drug or dietary treatment either occurred or was planned in ten families (23%), in agreement with one previous report. In two patients, both of whom received diagnoses in infancy, there was a favorable response to that treatment. One of these, CMH663, was presented in detail here. Given that all diagnoses were of ultra-rare diseases, a recurrent finding was that the new treatment considered was supported only by case reports or studies in model systems. For example, several patients with ataxia with oculomotor apraxia type 1, which was the diagnosis for CMH001 and CMH002, had responded to oral Coenzyme Q10 supplements. In addition to only anecdotal evidence of efficacy, the treatment of CMH001 and CMH002 with Coenzyme Q10 was complicated by advanced cerebellar atrophy at time of diagnosis and the absence of pharmaceutical formulation, pharmacokinetic, phannacodynamic, or dosing information in children. Thus, demonstration of the clinical effectiveness of genomic medicine will require not only improved rates and timeliness of molecular diagnosis, but also multidisciplinary care to identify, design and implement candidate interventions on an N-of-1-family or N-of-1-genome basis.

Neurodevelopmental disorders exhibited a broad spectrum of monogenetic inheritance patterns and frequently, divergence of clinical features from classical descriptions. Over 2,400 genetically distinct neurologic disorders exist, underscoring the relative ineffectiveness of serial, single gene testing. Furthermore, the clinical features of patients and families receiving diagnoses did not delineate a subset of NDD patients unlikely to benefit from WGS or WES. Mechanistically, the low incidence of recurrent alleles was consistent with their recent origin, as was the high rate of causative de novo mutations. Given the broad enrollment criteria used herein, it is possible that this level of genetic and clinical heterogeneity may be typical of NDD in subspecialty practice.

The evaluation of NDD patients has, historically, been constrained by the availability and cost of testing. Limited availability of tests reflects both the delay between disease gene discovery and the development of clinical diagnostic gene panels, and the adverse economics of targeted test development for ultra-rare diseases. Acuity-guided WGS and WES largely circumvented these constraints. Indeed, eight of the diagnoses reported herein were in genes for which no individual clinical sequencing was available at the time of patient enrollment (ASXL3, BRAT1, CLPB, KCNB1, MTOR, PIGA, PNPLA8 and MAGEL2).

A new candidate NDD gene or a previously undescribed presentation of a known NDD-associated gene that required additional experimental support was identified in twelve families. Three new disease-gene associations, and one new phenotype, were validated or reported during the study. Functional studies will need to be performed in the future for the remaining nine candidate genes, which were not included among the positive diagnoses reported here. These patients lacked causative genotypes in known disease genes, and had rare, likely pathogenic changes in biologically plausible genes that exhibited appropriate familial segregation. The possibility of a substantial number of new NDD genes fits with findings in other recent case series. From a clinical standpoint, the common identification of variants of uncertain significance in candidate disease genes creates practical dilemmas that are not experienced with traditional diagnostic testing. Given the exacting principles of validation of a new disease gene, there exists an urgent need for pre-competitive sharing of the relevant pedigrees.

This study had several limitations. It was retrospective and lacked a control group. Clinical data were collected principally through chart review, which may have led to under- or over-estimates of acute changes in management. Information about long-term consequences of diagnosis, such as the impact of genetic counseling were not ascertained. Comparisons of costs of genomic and conventional diagnostic testing excluded associated costs of testing, such as outpatient visits, and may have included tests that would nevertheless have been performed, irrespective of diagnosis. The acuity-based approach to expedited WGS and non-expedited WES was a patient-care-driven approach and was not designed to facilitate direct comparisons between the two methods.

In summary, WGS and WES provided prompt diagnoses in a substantial minority of children with NDD who were undiagnosed despite extensive diagnostic evaluations. Preliminary analyses suggested that WES was less costly than continued conventional diagnostic testing of children with NDD in whom initial testing failed to yield a diagnosis. WES-based diagnoses were found to refine treatment plans in many patients with NDD. It is suggested that sequencing of genomes or exomes of trios should become an early part of the diagnostic work-up of NDD and that accelerated sequencing modalities be extended to patients with high-acuity illness.

Study Design—

This is a retrospective analysis of patients enrolled in a biorepository at a children's hospital in the central United States. The repository comprised all families enrolled in a research WGS and WES program established to diagnose pediatric monogenic disorders. Of 155 families analyzed by WGS or WES during the first 33 months of the diagnostic program, 100 were families affected by NDD. This is a descriptive study of the 119 affected children from these families.

Study Participants—

Referring physicians were encouraged to nominate families for enrollment in cases with multiple affected children, consanguineous unions where both biologic parents were available for enrollment, infants receiving intensive care, or children with progressive NDD. WES was deferred when the phenotype was suggestive of genetic diseases not detectable by next-generation sequencing, such as triplet repeat disorders, or when standard cytogenetic testing or array-based comparative genomic hybridization had not been obtained. Post-mortem enrollment was considered for deceased probands of families receiving ongoing healthcare services at the clinic.

NDD was characterized as central or peripheral nervous system symptoms and developmental delays or disabilities. With one exception, enrollment was from subspecialty clinics at a single, urban children's hospital. This study was approved by the Institutional Review Board at Children's Mercy—Kansas City. Informed written consent was obtained from adult subjects, parents of children, and children capable of assenting.

Ascertainment of Clinical Features in Affected Children—

The clinical features of each affected child were ascertained by examination of electronic health records and communication with treating clinicians, translated into Human Phenotype Ontology (HPO) terms, and mapped to ˜4,000 monogenic diseases and ˜2,800 genes with the clinicopathologic correlation tools SSAGA (Symptom and Sign Associated Genome Analysis) and/or Phenomizer (Supplementary Table S2).

Exome Sequencing—

WES was performed in a CLIA/CAP approved laboratory under a research protocol. Exome samples were prepared with either Illumina TruSeq Exome or Nextera Rapid Capture Exome kits according to manufacturer's protocols. Exon enrichment was verified by quantitative PCR of 4 targeted loci and 2 non-targeted loci, both before and after enrichment. Samples were sequenced on Illumina HiSeq 2000 and 2500 instruments with 2×100 nt sequences.

Genome Sequencing—

Genomic DNA was prepared for WGS using either Illumina TruSeq PCR Free (rapid WGS) or TruSeq Nano (HiSeq X Ten) sample preparation according to manufacturer's protocols. Briefly, 500 ng of DNA was sheared with a Covaris S2 Biodisruptor, end-repaired, A-tailed and adaptor-ligated. Quantitation was carried out by real-time PCR. Libraries were sequenced by Illumina HiSeq 2500 instruments (2×100 nt) in rapid run mode or by HiSeq X Ten (2×150 nt).

Next Generation Sequencing Analysis—

Sequence data were generated with Illumina RTA 1.12.4.2 & CASAVA-1.8.2, aligned to the human reference NCBI 37 using GSNAP, and variants were detected and genotyped with the Genome Analysis Tool Kit, versions 1.4 and 1.6, and Alpheus v3.0. Sequence analysis used FASTQ, barn, and VCF files. Variants were called and genotyped in WES in batches, corresponding to exome pools, using GATK 1.6 with best practice recommendations. Variants were identified in WGS using GATK 1.6 without Variant Quality Score Recalibration. The largest deletion variant detected was 9,992 nt, and the largest insertion was 236 nt.

Variants were annotated with the RUNES Software (v1.0). RUNES incorporates data from ENSEMBL's Variant Effect Predictor (VEP) software, produces comparisons to NCBI dbSNP, known disease variants from the Human Gene Mutation Database, and performs additional in silico prediction of variant consequences using RefSeq and ENSEMBL gene annotations. RUNES categorized each variant according to ACMG recommendations for reporting sequence variation and with an allele frequency (MAF) derived from CPGM's Variant Warehouse database. Category 1 variants had previously been reported to be disease-causing. Category 2 variants had not previously been reported to be disease-causing, but were of types that were expected to be pathogenic (loss of initiation, premature stop codon, disruption of stop codon, whole gene deletion, frameshifting indel, disruption of splicing). Category 3 were variants of unknown significance that were potentially disease-causing (nonsynonymous substitution, in-frame indel, disruption of polypyrimidine tract, overlap with 5′ exonic, 5′ flank or 3′ exonic splice contexts). Category 4 were variants that were probably not causative of disease (synonymous variants that were unlikely to produce a cryptic splice site, intronic variants >20 nt from the intron/exon boundary, and variants commonly observed in unaffected individuals). Causative variants were identified primarily with VIKING software. Variants were filtered by limitation to ACMG Categories 1-3 and MAF<1%. All potential monogenetic inheritance patterns were examined, including de novo, recessive, dominant, X-linked, mitochondrial, and, where possible, somatic variation. Where a single likely causative variant for a recessive disorder was identified, the entire coding domain was manually inspected using the Integrated Genome Viewer for coverage, additional variants, as were variants for that locus called in the appropriate parent that may have had low coverage in the proband. Expert interpretation and literature curation were performed for all likely causative variants with regard to evidence for pathogenicity. Sanger sequencing was used for clinical confirmation and reporting of all diagnostic genotypes. Additional expert consultation and functional confirmation were performed when the subject's phenotype differed from previous mutation reports for that disease gene.

Flow Cytometry—

Allophycocyanin-conjugated antibodies to CD59 were obtained from Becton Dickinson. Detection of glycosylphosphatidylinositol (GPI)-anchored protein expression on granulocytes, B cells, and T cells was performed with a fluorescent aerolysin-based assay (Protox Biotech). Before staining white blood cells, whole blood was incubated in 1× red blood cell lysis buffer (GIBCO). The remaining nucleated cells were identified on the basis of forward and side scatter and by staining with phycoerythrin (PE)-conjugated anti-CD3 (T cells), anti-CD15 (granulocytes), and anti-CD20 (B cells) antibodies (Becton Dickinson). Acquisition and analysis was performed by flow cytometry (FACSCalibur, Becton Dickinson) and Flow Jo (Tree Star. Inc). For all cell types, the isotypic control was set at 1%.

Clinical Study 2

The following are the diagnostic and clinical findings among critically ill infants receiving rapid whole genome sequencing for identification of Mendelian disorders. Genetic disorders and congenital anomalies are the leading cause of infant mortality. Diagnosis of most genetic diseases in neonatal and pediatric intensive care units (NICU, PICU) has not occurred in time to guide clinical management. Rapid whole-genome sequencing (STATseq) was performed in a level IV NICU and PICU to examine (1) the rate and types of molecular diagnoses, and (2) the prevalence, types and impact of medically actionable diagnoses.

Retrospective comparison of STATseq and standard etiologic testing in a case series collected from the NICU and PICU of a large children's hospital between November 2011 and October 2014. The participants were 35 families with an infant aged <4 months with an acute illness of suspected genetic etiology. The intervention was STATseq of trios (parents and their affected infant). The main measures were the diagnostic rate, time to diagnosis, and rate of change in management of reference standard testing and STATseq.

The rate of diagnosis of a genetic disease was 57% by STATseq, and 9% by the reference standard (p<0.001). Median time to genome analysis was 5 days, but to confirmed clinical report was 23 days. 65% of STATseq diagnoses were associated with de novo mutations. In infants receiving a genetic diagnosis, acute clinical utility was observed in 62%, a strongly favorable impact on management occurred in 19%, palliative care was instituted in 33%, and 120-day mortality was 57%.

In selected acutely ill infants, STATseq had a high rate of diagnosis of genetic disorders. A majority of diagnoses influenced acute management. Mortality is very high among NICU and PICU infants diagnosed with a genetic disease. Since disease progression can be extremely rapid in infants, diagnoses must be very fast to allow consideration of interventions that lessen morbidity and mortality. There are over 5,300 genetic diseases of known cause. Collectively, they are the leading cause of infant mortality, particularly in neonatal intensive care units (NICUs), and pediatric intensive care units (PICUs). The premise of genomic medicine is that molecular diagnosis may allow supplementation of empiric, phenotype-driven management with genotype-differentiated treatment and genetic counseling. Timely molecular diagnoses of suspected genetic disorders were previously largely precluded in acutely ill infants by profound clinical and genetic heterogeneity, and tardiness of results of reference standard tests, such as gene sequencing. While appropriate NICU treatment is among the most cost-effective methods of high-cost health care, the long-term outcomes of these in NICU subpopulations are diverse. In genetic diseases with poor prognosis, rapid diagnosis can empower early parental discussions regarding palliative care calibrated on minimization of suffering. Methods for 50-hour diagnosis of genetic disorders by rapid whole-genome sequencing (STATseq) were previously reported. STATseq simultaneously tested almost all Mendelian illnesses, and was hypothesized to give a diagnosis in time to guide clinical management acutely in infants and children in a NICU or PICU setting. This study reports the rate and types of molecular diagnosis from STATseq and reference standard tests among phenotypic groups in the first 35 infants in a level IV NICU and PICU at a quaternary children's hospital, and the prevalence, types and results of medically actionable findings.

Methods—Study Design, Setting and Participants

This study was approved by the Institutional Review Board at Children's Mercy—Kansas City. This was a retrospective comparison of the diagnostic rate, time to diagnosis, and types of molecular diagnosis of reference standard etiologic testing, as clinically indicated, with STATseq (index test) in a case series. Participants were principally parent-child trios, enrolled in a research biorepository who received genomic sequencing to diagnose monogenic disorders of unknown etiology in affected children. Affected infants and children with suspected genetic disorders were nominated for STATseq by a treating physician, typically a neonatologist. A standard form requesting the primary signs and symptoms, past diagnostic testing results, differential diagnosis or candidate genes, pertinent family history, availability of biologic parents for enrollment, and whether STATseq would potentially affect treatment was submitted for immediate evaluation. Infants received STATseq if the likely diagnosis was of a type that was detectable by next-generation sequencing and had any potential to alter management or genetic counseling. Patients were not required to undergo standardized clinical examinations or diagnostic testing prior to referral; standard etiologic testing was performed as clinically indicated. Infants likely to have disorders associated with cytogenetic abnormalities were not accepted unless standard testing for those disorders was negative. Approximately two thirds of nominees were accepted for STATseq. Informed written consent was obtained from parents. About one half of accepted families were enrolled. Major reasons for failure to enroll were unavailability of one or more biological parents, parents were minors and unable to consent, or parental refusal to participate. 49 families with acutely ill or deceased infants and children were enrolled and received STATseq of parent-child trios. 35 of these families met inclusion criteria for this report: age of the affected infant <4 months, enrollment from a level IV NICU or PICU at the clinic between November 2011 and October 2014, acute illness of suspected monogenetic etiology in the infant, and absence of an etiologic diagnosis. Approximately 2,400 infants <4 months of age were admitted to the NICU or PICU during the study period.

Ascertainment of Clinical Features

The clinical features of affected infants were ascertained comprehensively by physician interviews and review of the medical record. Clinical features were translated into Human Phenotype Ontology (HPO) term, and mapped to ˜5,300 monogenic diseases with the clinicopathologic correlation tool Phenomizer (MD Table s1).

MD TABLE s1

| Patient | | | | | | | |
|---|---|---|---|---|---|---|---|
| ID | Signs and Symptoms | HPO # | HPO Term | Diagnosis | Gene | Rank | P-value |
| 64 | Congenital epidermolysis | HP:0001019 | Erythroderma | Y | GJB2 | 429 | 0.0069 |
| | bullosa | | | | | | |
| | Suprabasal acantholysis of | HP:0100792 | Acantholysis | | | | |
| | esophageal mucosa; Suprabasal | | | | | | |
| | intraepidermal acantholysis of | | | | | | |
| | skin and esophageal mucosa | | | | | | |
| | Erythema and desquamation of | HP:0007549 | Desquamation of skin | | | | |
| | skin, 80-85% body surface area | | soon after birth | | | | |
| | Nail dystrophy | HP:0008404 | Nail dystrophy | | | | |
| | Metabolic acidosis | HP:0001942 | Metabolic acidosis | | | | |
| | Conjunctivitis | HP:0000509 | Conjunctivitis | | | | |
| | Erythema | HP:0010783 | Erythema | | | | |
| | Neutropenia | HP:0001875 | Neutropenia | | | | |
| | Thrombocytopenia | HP:0001873 | Thrombocytopenia | | | | |
| | Left intraventricular | HP:0002170 | Intracranial hemorrhage | | | | |
| | hemorrhage, Grade I | | | | | | |
| | Septicemia | HP:0100806 | Sepsis | | | | |
| | Abdominal distention | HP:0003270 | Abdominal distention | | | | |
| | Tongue/oral ulceration | HP:0000155 | Oral ulcer | | | | |
| | Oral blisters | HP:0200097 | Oral mucosa blisters | | | | |
| | Absent eyebrows | HP:0002223 | Absent eyebrow | | | | |
| | Absent eyelashes | HP:0000561 | Absent eyelashes | | | | |
| | Anemia | HP:0001903 | Anemia | | | | |
| | Bloody stools | HP:0002573 | Hematochezia | | | | |
| | Tachycardia | HP:0001649 | Tachycardia | | | | |
| | Preeclampsia | HP:0100602 | Preeclampsia | | | | |
| | Prematurity @33 weeks | HP:0001622 | Premature birth | | | | |
| | Respiratory failure requiring | HP:0004887 | Respiratory failure | | | | |
| | ventilation | | requiring assisted | | | | |
| | | | ventilation | | | | |
| | Absent scalp hair | HP:0001596 | Alopecia | | | | |
| 172 | Bitemporal narrowing | HP:0000341 | Narrow forehead | Y | BRAT1 | 3252 | 0.8110 |
| | Flat nasal bridge | HP:00005280 | Depressed nasal bridge | | | | |
| | Low posterior hairline | HP:0002162 | Low posterior hairline | | | | |
| | Labial hypoplasia | HP:0000066 | Labial hypoplasia | | | | |
| | Upward slanting palpebral | HP:0000582 | Upslanted palpebral | | | | |
| | fissures | | fissures | | | | |
| | Cortical thumbs | HP:0001188 | Hand clenching | | | | |
| | Ankle clonus | HP:0011448 | Ankle clonus | | | | |
| | Microcephaly | HP:0011451 | Congenital | | | | |
| | | | microcephaly | | | | |
| | Focal seizures with sharp wave | HP:0007359 | Focal seizures | | | | |
| | activity, central/centro-temporal | | | | | | |
| | regions | | | | | | |
| | Micrognathia | HP:0000347 | Micrognathia | | | | |
| | Prominent upturned nose | HP:0000463 | Anteverted nares | | | | |
| | Uplifted ear lobes | HP:0009909 | Uplifted earlobe | | | | |
| | Bilateral 2-3 toe syndactyly | HP:0004691 | 2-3 toe syndactyly | | | | |
| | R > L | | | | | | |
| | Thin lips | HP:0000213 | Thin lips | | | | |
| | Hypertonia | HP:0001276 | Hypertonia | | | | |
| | Small size | HP:0001518 | Small for gestational | | | | |
| | | | age | | | | |
| 184/185 | D-transposition of the great | HP:0011607 | Transposition of the | Y | MMP21 | not ranked | |
| | arteries | | great arteries with | | | | |
| | | | ventricular septal defect | | | | |
| | TAPVR | HP:0011720 | Cardiac total anomalous | | | | |
| | | | pulmonary venous connection | | | | |
| | dextrocardia | HP:0001651 | Dextrocardia | | | | |
| | situs inversus | HP:0003363 | Abdominal situs | | | | |
| | | | inversus | | | | |
| | pulmonary valve atresia | HP:0010882 | Pulmonary valve atresia | | | | |
| | interrupted inferior vena | HP:0011671 | Interrupted inferior vena | | | | |
| | cava with azygous | | cava with azygous | | | | |
| | continuation | | continuation | | | | |
| | ear dimple | no term | | | | | |
| | sacral dimple | HP:0000960 | Sacral dimple | | | | |
| | Mongolian spots | HP:0011369 | Mongolian blue spot | | | | |
| 436 | hypertelorism | HP:0000316 | Hypertelorism | N | | | |
| | brachycephaly | HP:0000248 | Brachycephaly | | | | |
| | ventriculomegaly | HP:0002119 | Ventriculomegaly | | | | |
| | encephalomalacia | no term | | | | | |
| | cervical spine stenosis | HP:0003319 | Abnormality of the | | | | |
| | | | cervical spine | | | | |
| | intrahepatic ductal dilatation | HP:0011040 | Abnormality of the | | | | |
| | | | intrahepatic bile ducts | | | | |
| | moderate pda | HP:0001643 | Patent ductus arteriosus | | | | |
| | right ventricular hypertrophy | HP:0001667 | Right ventricular | | | | |
| | | | hypertrophy | | | | |
| | fenetstrated secundum ASD | HP:0001684 | Secundum atrial septal | | | | |
| | | | defect | | | | |
| | diffuse slowing on EEG | HP:0010845 | EEG with generalized | | | | |
| | | | slow activity | | | | |
| | gastroschisis | HP:0001543 | Gastroschisis | | | | |
| | unilateral hearing loss | HP:0000365 | Hearing impairment | | | | |
| | pulmonary hypertension | HP:0002092 | Pulmonary | | | | |
| | | | hypertension | | | | |
| | malrotation | HP:0002566 | Intestinal malrotation | | | | |
| | jaw contracture | HP:0000277 | Abnormality of the | | | | |
| | | | mandible | | | | |
| | wrist contracture | HP:0001239 | Wrist flexion | | | | |
| | | | contracture | | | | |
| | ankle contracture | HP:0006466 | Ankle contracture | | | | |
| | hypoplastic hands | not entered as description is incomplete | | | | | |
| | interdigital webbing fingers | HP:0006101 | Finger syndactyly | | | | |
| | poor growth | HP:0008897 | Postnatal growth | | | | |
| | | | retardation | | | | |
| 487 | Right hydrocele | HP:0000034 | Hydrocele testis | Y | PRF1 | 291 | 0.1411 |
| | Infra-orbital crease | HP:0100876 | Infra-orbital crease | | | | |
| | Maternal diabetes | HP:0009800 | Maternal diabetes | | | | |
| | Posteriorly rotated ears, | HP:0000368 | Low-set, posteriorly | | | | |
| | borderline low-set | | rotated ears | | | | |
| | Feeding difficulties | HP:0008872 | Feeding difficulties in | | | | |
| | | | infancy | | | | |
| | Venitlator dependent | HP:0005946 | Ventilator dependence | | | | |
| | | | with inability to wean | | | | |
| | Two vessel umbilical cord | HP:0001195 | Single umbilical artery | | | | |
| | Cholestasis | HP:0001396 | Cholestasis | | | | |
| | Thrombocytopenia | HP:0001873 | Thrombocytopenia | | | | |
| | Prolonged partial | HP:0003645 | Prolonged partial | | | | |
| | thromboplastin time | | thromboplastin time | | | | |
| | Prolonged prothrombin time | HP:0008151 | Prolonged prothrombin | | | | |
| | | | time | | | | |
| | Chronic lung disease | HP:0006528 | Chronic lung disease | | | | |
| | Normal to mildly increased eye | HP:0000316 | Hypertelorism | | | | |
| | spacing | | | | | | |
| | Congenital scoliosis | HP:0002944 | Thoracolumbar | | | | |
| | | | scoliosis | | | | |
| | Bronchopulmonary dysplasia | HP:0006533 | Bronchodysplasia | | | | |
| | Congenital omphalocele | HP:0001539 | Omphalocele | | | | |
| | Dimpled chin | HP:0010751 | Chin dimple | | | | |
| | Duplicated right | HP:0000081 | Duplicated collecting | | | | |
| | kidney/collecting system | | system | | | | |
| | Ventricular hypertrophy | HP:0001714 | Ventricular hypertrophy | | | | |
| | Nevus flammeus, right eyelid | HP:0001052 | Nevus flammeus | | | | |
| | GERD | HP:0002020 | Gastroesophageal | | | | |
| | | | reflux | | | | |
| 531 | omphalocele | HP:0001539 | Omphalocele | N | | | |
| | 2 vessel cord | HP:0001195 | Single umbilical artery | | | | |
| | congenital nephrotic syndrome | HP:0000100 | Nephrotic syndrome | | | | |
| | undescended testicle | HP:0000028 | Cryptorchidism | | | | |
| | hypothyroidism | HP:0000851 | Congenital | | | | |
| | | | hypothyroidism | | | | |
| | vsd | HP:0011623 | Muscular ventricular | | | | |
| | | | septal defect | | | | |
| 545 | prenatal ascites | HP:0001791 | Fetal ascites | Y | PTPN11 | 1194 | 0.3731 |
| | prenatal pericardial effusion | HP:0001698 | Pericardial effusion | | | | |
| | prenatal pleural effusions | HP:0002202 | Pleural effusion | | | | |
| | absent septum cavum | HP:0001331 | Absent septum | | | | |
| | pellucidum | | pellucidum | | | | |
| | partially absent corpus callosum | HP:0001338 | Partial agenesis of the | | | | |
| | | | corpus callosum | | | | |
| | dilated colon | HP:0100016 | Abnormality of the | | | | |
| | | | mesentery | | | | |
| | GI perforation | no term | | | | | |
| | hypoglycemia | HP:0001998 | Neonatal hypoglycemia | | | | |
| | chylothorax | HP:0010310 | Chylothorax | | | | |
| | receding chin | HP:0000278 | Retrognathia | | | | |
| | tall forehead | HP:0000348 | High forehead | | | | |
| | open metopic suture | HP:0005556 | Abnormality of the | | | | |
| | | | metopic suture | | | | |
| | sparse eyebrows | HP:0000535 | Sparse eyebrow | | | | |
| | lowset, posteriorly rotated ears | HP:0000368 | Low-set, posteriorly | | | | |
| | | | rotated ears | | | | |
| | elfin appearance to ears | HP:0100810 | Pointed helix | | | | |
| | almond-shaped eyes | HP:0007874 | Almond-shaped | | | | |
| | | | palpebral fissure | | | | |
| | epicanthal folds | HP:0007930 | Prominent epicanthal | | | | |
| | | | folds | | | | |
| | redundant upper eyelid tissue | No term | | | | | |
| | sparse eyelashes | HP:0000653 | Sparse eyelashes | | | | |
| | wide flat nasal bridge | HP:0000431 | Wide nasal bridge | | | | |
| | short upturned nose | HP:0003196 | Short nose | | | | |
| | anteverted nares | HP:0000463 | Anteverted nares | | | | |
| | bulbous nasal tip | HP:0000414 | Bulbous nose | | | | |
| | redundant skin folds at neck | HP:0005989 | Redundant neck skin | | | | |
| | wide-spaced nipples | HP:0006610 | Wide intermamillary | | | | |
| | | | distance | | | | |
| | redundant skin on limbs | HP:0007595 | Redundant skin in | | | | |
| | | | infancy | | | | |
| | decreased tone | HP:0001319 | Neonatal hypotonia | | | | |
| | doughy skin | HP:0001027 | Soft, doughy skin | | | | |
| 569 | hyperammonemia | HP:0008281 | Acute | Y | ABCC8 | 21 | 0.0009 |
| | | | hyperammonemia | | | | |
| | abnormal insulin level | HP:0000825 | Hyperinsulinemic | | | | |
| | | | hypoglycemia | | | | |
| | hypoketotic hypoglycemia | HP:0001985 | Hypoketotic | | | | |
| | | | hypoglycemia | | | | |
| | lactic acidemia | HP:0003128 | Lactic acidosis | | | | |
| | recurrent hypoglycemia | HP:0004914 | Recurrent infantile | | | | |
| | | | hypoglycemia | | | | |
| 578 | hypoglycemia | HP:0001998 | Neonatal hypoglycemia | Y | PTPN11 | 1408 | 1.0000 |
| | hepatosplenomegaly | HP:0001433 | Hepatosplenomegaly | | | | |
| | hypertrophic cardiomyopathy | HP:0001639 | Hypertrophic | | | | |
| | | | cardiomyopathy | | | | |
| | apnea | HP:0005949 | Apneic episodes in | | | | |
| | | | infancy | | | | |
| | large for gestational age | HP:0001520 | Large for gestational | | | | |
| | | | age | | | | |
| 586 | Neonatal hypoglycemia | HP:0001998 | Neonatal | Y | MT:TE | 5 | 0.0024 |
| | | | Hypoglycemia | | | | |
| | Lactic acidosis | HP:0003128 | Lactic acidosis | | | | |
| | Elevated hepatic transaminases | HP:0002910 | Elevated hepatic | | | | |
| | | | transaminases | | | | |
| | Generalized hypotonia | HP:0001290 | Generalized hypotonia | | | | |
| | Severe failure to thrive | HP:0001525 | Severe failure to thrive | | | | |
| | Hyperinsulinemia hypoglycemia | HP:0000825 | hyperinsulinemic | | | | |
| | | | hypoglycemia | | | | |
| 597 | Hypoglycemia | HP:0001943 | Hypoglycemia | N | | | |
| | Hyperinsulinemia | HP:0000842 | Hyperinsulinemia | | | | |
| | Prematurity | HP:0001622 | Premature birth | | | | |
| | IUGR | HP:0001511 | Intrauterine growth | | | | |
| | | | retardation | | | | |
| | Jaundice | HP:0003265 | Neonatal | | | | |
| | | | hyperbilirubinemia | | | | |
| 629 | decreased fetal movements | HP:0001558 | Decreased fetal | Y | SCN2A | 4509 | 1.0000 |
| | | | movement | | | | |
| | enlarged fontanelles | HP:0000239 | Large fontanelles | | | | |
| | scoliosis | HP:0002650 | Scoliosis | | | | |
| | joint contractures | HP:0002803 | Congenital contractures | | | | |
| | rocker bottom feet | HP:0001838 | Vertical talus | | | | |
| | hypoglycemia | HP:0001998 | Neonatal hypoglycemia | | | | |
| | hyponatremia | P:0002902 | Hyponatremia | | | | |
| | small for gestational age | HP:0001518 | Small for gestational | | | | |
| | | | age | | | | |
| | relative macrocephaly | HP:0004482 | Relative macrocephaly | | | | |
| | epicanthus | HP:0000286 | Epicanthus | | | | |
| | mild ptosis | HP:0000508 | Ptosis | | | | |
| | abdominal wall hypoplasia | HP:0010318 | Aplasia/Hypoplasia of | | | | |
| | | | the abdominal wall | | | | |
| | polymicrogyria | HP:0002126 | Polymicrogyria | | | | |
| 659 | ambiguous genitalia | HP:0000061 | Ambiguous genitalia, | Y | KAT6B | 3 | 0.0747 |
| | | | female | | | | |
| | breech presentation | HP:0001623 | Breech presentation | | | | |
| | enlarged kidneys | HP:0000105 | Enlarged kidneys | | | | |
| | club feet | HP:0001762 | Talipes equinovarus | | | | |
| | prematurity | HP:0001622 | Premature birth | | | | |
| | absent corpus callosum | HP:0001274 | Agenesis of corpus | | | | |
| | | | callosum | | | | |
| | low set, posteriorly rotated ears | HP:0000368 | Low-set, posteriorly | | | | |
| | | | rotated ears | | | | |
| | camptodactyly | HP:0100490 | Camptodactyly of | | | | |
| | | | finger | | | | |
| | flexion contractures | HP:0001371 | Flexion contracture | | | | |
| 672 | EEG: severe encephalopathy | HP:0010851 | EEG with burst | Y | KCNQ2 | 111 | 0.0553 |
| | with a burst suppression pattern | | suppression | | | | |
| | (Ohtahara-like | HP:0010818 | Generalized tonic | | | | |
| | tonic seizure activity with | | seizures | | | | |
| | tongue thrusting, “mouthing”, | | | | | | |
| | arching/writhing movements. | | | | | | |
| | Repetitive pedaling motion. | | | | | | |
| | Severe encephalopathy | HP:0001298 | Encephalopathy | | | | |
| | MRI: suggestive of | HP:0001302 | Pachygyria | | | | |
| | pachygyria/polymicrogyria | | | | | | |
| | MRI: suggestive of | HP:0002126 | Polymicrogyria | | | | |
| | pachygyria/polymicrogyria | | | | | | |
| | Decorticate posturing of upper | HP:0011444 | Decorticate rigidity | | | | |
| | extremities | | | | | | |
| | Frontal bossing | HP:0002007 | Frontal bossing | | | | |
| | Depressed nasal bridge | HP:0005280 | Depressed nasal bridge | | | | |
| | Anteverted nares | HP:0000463 | Anteverted nares | | | | |
| | Pilonidal dimple | HP:0000960 | Sacral dimple | | | | |
| | Polyhydramnios | HP:0001561 | Polyhydramnios | | | | |
| | Maternal gestational diabetes | HP:0009800 | Maternal diabetes | | | | |
| 675 | Cleft palate | HP:0000175 | Cleft palate | N | | | |
| | Large fontanelles | HP:0000239 | Large fontanelles | | | | |
| | Large head | HP:0004482 | Relative macrocephaly | | | | |
| | Elevated C5DC | HP:0003150 | Glutaric aciduria | | | | |
| | Elevated very long chain fas | HP:0008167 | Very long chain fatty | | | | |
| | | | acid accumulation | | | | |
| | supravalvular pulmonary | HP:0001642 | Pulmonic stenosis | | | | |
| | stenosis | | | | | | |
| | Dysmorphic ears | HP:0000377 | Abnormality of the | | | | |
| | | | pinna | | | | |
| | Low-set posteriorly rotated ears | HP:0000368 | Low-set, posteriorly | | | | |
| | | | rotated ears | | | | |
| | Hydronephrosis | HP:0000126 | Hydronephrosis | | | | |
| | Unilateral absent kidney | HP:0000122 | Unilateral renal | | | | |
| | | | agenesis | | | | |
| | Nail hypoplasia | HP:0008386 | Aplasia/Hypoplasia of | | | | |
| | | | the nails | | | | |
| | Short extremities | HP:0008905 | Rhizomelia | | | | |
| | Short hand | HP:0004279 | Short palm | | | | |
| | Short fingers | HP:0009803 | Short phalanx of finger | | | | |
| 678 | oliguria | HP:0100520 | Oliguria | Y | GNPTAB | 573 | 1.0000 |
| | microcolon | HP:0004388 | Microcolon | | | | |
| | oligohydramnios | HP:0001562 | Oligohydramnios | | | | |
| | osteopenia | HP:0000938 | Osteopenia | | | | |
| | AV canal heart defect | HP:0011576 | Intermediate | | | | |
| | | | atrioventricular canal | | | | |
| | | | defect | | | | |
| | thrombocytopenia | HP:0001873 | Thrombocytopenia | | | | |
| | anemia | HP:0001903 | Anemia | | | | |
| | femur fracture | HP:0003084 | Fractures of the long | | | | |
| | | | bones | | | | |
| | cardiomegaly | HP:0001640 | Cardiomegaly | | | | |
| | pulmonary edema | HP:0100598 | Pulmonary edema | | | | |
| | growth restriction | HP:0001511 | Intrauterine growth | | | | |
| | | | retardation | | | | |
| | large optic nerves | HP:0000587 | Abnormality of the | | | | |
| | | | optic nerve | | | | |
| | undermineralization of bones | HP:0005474 | Decreased calvarial | | | | |
| | | | ossification | | | | |
| | elevated alkaline phosphatase | HP:0003155 | Elevated alkaline | | | | |
| | | | phosphatase | | | | |
| | choledochal cyst | HP:0100890 | Cyst of the ductus | | | | |
| | | | choledochus | | | | |
| 680 | breech presentation | HP:0001623 | Breech presentation | Y | SCN2A | 157 | 0.3165 |
| | hypoglycemia | HP:0001998 | Neonatal hypoglycemia | | | | |
| | tachypnea | HP:0002098 | Respiratory distress | | | | |
| | multifocal (central onset) | HP:0001250 | Seizures | | | | |
| | seizures | | | | | | |
| | abnormal EEG | HP:0002353 | EEG abnormality | | | | |
| | myoclonic jerks | HP:0001336 | Myoclonus | | | | |
| | periventricular signal | HP:0002518 | Abnormality of the | | | | |
| | hyperintensity | | periventricular white | | | | |
| | | | matter | | | | |
| | decreased CSF glucose | HP:0002921 | Abnormality of the | | | | |
| | | | cerebrospinal fluid | | | | |
| 718 | patent ductus arteriosis | HP:0001643 | Patent ductus arteriosis | N | | | |
| | cardiomegaly | HP:0001640 | Cardiomegaly | | | | |
| | abnormal pulmonary veins | HP:0011718 | Abnormality of | | | | |
| | | | pulmonary veins | | | | |
| | right aortic arch | HP:0012020 | Right aortic arch | | | | |
| | left ventricular abnormality | HP:0001711 | Abnormality of the left | | | | |
| | | | ventricle | | | | |
| | aortic regurgitation | HP:0001659 | Aortic regurgitation | | | | |
| | L-looping of right ventricle | HP:0011544 | L-looping of the right | | | | |
| | | | ventricle | | | | |
| | primum atrial septal defect | HP:0010445 | Primum atrial septal | | | | |
| | | | defect | | | | |
| | tricuspid regurgitation | HP:0005180 | Tricuspid regurgitation | | | | |
| | persistent left superior vena | HP:0005301 | Persistent left superior | | | | |
| | cava | | vena cava | | | | |
| | dextrocardia | HP:0001651 | Dextrocardia | | | | |
| | transposition of the great | HP:0001669 | Transposition of the | | | | |
| | arteries | | great arteries | | | | |
| | right ventricular hypertrophy | HP:0001667 | Right ventricular | | | | |
| | | | hypertrophy | | | | |
| | hypoplastic left heart | HP:0004383 | Hypoplastic left heart | | | | |
| | unbalanced atrioventricular | HP:0011579 | Unbalanced | | | | |
| | canal defect | | atrioventricular canal | | | | |
| | | | defect | | | | |
| | secundum ASD | HP:0001684 | Secundum atrial septal | | | | |
| | | | defect | | | | |
| | single ventricle | HP:0001750 | Single ventricle | | | | |
| | coronary artery fistula | HP:0011641 | Coronary artery fistula | | | | |
| | pulmonary valve atresia | HP:0010882 | Pulmonary valve atresia | | | | |
| | bulbous nasal tip | HP:0000414 | Bulbous nose | | | | |
| | retrognathia | HP:0000278 | Retrognathia | | | | |
| | small forehead | HP:0000350 | Small forehead | | | | |
| | creased earlobes | HP:0009908 | Anterior creases of | | | | |
| | | | earlobe | | | | |
| | small ears | HP:0008551 | Microtia | | | | |
| | Microcephaly | HP:0000252 | Microcephaly | | | | |
| | widely-spaced nipples | HP:0006610 | Wide intermammillary | | | | |
| | | | distance | | | | |
| | long toes | HP:0010511 | Long toe | | | | |
| | tapered fingers | HP:0001182 | Tapered finger | | | | |
| | sacral dimple | HP:0000960 | Sacral dimple | | | | |
| | respiratory distress | HP:0002643 | Neonatal respiratory | | | | |
| | | | distress | | | | |
| | teratogen exposure | HP:0011438 | Maternal teratogenic | | | | |
| | | | exposure | | | | |
| 725 | bilateral cleft lip/palate | HP:0002744 | Bilateral cleft lip and | Y | CHD7 | 40 | 0.0035 |
| | | | palate | | | | |
| | bilateral hydronephrosis | HP:0000126 | Hydronephrosis | | | | |
| | left ventricular hypertrophy | HP:0001712 | Left ventricular | | | | |
| | | | hypertrophy | | | | |
| | double outlet right ventricle | HP:0011655 | Double outlet right ventricle | | | | |
| | with subaortic VSD and | | with subaortic VSD | | | | |
| | pulmonary stenosis | | and pulmonary stenosis | | | | |
| | ASD/PFO | HP:0001631 | Defect in the atrial | | | | |
| | | | septum | | | | |
| | undescended testis (unilateral) | HP:0000028 | Cryptorchidism | | | | |
| | microphthalmia | HP:0000568 | Microphthalmos | | | | |
| | anophthalmia | HP:0000528 | Anophthalmia | | | | |
| | profound hearing loss | HP:0008527 | Congenital | | | | |
| | | | sensorineural hearing | | | | |
| | | | impairment | | | | |
| | profound hearing loss | HP:0008591 | Congenital conductive | | | | |
| | | | hearing impairment | | | | |
| | orbital cyst | HP:0001144 | Orbital cyst | | | | |
| | corneal hazing | HP:0007957 | Corneal opacity | | | | |
| | optic nerve coloboma | HP:0000588 | Optic nerve coloboma | | | | |
| | retinal coloboma | HP:0007744 | Iridoretinal coloboma | | | | |
| | iris and fundus coloboma | HP:0007748 | Irido-fundal coloboma | | | | |
| | magna cisterna magna | HP:0002280 | Enlarged cisterna | | | | |
| | | | magna | | | | |
| | cerebellar dysplasia | HP:0007033 | Cerebellar dysplasia | | | | |
| | craniocervical fusion | HP :0002949 | Fused cervical | | | | |
| | | | vertebrae | | | | |
| 728 | premature birth | HP:0001622 | Premature birth | N | | | |
| | pleural effusion | HP:0002202 | Pleural effusion | | | | |
| | neonatal depression requiring | HP:0002643 | Neonatal respiratory | | | | |
| | chest compressions | | distress | | | | |
| | hydrops fetalis | HP:0001789 | Hydrops fetalis | | | | |
| | | HP:0010944 | Abnormality of the | | | | |
| | grade I pelviectasis | | renal pelvis | | | | |
| | | HP:0002092 | Pulmonary | | | | |
| | pulmonary hypertension | | hypertension | | | | |
| | low-set ears | HP:0000369 | Low-set ears | | | | |
| | wide neck | HP:0000465 | Webbed neck | | | | |
| 731 | complete AV canal | HP:0001674 | Complete | N | | | |
| | | | atrioventricular canal | | | | |
| | | | defect | | | | |
| | Double outlet right ventricle | HP:0001719 | Double outlet right | | | | |
| | | | ventricle | | | | |
| | hypoplastic left heart | HP:0004383 | Hypoplastic left heart | | | | |
| | pulmonary artery atresia | HP:0004935 | Pulmonary artery | | | | |
| | | | atresia | | | | |
| | situs inversus | HP:0001696 | Situs inversus totalis | | | | |
| 743 | apnea | HP:0002882 | Sudden episodic apnea | N | | | |
| | seizure | HP:0002197 | Generalized seizures | | | | |
| | burst suppression | HP:001851 | EEG with burst | | | | |
| | | | suppression | | | | |
| | temporal sharp burst | HP:0011296 | EEG with temporal | | | | |
| | | | sharp waves | | | | |
| | epileptic encephalopathy | HP:0200134 | Epileptic | | | | |
| | | | encephalopathy | | | | |
| 773 | respiratory distress | HP:0002045 | Hypothermia | N | | | |
| | pneumothorax | HP:0004876 | Spontaneous neonatal | | | | |
| | | | pneumothorax | | | | |
| | persistent pulmonary | HP:0011726 | Persistent fetal | | | | |
| | hypertension | | circulation | | | | |
| | mid-muscular VSD | HP:0011623 | Muscular ventricular | | | | |
| | | | septal defect | | | | |
| | small PDA | HP:0001643 | Patent ductus arteriosus | | | | |
| | polyhydramnios | HP:0001561 | Polyhydramnios | | | | |
| | hypothermia | HP:0002643 | Neonatal respiratory | | | | |
| | | | distress | | | | |
| | hydrocephalus/ventriculomegaly | HP:0000238 | Hydrocephalus | | | | |
| 809 | RBC macrocytosis | HP:0005518 | Erythrocyte | Y | PTPN11 | 181 | 0.9538 |
| | | | macrocytosis | | | | |
| | thrombocytopenia | HP:0001873 | Thrombocytopenia | | | | |
| | Elevated creatinine | HP:0003259 | Elevated serum | | | | |
| | | | creatinine | | | | |
| | hydrops fetalis | HP:0001789 | Hydrops fetalis | | | | |
| | Low alkaline phosphatase | HP:0003282 | Low alkaline | | | | |
| | | | phosphatase | | | | |
| | Concentric hypertrophic | HP:0005157 | Concentric | | | | |
| | cardiomyopathy | | hypertrophic | | | | |
| | | | cardiomyopathy | | | | |
| | patent ductus arteriosis | HP:0001643 | Patent ductus arteriosus | | | | |
| | Low-set ears | HP:0000369 | Low-set ears | | | | |
| | Abnormal renal | HP:0005932 | Abnormal renal | | | | |
| | corticomedullary differentiation | | corticomedullary | | | | |
| | | | differentiation | | | | |
| | Abnormal renal pelvices | HP:0010944 | Abnormality of the | | | | |
| | | | renal pelvis | | | | |
| | Hypoplasia of the corpus | HP:0007370 | Aplasia/Hypoplasia of | | | | |
| | callosum | | the corpus callosum | | | | |
| | 2-3 toe syndactyly | HP:0005709 | 2-3 toe cutaneous | | | | |
| | | | syndactyly | | | | |
| 846 | no respiratory effort at birth | HP:0002104 | Apnea | Y | PHOX2B | 2429 | 0.8489 |
| | | HP:0002643 | Neonatal respiratory | | | | |
| | | | distress | | | | |
| | polyhydramnios | HP:0001563 | Fetal polyuria | | | | |
| | hypotonia | HP:0008935 | Generalized neonatal | | | | |
| | | | hypotonia | | | | |
| | seizure | HP:0001250 | Seizures | | | | |
| | encephalopathy | HP:0007239 | Congenital | | | | |
| | | | encephalopathy | | | | |
| | hypertonia | HP:0001276 | Hypertonia | | | | |
| | thin upper lip | HP:0000219 | Thin upper lip | | | | |
| | | | vermilion | | | | |
| | hypoplastic alae nasae | HP:0000430 | Underdeveloped nasal | | | | |
| | | | alae | | | | |
| | long digits | HP:0100807 | Long fingers | | | | |
| | | HP:0010511 | Long toe | | | | |
| | optic nerve hypoplasia | HP:0000609 | Optic nerve hypoplasia | | | | |
| | fixed dilated pupils | no term | | | | | |
| | unilateral facial droop | HP:0010628 | Facial palsy | | | | |
| 852 | hyperinsulinism | HP:0000842 | Hyperinsulinemia | N | | | |
| | undescended testes | HP:0000028 | Cryptorchidism | | | | |
| | chordee | HP:0000041 | Chordee | | | | |
| | prematurity | HP:0001622 | Premature birth | | | | |
| | VSD | HP:0001629 | Ventricular septal | | | | |
| | | | defect | | | | |
| 855 | hypoplastic right heart | HP:0010954 | Hypoplastic right heart | Y | GATA6 | 1 | 0.0083 |
| | triscuspid valve stenosis | HP:0010446 | Tricuspid stenosis | | | | |
| | hypoplastic right ventricle | no term--part of hypoplastic right heart | | | | | |
| | pulmonic stenosis | HP:0001642 | Pulmonic stenosis | | | | |
| | neonatal diabetes | HP:0000857 | Neonatal insulin- | | | | |
| | | | dependent diabetes | | | | |
| | biliary atresia | HP:0005912 | Biliary atresia | | | | |
| | absent gallbladder | HP:0011466 | Aplasia/Hypoplasia of | | | | |
| | | | the gallbladde | | | | |
| 873 | cataracts | HP:0000519 | Congenital cataract | Y | LAMB2 | 52 | 0.1165 |
| | microphthalmia | HP:0000568 | Microphthalmos | | | | |
| | hyponatremia | HP:0002902 | Hyponatremia | | | | |
| | hyperkalemia | HP:0002153 | Hyperkalemia | | | | |
| | nephrotic syndrome | HP:0008677 | Congenital nephrotic | | | | |
| | | | syndrome | | | | |
| | retinal detachment | HP:0000541 | Retinal detachment | | | | |
| | left pulmonary artery stenosis | HP:0004415 | Pulmonary artery | | | | |
| | | | stenosis | | | | |
| | hyperplastic primary vitreous | HP:0007968 | Persistent hyperplastic | | | | |
| | | | primary vitreous | | | | |
| 879 | diphragmatic hernia | HP:0000776 | Congenital | | | | |
| | | | diaphragmatic hernia | N | | | |
| | | HP:0009110 | Diaphragmatic | | | | |
| | | | eventration | | | | |
| | cleft lip/palate | HP:0000175 | Cleft palate | | | | |
| | | HP:0000202 | Oral cleft | | | | |
| | | HP:0100333 | Unilateral cleft lip | | | | |
| | ASD | HP:0001631 | Defect in the atrial | | | | |
| | | | septum | | | | |
| | VSD | HP:0011623 | Muscular ventricular | | | | |
| | | | septal defect | | | | |
| | PDA | HP:0001643 | Patent ductus arteriosus | | | | |
| | hypertelorism | HP:0000316 | Hypertelorism | | | | |
| | epicanthal folds | HP:0000286 | Epicanthus | | | | |
| | ectopic pupil | HP:0009918 | Ectopia pupillae | | | | |
| | micrognathia | HP:0000347 | Micrognathia | | | | |
| | extrarenal pelvices | HP:0010944 | Abnormality of the | | | | |
| | | | renal pelvis | | | | |
| | pelviectasis | HP:0010946 | Dilatation of the renal | | | | |
| | | | pelvis | | | | |
| | dysplastic ears | HP:0000377 | Abnormality of the | | | | |
| | | | pinna | | | | |
| | low-set ears | HP:0000369 | Low-set ears | | | | |
| | small earlobes | HP:0000385 | Small earlobe | | | | |
| | preauricular pit | HP:0004467 | Preauricular pit | | | | |
| | broad nasal tip | HP:0000455 | Broad nasal tip | | | | |
| | flat short nasal bridge | HP:0003194 | Short nasal bridge | | | | |
| | increased nuchal thickness | HP:0000474 | Thickened nuchal skin | | | | |
| | | | fold | | | | |
| | sacral dimple | HP:0000960 | Sacral dimple | | | | |
| | broad thumbs | HP:0011304 | Broad thumb | | | | |
| | deviated thumbs | HP:0009603 | Deviation/Displacement | | | | |
| | | | of the thumb | | | | |
| | prominent fingertip pads | HP:0001212 | Prominent fingertip | | | | |
| | | | pads | | | | |
| | hypoplastic triangular nails | HP:0008386 | Aplasia/Hypoplasia of | | | | |
| | | | the nails | | | | |
| 890 | bilateral choanal atresia | HP:0004502 | Bilateral choanal atresia | Y | FGFR2 | 1 | 0.0030 |
| | Cloverleaf skull | HP:0002676 | Cloverleaf skull | | | | |
| | Downslanting palpebral fissures | HP:0000494 | Downslanted palpebral | | | | |
| | | | fissures | | | | |
| | Frontal bossing | HP:0002007 | Frontal bossing | | | | |
| | Micrognathia | HP:0000347 | Micrognathia | | | | |
| | Aqueductal stenosis | HP:0002410 | Aqueductal stenosis | | | | |
| | Craniosynostosis | HP:0011324 | Multiple suture | | | | |
| | | | craniosynostosis | | | | |
| | Exophthalmos | HP:0000520 | Proptosis | | | | |
| | Gastroschisis | HP:0001543 | Gastroschisis | | | | |
| | Low-set ears | HP:0000369 | Low-set ears | | | | |
| | Arnold-Chiari malformation | HP:0002308 | Arnold-Chiari | | | | |
| | | | malformation | | | | |
| | Noncommunicationg | HP:0010953 | Noncommunicating | | | | |
| | hydrocephalus | | hydrocephalus | | | | |
| | Porencephaly | HP:0002132 | Porencephaly | | | | |
| | Ventriculomegaly | HP:0002119 | Ventriculomegaly | | | | |
| | Broad thumbs | HP:0011304 | Broad thumb | | | | |
| | Increased sandal gap | HP:0001852 | Sandal gap | | | | |
| | Rockerbottom feet | HP:0001838 | Vertical talus | | | | |
| 893 | Potter facies | HP:0002009 | Potter facies | N | | | |
| | Congenital cataract | HP:0000519 | Congenital cataract | | | | |
| | Partial aniridia | HP:0011498 | Partial aniridia | | | | |
| | Absent bladder | HP:0010477 | Aplasia of the bladder | | | | |
| | Bilateral renal agenesis | HP:0010958 | Bilateral renal agenesis | | | | |
| | Pulmonary hypoplasia | HP:0002089 | Pulmonary hypoplasia | | | | |
| | Thoracic hemivertebrae | HP:0008467 | Thoracic hemivertebrae | | | | |
| | Thoracic scoliosis | HP:0002943 | Thoracic scoliosis | | | | |
| 902 | PPHTN | HP:0011726 | Persistent fetal | Y | CHD7 | 666 | 0.3540 |
| | | | circulation | | | | |
| | | HP:0002092 | Pulmonary | | | | |
| | | | hypertension | | | | |
| | multicystic, dysplastic kidney | HP:0000003 | Multicystic kidney | | | | |
| | | | dysplasia | | | | |
| | lowset posteriorly rotated ears | HP:0000368 | Low-set, posteriorly | | | | |
| | | | rotated ears | | | | |
| | microtia | HP:0008551 | Microtia | | | | |
| | | HP:0000356 | Abnormality of the | | | | |
| | ear fused to scalp | | outer ear | | | | |
| | short webbed neck | HP:0000470 | Short neck | | | | |
| | | HP:0000465 | Webbed neck | | | | |
| | choroid plexus cysts | HP:0002190 | Choroid plexus cyst | | | | |
| | thalamic cyst | no term | | | | | |
| | aortic valve abnormality | HP:0001646 | Abnormality of the | | | | |
| | | | aortic valve | | | | |
| | pericardial effusion | HP:0001698 | Pericardial effusion | | | | |
| | hypoplastic earlobe | HP:0000385 | Small earlobe | | | | |
| | thick columella | HP:0010761 | Broad columella | | | | |
| | anteverted nares | HP:0000463 | Anteverted nares | | | | |
| | clinodactyly | HP:0009466 | Radial deviation of | | | | |
| | | | finger | | | | |
| | freckling | HP:0001480 | Freckling | | | | |
| | large fontanel | HP:0000239 | Large fontanelles | | | | |
| | palpable hyperpigmented | no term | | | | | |
| | lesions | | | | | | |
| | PDA | HP:0001643 | Patent ductus arteriosus | | | | |
| | prematurity | HP:0001622 | Premature birth | | | | |
| 909 | flat expresionless facies | HP:0008769 | Dull facial expression | N | | | |
| | micrognathia | HP:0000347 | Micrognathia | | | | |
| | bitemporal narrowing | HP:0000341 | Narrow forehead | | | | |
| | prominent forehead | HP:0011220 | Prominent forehead | | | | |
| | poor suck | HP:0002033 | Poor suck | | | | |
| | ptosis | HP:0007911 | Congenital bilateral | | | | |
| | | | ptosis | | | | |
| | poor cry | HP:0001612 | Weak cry | | | | |
| 915 | hydrops | HP:0001789 | Hydrops fetalis | N | | | |
| | intestinal perforation | HP:0002244 | Abnormality of the | | | | |
| | | | small intestine | | | | |
| | pleural effusions | HP:0002202 | Pleural effusion | | | | |
| | PFO | HP:0001655 | Patent foramen ovale | | | | |
| | small secundum atrial defect | HP:0001684 | Secundum atrial septal | | | | |
| | | | defect | | | | |
| | nephrolithiasis | HP:0000787 | Nephrolithiasis | | | | |
| | kidney echogenicity | HP:0005565 | Reduced renal | | | | |
| | | | corticomedullary | | | | |
| | | | differentiation | | | | |
| | single palmar crease | HP:0000954 | Single transverse | | | | |
| | | | palmar crease | | | | |
| | low-set posteriorly rotated ears | HP:0000368 | Low-set, posteriorly | | | | |
| | | | rotated ears | | | | |
| | broad forehead | HP:0000337 | Broad forehead | | | | |
| | ascites | HP:0001541 | Ascites | | | | |
| 921 | cyanosis | HP:0000961 | Cyanosis | N | | | |
| | apnea | HP:0002882 | Sudden episodic apnea | | | | |
| | tachycardia | HP:0001649 | Tachycardia | | | | |
| | seizure | HP:0001250 | Seizures | | | | |
| | poor tone | HP:0001319 | Neonatal hypotonia | | | | |
| | hypoxemic-ischemic injury on | HP:0010663 | Abnormality of the | | | | |
| | MRI | | thalamus | | | | |
| | low alkaline phosphatase | HP:0003282 | Low alkaline | | | | |
| | | | phosphatase | | | | |
| | moderate encephalopathy | HP:0001298 | Encephalopathy | | | | |
| | bilateral thalamic injury | HP:0010663 | Abnormality of the | | | | |
| | | | thalamus | | | | |

Average ranked score = 806
Median = 181

Genome Sequencing and Quality Control

STATseq was performed at CPGM under a research protocol, and employed either a 50-hour or seven day protocol that was guided by acuity of illness. The laboratory was licensed by the Clinical Laboratory Improvement Amendments (CLIA) and accredited by the College of American Pathologists (CAP). STATseq was performed on both parents and affected infants simultaneously. Genomic DNA extraction from whole blood, library preparation, sequencing, and data analysis were performed using validated protocols. Genomic DNA was prepared using Illumina TruSeq PCR Free sample preparation. Quantitation was by real-time PCR. Libraries were sequenced by Illumina HiSeq 2500 instruments (2×100 nt) in rapid run mode (50-hour protocol) or standard run mode (7 day protocol). STATseq was to a depth of at least 90 Gb per sample (MD Table s2), to provide a mean 40-fold genome coverage. Each sample met established quality metrics.

MD TABLE s2

| | | | | Aligned | | | |
|---|---|---|---|---|---|---|---|
| | | | Aligned | Sequence | | | |
| | | | Sequence | with | | ACMG | Rare |
| | Total | | Passing | Quality | Total | Category | Category |
| | Sequence | Sequence | Filters | Score >20 | Nucleotide | 1-3 | 1-3 |
| Patient ID | Reads | (GB) | (GB) | (GB) | Variants | Variants | Variants |
| CMH000064 | 1,209,959,172 | 122 | 116 | 108 | 4,114,218 | 1,675 | 439 |
| CMH000172 | 1,133,464,063 | 114 | 111 | 105 | 4,021,771 | 1,684 | 677 |
| CMH000184 | 1,539,534,606 | 153 | 143 | 124 | 4,112,204 | 1,793 | 697 |
| CMH000436 | 1,239,018,816 | 125 | 115 | 99 | 4,397,470 | 2,732 | 1,820 |
| CMH000487 | 984,302,114 | 99 | 90 | 81 | 3,495,407 | 1,486 | 446 |
| CMH000531 | 1,015,355,810 | 102 | 98 | 91 | 4,026,494 | 2,045 | 705 |
| CMH000545 | 1,299,071,626 | 131 | 123 | 112 | 4,167,651 | 2,161 | 543 |
| CMH000569 | 995,793,286 | 100 | 81 | 67 | 4,040,311 | 1,989 | 500 |
| CMH000578 | 1,016,894,441 | 102 | 96 | 85 | 4,362,650 | 2,314 | 503 |
| CMH000586 | 1,161,691,860 | 117 | 105 | 96 | 5,072,718 | 3,199 | 660 |
| CMH000597 | 1,179,401,492 | 119 | 113 | 105 | 5,768,041 | 4,832 | 2,057 |
| CMH000629 | 1,260,077,897 | 127 | 122 | 113 | 5,638,197 | 4,072 | 1,567 |
| CMH000659 | 1,115,741,714 | 112 | 106 | 95 | 4,893,006 | 2,926 | 528 |
| CMH000672 | 1,338,643,358 | 135 | 127 | 119 | 5,188,397 | 3,499 | 641 |
| CMH000675 | 1,069,465,706 | 108 | 101 | 92 | 5,016,595 | 3,308 | 590 |
| CMH000678 | 1,141,745,228 | 115 | 111 | 105 | 5,177,754 | 3,429 | 677 |
| CMH000680 | 1,236,090,235 | 124 | 116 | 104 | 4,984,432 | 3,049 | 581 |
| CMH000718 | 893,119,414 | 90 | 86 | 76 | 4,835,510 | 2,731 | 541 |
| CMH000725 | 1,217,619,906 | 153 | 145 | 132 | 5,792,885 | 4,339 | 1,034 |
| CMH000728 | 1,385,506,538 | 139 | 135 | 126 | 5,742,253 | 4,346 | 894 |
| CMH000731 | 1,539,656,776 | 155 | 149 | 139 | 5,792,358 | 4,380 | 951 |
| CMH000743 | 1,346,953,314 | 136 | 117 | 104 | 5,706,846 | 4,058 | 981 |
| CMH000773 | 1,377,844,134 | 139 | 127 | 114 | 5,189,138 | 3,456 | 589 |
| CMH000809 | 1,301,669,582 | 131 | 127 | 121 | 5,253,161 | 3,740 | 711 |
| CMH000846 | 1,167,898,354 | 117 | 112 | 106 | 4,926,462 | 3,451 | 604 |
| CMH000852 | 1,313,185,974 | 132 | 127 | 116 | 4,892,748 | 3,391 | 648 |
| CMH000855 | 1,573,776,080 | 158 | 153 | 144 | 5,088,643 | 3,598 | 686 |
| CMH000873 | 1,503,210,908 | 151 | 146 | 137 | 4,999,683 | 3,526 | 698 |
| CMH000879 | 949,250,826 | 96 | 94 | 87 | 4,835,244 | 3,181 | 609 |
| CMH000890 | 1,317,927,540 | 133 | 127 | 118 | 5,028,868 | 3,431 | 841 |
| CMH000893 | 1,098,395,560 | 110 | 103 | 94 | 4,898,433 | 3,468 | 621 |
| CMH000902 | 1,196,040,706 | 120 | 117 | 110 | 5,828,311 | 4,897 | 2,346 |
| CMH000909 | 1,029,303,100 | 103 | 99 | 93 | 4,963,861 | 3,596 | 791 |
| CMH000915 | 1,277,867,680 | 129 | 124 | 116 | 4,964,223 | 3,652 | 836 |
| CMH000921 | 1,485,804,854 | 150 | 144 | 133 | 4,969,662 | 3,853 | 873 |
| Average | 1,226,036,648 | 124 | 117 | 108 | 4,919,589 | 3,237 | 825 |

Genome Sequence Analysis

Sequences were aligned to the human reference NCBI 37 using Genomic Short Read Nucleotide Alignment Program (GSNAP). Nucleotide variants were detected and genotyped with the Genome Analysis Toolkit (GATK) v. 1.4 and 1.6, and yielded an average of 4.9 million nucleotide variants per sample (Table S2). Variants were annotated with RUNES software. STATseq interpretations considered multiple sources of evidence, including variant attributes, the gene involved, inheritance pattern, and clinical case history. Causative variants were identified primarily with VIKING software by limitation to American College of Medical Genetics (ACMG) Categories 1-3 and allele frequency <1% from an internal database. On average, genomes contained 825 potentially pathogenic variants (allele frequency <1%, ACMG categories 1-3). All inheritance patterns were examined. Where a single likely causative variant for a recessive disorder was identified, the locus was manually inspected using the Integrated Genome Viewer in the trio for uncalled variants. Expert interpretation and literature curation were performed for likely causative variants with regard to evidence for pathogenicity. While STATseq can give a provisional diagnosis of genetic disorders in 50-hours, it is a research test, and Sanger sequencing was used for confirmation of all likely causative genotypes. During the study, the FDA granted non-significant risk status to verbal return of a provisional STATseq diagnosis to the treating physician in exceptional cases, where the results were actionable and the infant was imminently likely to die (FDA/CDRH/OIR submission Q140271, May 8, 2014). Familial relationships were confirmed by segregation analysis of private variants in STATseq diagnoses associated with de novo mutations. An infant was classified as having a definitive diagnosis if a pathogenic or likely pathogenic genotype in a disease gene that overlapped with a reported phenotype was reported in the medical record. Expert consultation and functional confirmation were performed when the subject's phenotype differed from the expected phenotype for that disease gene. Incidental findings were not reported.

Reference Standard Testing

Affected infants received diagnostic testing based on physician clinical judgment (reference standard), in addition to STATseq (index test). Standard etiologic testing for genetic diseases included biochemical and immunologic testing of body fluids, array comparative genomic hybridization, fluorescence in situ hybridization, high resolution chromosomes, sequencing of genes and gene panels, methylation studies, and gene deletion/duplication assays.

Outcomes

The primary outcomes evaluated were the diagnostic rate and time to diagnosis of the reference standard and STATseq. Measurements included the types of molecular diagnosis obtained, medically actionable diagnoses, and impact of diagnoses on medical care and outcomes.

Results—Demographics of Infants

49 families with acutely ill or deceased infants and children were enrolled and received STATseq of parent-child trios. 35 of these families met inclusion criteria for this report: age of the affected infant <4 months, enrollment from a level IV NICU or PICU at the clinic between November 2011 and October 2014, acute illness of suspected monogenetic etiology in the infant, absence of an etiologic diagnosis, and where that diagnosis had any potential to alter management or genetic counseling (FIG. MD 1). The phenotype(s) for which infants had been nominated were diverse, and were typically present at birth (MD Table 1). The most common phenotypes were congenital anomalies (26%) and neurologic findings (20%). However, frequently, infants had complex clinical features, and the proximate reason for nomination for STATseq was one of several co-occurring phenotypes (Table S1). For example, CMH487 was admitted to the NICU at birth with bronchopulmonary dysplasia and a ruptured omphalocele, but was nominated for STATseq for acute liver failure on day of life (DOL) 71.

MD TABLE 1

| | | | Reference | | | | | |
|---|---|---|---|---|---|---|---|---|
| | | | Method | | | | No RGS | |
| Demographics | Total | | Diagnosis | | RGS Diagnosis | | Diagnosis | |
| Infants tested (n, %) | 35 | | 33 | (94%) | 35 | | 35 | |
| Group size (n) | 35 | | 33 | | 20 | | 15 | |
| Consanguinity/Isolated Population (n, %) | 1 | (3%) | 0 | | 1 | (5%) | 0 | |
| Males (n, %) | 18 | (51%) | 2 | (67%) | 9 | (45%) | 9 | (60%) |
| Family History (n, %) | 5 | (14%) | 0 | | 4 | (20%) | 1 | (7%) |
| Gestational Age (Average, range, weeks) | 36.7 | (29-41) | 38.0 | (37-39) | 36.7 | (29-40) | 36.7 | |
| Premature (<37 weeks gestation, n, %) | 13 | (37%) | | | | | | |
| 1 minute APGAR (Average, range) | 4.9 | (0-9) | 7.0 | (5-8) | 5.3 | (0-9) | 4.5 | (0-8) |
| 5 minute APGAR (Average, range) | 6.6 | (0-9) | 8.3 | (7-9) | 7.1 | (6-9) | 5.9 | (0.9) |
| Birth Weight (Average, range, Kg) | 2.70 | (0.72-4.48) | 2.88 | (2.52-3.34) | 2.78 | (0.72-4.48) | 2.59 | |
| Low birth weight (<2500 g, n, %) | 7 | (20%) | | | | | | |
| Very low birth weight (<1500 g, n, %) | 4 | (11%) | | | | | | |
| Extremely low birth weight (<1000 g, n, %) | 1 | (3%) | | | | | | |
| Deaths (n, %) | 13 | (37%) | 2 | (67%) | 10 | (50%) | 3 | (20%) |
| Age at Death (Average, range, days) | 80.9 | (2-595) | 29.5 | (10-49) | 44.5 | (16-88) | 202.3 | (2-595) |
| Principal phenotypic feature | | | | | | | | |
| Symptom onset (Average, range, days) | 0.3 | (0.7) | 0 | | 0.5 | (0-7) | 0 | |
| Multisystem Congenital Anomalies | 9 | (26%) | 2 | (67%) | 5 | (25%) | 4 | (27%) |

| | | | | | | | |
|---|---|---|---|---|---|---|---|
| Neurologic findings | 7 | (20%) | 0 | 4 | (20%) | 3 | (20%) |
| Cardiac findings/Heterotaxy | 5 | (14%) | 0 | 3 | (15%) | 2 | (13%) |
| Hydrops/Pleural Effusion | 4 | (11%) | 0 | 2 | (10%) | 2 | (13%) |
| Metabolic findings, inc. Hypoglycemia | 4 | (11%) | 0 | 2 | (10%) | 2 | (13%) |

| | | | | | | |
|---|---|---|---|---|---|---|
| Renal findings | 1 | (3%) | 0 | 0 | 1 | (7%) |

| | | | | | | |
|---|---|---|---|---|---|---|
| Arthrogryposis | 2 | (6%) | 0 | 2 | (10%) | 0 |

| | | | | | | | |
|---|---|---|---|---|---|---|---|
| Respiratory findings | 1 | (3%) | 1 | (33%) | 0 | 1 | (7%) |

| Hepatic findings | 1 | (3%) | 0 | | 1 | (5%) | 0 |
|---|---|---|---|---|---|---|---|
| Dermatologic findings | 1 | (3%) | 0 | | 1 | (5%) | 0 |
| Testing (median, range in days) | | | | | | | |
| Age at Enrollment/Reference Test Order (Days) | 25.9 | (0-144) | 19.7 | (0-144) | 32.4 | (2-71) | 17.3 |

| Number of tests | 114 | | 94 | 20 | | 15 | |
|---|---|---|---|---|---|---|---|
| Interval: Enrollment-Analysis | 5.0 | (3-153) | n.a. | 5.5 | (3-153) | 5.0 | (3-46) |

| Interval: Analysis-Report | 9.0 | (1-878) | n.a. | | 9.0 | (1-878) | n.a. |
|---|---|---|---|---|---|---|---|
| Interval: Enrollment/Reference Test Order-Report | 22.5 | (5-912) | 16.0 | (1-162) | 22.5 | (5-912) | n.a. |
| Infants diagnosed (n, %) | 21 | (60%) | 3 of 33 | (9%) | 20 of 35 | (57%) | 0 of 35 |

Diagnostic Results

The reference standard comprised 94 clinical genetic tests that were performed in 33 of the 35 infants, and gave three genetic diagnoses (9%; by microarray comparative genomic hybridization in CMH773, and single gene sequencing in CMH725 and CMH890) (FIG. MD 1, MD Table 1). The average age at reference standard test order was DOL 20, and the median time to diagnostic report was 16 days (MD Table 1).

STATseq gave 20 diagnoses (57%), which was significantly more than the reference standard (χ², p<10⁻¹⁰; FIG. MD 1, Tables 1 and 2). The average age at enrollment for STATseq was DOL 26, and the median time to confirmed, reported diagnosis was 23 days (MD Table 1). Of this, the median interval from enrollment to STATseq completion and start of variant analysis was 5 days (range 3-153 days; MD Table 1). The outlier, CMH064, was the first enrollee and STATseq methods were still in development. 65% of STATseq diagnoses were reported prior to discharge or death. In four infants, death occurred within four days of enrollment, and STATseq was incomplete at time of death (FIG. MD S2 and S3). Reasons for longer STATseq times-to-diagnosis were development of informatics tools for structural variant detection during the study, publication of novel disease-gene associations during the study, or infants whose phenotype differed sufficiently from prior reports to require extensive analysis and external expert consultation.

45% (9 of 20) of STATseq diagnoses were diseases that were not considered in the differential diagnosis at time of enrollment. In one acutely ill infant, an actionable, provisional molecular diagnosis was reported verbally on day 3, before confirmatory testing (see CMH487, below). STATseq replicated the three reference standard diagnoses, albeit one was not reported clinically as a result of STATseq, and was thus excluded from the STATseq diagnostic rate (FIG. MD 1). Inclusive of that case, the STATseq diagnostic rate was 60% (21 of 35; MD Table 1).

In almost all cases STATseq and clinical genetic testing also identified findings that were not reported since either they did not adequately explain the etiology of illness in those infants, or lacked sufficient evidence of pathogenicity.

No phenotypic feature was associated with a higher diagnostic yield with STATseq. Recurrent genes with causative variants were PTPN11 (3), CHD7 (2), and SCN2A (2); all of which occurred de novo (MD Tables 2 and s3). Dominant de novo mutations were the most common mechanism of genetic disease (65%). One patient had a dominantly inherited disease, with a paternally inherited variant and somatic loss of the maternal allele. Genome sequencing provided good coverage of the mitochondrial genome, yielding one maternally-inherited diagnosis. Of five patients with autosomal recessive inheritance, four were compound heterozygous, and one, from a genetically isolated population, was homozygous (MD Table 2).

MD TABLE 2

| Patient | | | |
|---|---|---|---|
| ID | RGS Indication | Gene | Disease Name |
| CMH064 | Desquamating skin rash | GJB2 | Keratitis-ichthyosis-deafness |
| | | | syndrome |
| CMH172 | Status epilepticus | BRAT1 | Lethal neonatal rigidity and |
| | | | multifocal seizure syndrome |
| CMH184 | Heterotaxy | MMP21 | Heterotaxy |
| CMH487 | Acute liver failure | PRF1 | Familial hemophagocytic |
| | | | lymphohistiocytosis type 2 |
| CMH545 | Bilateral chylous effusions | PTPN11 | Noonan syndrome |
| CMH569 | Hyperinsulinemic hypoglycemia | ABCC8 | Familial Hyperinsulinism type 1 |
| CMH578 | Hypertrophic cardiomyopathy, increased neck folds, | PTPN11 | Noonan syndrome |
| | low set ears, hypotonia | | |
| CMH586 | Failure to thrive, lactic acidosis, hypoglycemia | MT:TE | Reversible COX deficiency |
| | | | myopathy |
| CMH629 | Seizures, arthrogryposis, pulmonary hypoplasia | SCN2A | Epileptic encephalopathy |
| CMH659 | Arthrogryposis, VUR, VSD, ASD, lissenencephaly, | KAT6B | SBBYSS syndrome |
| | absent corpus collusum | | |
| CMH672 | Seizures | KCNQ2 | Epileptic encephalopathy |
| CMH678 | IUGR, cardiomegaly, AV canal defect, osteopenia, | GNPTAB | Mucolipidosis III α/β |
| | microcolon, large optic nerves | | |
| CMH680 | Seizures | SCN2A | Epileptic encephalopathy |
| CMH725 | Multiple congenital anomalies | CHD7 | CHARGE syndrome |
| CMH809 | Hypertrophic cardiomyopathy, hepatomegaly, | PTPN11 | LEOPARD syndrome |
| | thrombocytopenia | | |
| CMH846 | Seizure, polyhydramnios, respiratory failure, flat | PHOX2B | Central hypoventilation syndrome |
| | facies, Facial nerve palsy | | |
| CMH855 | Hypoplastic right heart, tricuspid stenosis, diabetes, | GATA6 | Pancreatic agenesis and congenital |
| | biliary atresia, gallbladder absent | | heart defects |
| CMH873 | acute renal failure with nephrotic syndrome, cataracts | LAMB2 | Pierson syndrome |
| CMH890 | Craniosynostosis, bilateral choanal atresia, | FGFR2 | Pfeiffer syndrome |
| | micrognathia, ventriculomegaly | | |
| CMH902 | Pulmonary Hypertension, abnormal ears, multicystic | CHD7 | CHARGE syndrome |
| | kidney, labial hypoplasia, brain cyst | | |

| | Atypical | | |
|---|---|---|---|
| | presentation | | |
| Patient | or partial | Inheritance | |
| ID | diagnosis | Pattern | Variant |
| CMH064 | Y | AD, de novo | c.85_87del [p.Phe29del] |
| CMH172 | | AR, hom | c.453_454insATCTTCTC [p.Leu152IlefsTer70] |
| CMH184 | | AR, CH | c.365del [p.Met122SerfsTer55] |
| | | | exon 1-3 deletion |
| CMH487 | Y | AR, CH | c.1310C > T [p.Ala437Val] |
| | | | c.272C > T [p.Ala91Val] |
| CMH545 | | AD, de novo | c.922A > G [p.Asn308Asp] |
| CMH569 | | AD*** | c.3640C > T [p.Arg1214Trp] |
| CMH578 | | AD, de novo | c.1391G > C [p.Gly464Ala] |
| CMH586 | | Mitochondrial | tRNA-Glu; nucleotide 73 T > C |
| CMH629 | Y | AD, de novo | c.4877G > A [p.Arg1626Gln] |
| CMH659 | | AD, de novo | c.3603_3606del [p.Thr1203ArgfsTer21] |
| CMH672 | | AD, de novo | c.913T > C [p.Phe305Leu] |
| CMH678 | | AR, CH | c.1001G > A [p.Arg334Gln] |
| | | | c.1017_1020dupTGCA [p.Pro341CysfsTer22] |
| CMH680 | | AD, de novo | c.2635G > A [p.Gly879Arg] |
| CMH725 | | AD, de novo | c.1234C > T [p.Gln412Ter] |
| CMH809 | | AD, de novo | c.1517A > C [p.Gln506Pro] |
| CMH846 | | AD, de novo | c.831dupC [p.Gly278ArgfsTer82] |
| CMH855 | | AD, de novo | c.960del [p.Asn320LysfsTer26] |
| CMH873 | | AR, CH | c.4773dupG [p.Arg1592AlafsTer7] |
| | | | c.5248C > T [p.Gln1750Ter] |
| CMH890 | | AD, de novo | c.1124A > G [pTyr375Cys] |
| CMH902 | | AD, de novo | c.5164_5171del [p.Phe1722GlyfsTer12] |

In infants receiving STATseq diagnoses, the degree of overlap between the classical clinical features of that disease and those which were observed was examined. HPO terms for these were mapped to genetic diseases with Phenomizer (MD Table s1). The rank of the diagnosis in the genetic disease compendium reflected concordance of observed and expected presentations (MD Table s1). Among 19 infants whose genetic diagnosis was in the Phenomizer database, the average rank was 806^{th} (median 181^{st}, MD Table s1). In contrast, the average rank among 32 older children with neurodevelopmental disorders diagnosed by genomic sequencing was 279^{th} (median 128^{th}, MD table s4).

MD TABLE S4

| Patient | | | P | | |
|---|---|---|---|---|---|
| ID | Gene | Rank | Value | OMIM ID | Disease Name |
| 1 | APTX | 136 | 0.08 | 208920 | ATAXIA, EARLY-ONSET, W OCULOMOTOR APRAXIA AND |
| 2 | APTX | 62 | 0.002 | 208920 | HYPOALBUMINEMIA |
| 7 | PYCR1 | 2 | 0.03 | 612940 | CUTIS LAXA, AUTOSOMAL RECESSIVE, TYPE IIB; |
| 21 | GNAS | 59 | 0.38 | 104580 | PSEUDOHYPOPARATHYROIDISM, 1A |
| 36 | COQ2 | ### | 1 | 607426 | COENZYME Q10 DEFICIENCY, PRIMARY, 1 |
| 42 | CACNA1A | 79 | 0.006 | 108500 | EPISODIC ATAXIA, TYPE 2 |
| 60 | TBX1 | 314 | 0.098 | 192430 | VELOCARDIOFACIAL SYNDROME |
| 62 | ASPM | 15 | 0.0001 | 608716 | MICROCEPHALY 5, PRIMARY, AR |
| 67 | MTATP6 | 51 | 0.058 | 256000 | LEIGH SYNDROME |
| 99 | IGHMBP2 | 1 | 0.0039 | 604320 | SPINAL MUSCULAR ATROPHY, DISTAL, AUT. RECESSIVE, 1 |
| 102 | NEB | 159 | 0.08 | 256030 | NEMALINE MYOPATHY 2 |
| 103 | NEB | 159 | 0.08 | 256030 | |
| 146 | KIAA2022 | ### | 0.9 | NET:85277 | INTELLECTUAL DEFICIT, XL, CANTAGREL TYPE |
| 150 | COL6A1 | 291 | 0.15 | 158810 | BETHLEM MYOPATHY |
| 169 | STXBP1 | 147 | 0.03 | 612164 | EPILEPTIC ENCEPHALOPATHY, EARLY INFANTILE, 4 |
| 190 | TRPV4 | 137 | 0.61 | 600175 | SPINAL MUSCULAR ATROPHY, DISTAL, CONGENITAL |
| | | | | | NONPROGRESSIVE |
| 194 | ARID1B | 5 | 0.006 | 614562 | MENTAL RETARDATION, AD 12 |
| 230 | ANKRD11 | 315 | 0.15 | 148050 | KBG SYNDROME |
| 254 | NDUFV1 | 78 | 0.2 | 252010 | MITOCHONDRIAL COMPLEX I DEFICIENCY |
| 255 | NDUFV1 | 119 | 0.92 | 252010 | MITOCHONDRIAL COMPLEX I DEFICIENCY |
| 259 | RMND1 | 576 | 0.47 | 614922 | COMBINED OXIDATIVE PHOSPHORYLATION DEFICIENCY |
| | | | | | 11 |
| 301 | PIGA | ### | 1 | 300868 | MULTIPLE CONGENITAL ANOMALIES-HYPOTONIA- |
| | | | | | SEIZURES SYNDROME 2 |
| 311 | PQBP1 | 3 | 0.01 | 309500 | RENPENNING SYNDROME |
| 312 | PQBP1 | 3 | 0.01 | 309500 | RENPENNING SYNDROME |
| 334 | MECP2 | 4 | 0.0001 | 300055 | MENTAL RETARDATION, X-LINKED, SYNDROMIC 13 |
| 335 | MECP2 | 24 | 0.0004 | 300055 | MENTAL RETARDATION, X-LINKED, SYNDROMIC 13 |
| 350 | STXBP1 | 5 | 0.0012 | 612164 | EPILEPTIC ENCEPHALOPATHY, EARLY INFANTILE, 4 |
| 430 | ND3 | 234 | 0.009 | 256000 | LEIGH SYNDROME |
| 502 | SNAP29 | 401 | 0.02 | 609528 | CEREBRAL DYSGENESIS, NEUROPATHY, ICHTHYOSIS, |
| | | | | | AND PALMOPLANTAR KERATODERMA SYNDROME |
| 564 | UPF3B | 350 | 0.36 | 300298 | MENTAL RETARDATION, X-LINKED, SYNDROMIC 14 |
| 605 | TSC1 | ### | 1 | 191100 | TUBEROUS SCLEROSIS-1 |
| 663 | SLC25A1 | 22 | 0.007 | 615182 | COMBINED D-2- AND L-2-HYDROXYGLUTARIC ACIDURIA |
| Average | | 279 | | | |
| Median | | 128 | | | |

Clinical Outcomes and Impact of Genomic Diagnoses

The median NICU or PICU stay was 42 days (range 3-387 days). 120-day mortality was 34% (12 of 35). It was significantly higher in infants receiving diagnoses than those who did not (11 of 21, 52%, versus 1 of 14, 7%, respectively; χ², p<10⁻²²; Table 3, MD FIGS. 2a and S3). Palliative care was instituted in a significantly higher number of infants receiving diagnoses than those who did not (7 of 21, 33%, versus 0 of 14, respectively; MD Table 3).

MD TABLE 3

| | | Diagnosis | Genetic/ | Subspecialty | | | |
|---|---|---|---|---|---|---|---|
| | Clinical | Prior to | Reproductive | consult (non- | | | |
| | Utility | Discharge/ | Counseling | genetic) | Medication | Procedure | Diet |
| Infant ID | of Dx | Death | Change | initiated | Change | Change | Change |
| CMH064 | No | No | — | — | — | — | — |
| CMH172 | Yes | No | Yes | — | — | — | — |
| CMH184 | No | No | — | — | — | — | — |
| CMH487 | Yes | Yes | — | — | Yes | — | — |
| CMH545 | Yes | Yes | Yes | — | — | — | — |
| CMH569 | Yes | Yes | — | Yes | Yes | Yes | — |
| CMH578 | No | Yes | — | — | — | — | — |
| CMH586 | Yes | No | Yes | — | Yes | — | Yes |
| CMH629 | No | No | — | — | — | — | — |
| CMH659 | Yes | Yes | — | — | — | — | — |
| CMH672 | Yes | Yes | — | — | Yes | — | — |
| CMH678 | Yes | Yes | — | — | — | — | — |
| CMH680 | Yes | Yes | — | — | — | — | Yes |
| CMH725 | No | No | — | — | — | — | — |
| CMH773* | No | No | — | — | — | — | — |
| CMH809 | Yes | Yes | — | — | — | — | — |
| CMH846 | Yes | Yes | — | — | — | — | — |
| CMH855 | Yes | Yes | Yes | — | — | Yes | — |
| CMH873 | No | No | — | — | — | — | — |
| CMH890 | Yes | Yes | — | — | — | Yes | — |
| CMH902 | No | Yes | — | — | — | — | — |
| Total or Mean | 13 | 13 | 4 | 1 | 4 | 3 | 2 |
| % of Diagnosed | 62% | 62% | 19% | 5% | 19% | 14% | 10% |

| | | | Patient | Days From | | | |
|---|---|---|---|---|---|---|---|
| | Palliative | | transferred | Enrollment | Age | Age at | Age at |
| | Care | Imaging | to different | to | at | Death | Discharge |
| Infant ID | Initiated | Change | facility | Diagnosis | Dx | (Days) | (Days) |
| CMH064 | — | — | — | 415 | — | 54 | 54 |
| CMH172 | — | — | — | 49 | — | 39 | 39 |
| CMH184 | — | — | — | 912 | 956 | | 75 |
| CMH487 | — | — | — | 36 | 107 | | 386 |
| CMH545 | Yes | Yes | — | 13 | 69 | 88 | 88 |
| CMH569 | — | — | Yes | 9 | 50 | | 53 |
| CMH578 | — | — | — | 6 | 8 | 48 | 21 |
| CMH586 | — | — | — | 34 | 98 | | 70 |
| CMH629 | — | — | — | 167 | — | 63 | 63 |
| CMH659 | Yes | — | — | 23 | 61 | | 115 |
| CMH672 | — | — | — | 22 | 26 | | 33 |
| CMH678 | Yes | — | — | 10 | 28 | 34 | 34 |
| CMH680 | — | — | — | 10 | 24 | | 143 |
| CMH725 | — | — | — | 23 | 65 | | 42 |
| CMH773* | — | — | — | 15* | — | 10 | 10 |
| CMH809 | Yes | Yes | — | 5 | 7 | 17 | 16 |
| CMH846 | Yes | Yes | — | 9 | 16 | 28 | 28 |
| CMH855 | Yes | — | — | 13 | 62 | | 101 |
| CMH873 | — | — | — | 30 | — | 26 | 25 |
| CMH890 | Yes | — | — | 15 | 35 | 49 | 49 |
| CMH902 | — | — | — | 34 | 53 | | n.a. |
| Total or Mean | 7 | 3 | 1 | 91.8 | 104 | 41 | 72 |
| % of Diagnosed | 33% | 14% | 5% | | | 52% | |

The short-term clinical impact of STATseq diagnoses was assessed by chart reviews and interviews with referring physicians (MD Table 3). 62% of STATseq diagnoses were considered to have acute clinical utility (MD Table 3). Reasons for utility were diverse, and included institution of palliative care, medication changes, and change in genetic counseling. Of 13 diagnoses made prior to discharge or death, 11 (85%) were considered to have acute clinical utility. In four of these (31% of timely diagnoses, 19% of all diagnoses, 11% of the total cohort) the change in acute management or outcome was both considerable and favorable, detailed as follows.

Illustrative Cases

CMH487, a full-term male admitted to the NICU at birth with multiple congenital anomalies, required tracheostomy and was ventilator dependent (FIG. MD 2b). On day of life (DOL) 56 he developed acute hepatic failure. Extensive testing failed to yield an etiologic diagnosis. Steroids were initiated empirically on DOL 67 with some improvement in hepatic failure. Intravenous immunoglobulin was given on DOL 69. The infant-parent trio was enrolled on DOL 71. STATseq yielded a genotype suggestive of type 2 hemophagocytic lymphohistiocytosis on DOL 74, which was confirmed and reported on DOL 77 with recommendations for functional studies. Despite marginal overlap with the classic presentation, the diagnosis was confirmed functionally by absent NK cell function. Disease-specific treatment (intravenous immunoglobulin and corticosteroids) was continued, and empiric therapies discontinued on DOL 81. Coagulopathy resolved on DOL 88. The patient is now 23 months old, at home, has normal liver function, and has undergone several surgical procedures for correction of congenital anomalies.

CMH569 was admitted to the PICU on DOL 34 with a blood glucose of 18 mg/dL (FIG. MD 2c). Hypoglycemia persisted despite glucose infusion of >13 mg/kg/min and maximum dose of diazoxide. Testing revealed hyperinsulinemia (6.4 PU/mL with a serum glucose of 37 mg/dL). The infant-parent trio was enrolled on infant DOL 41. STATseq yielded a genotype suggestive of ABCC8-associated familial hyperinsulinism, type 1, which was reported provisionally on DOL 45. The presence of a single, paternally derived mutation and clinical presentation suggested the focal form of familial hyperinsulinism (FHI; pancreatic adenomatous hyperplasia that involved a portion of the pancreas), caused by biallelic mutations in ABCC8. Focal FHI is inherited autosomal dominantly, but only manifests when the mutation is on the paternally derived allele and there is somatic loss of the maternal allele in a p cell precursor. The confirmed diagnosis was reported on DOL 50. Fluorodopa positron emission tomography was used to confirm and localize the focal pancreatic lesions, which changed the surgical approach and clinical outcome: Targeted resection of focal pancreatic lesions was performed, avoiding insulin-requiring diabetes mellitus. STATseq shortened the PICU stay, as well as the morbidity (and potential mortality) associated with breakthrough hypoglycemia, by approximately three weeks. The patient is now 19 months old and euglycemic. The patient maintained normal blood glucose during a fasting challenge, indicating no persistent hyperinsulinism.

CMH586 was admitted on DOL 63 for failure to thrive (weight 5^{th} percentile for a 2-week old, length 6^{th} percentile, head circumference 15^{th} percentile), with lactic acidosis, hypoglycemia and abnormal liver function. Intravenous dextrose increased the lactic acid. Ketosis was minimal and lactate: pyruvate ratio was normal. The empiric diagnosis was pyruvate dehydrogenase complex deficiency, and a modified ketogenic diet was started. STATseq identified reversible cytochrome C oxidase deficiency with a maternally inherited homoplasmic mitochondrial mutation. This diagnosis conferred a highly favorable long-term prognosis, and, thus, changed the clinical impression such that intensive interventions were indicated had the acute clinical course deteriorated. The ketogenic diet was unnecessary, and was discontinued. She is now 17 months old and has normal growth, weight and age-appropriate development.

CMH680 was diagnosed with early infantile epileptic encephalopathy, type 11, resulting in institution of a ketogenic diet and a change in anti-epileptic drug. She is now 16 months old, at home, and continues to have seizures, but has had improvement in electroencephalograms.

In several cases, literature review identified potential treatments that were novel or supported only by anecdotal evidence of efficacy. For example, in CMH809, with PTPN11-associated hypertrophic cardiomyopathy (LEOPARD syndrome), an N-of-1 trial of everolimus, an inhibitor of mTOR-dependent MEK/ERK activation, was internally discussed as a potential therapy, but not implemented. The infant died on DOL 17.

STATseq was feasible in a sustained manner in a NICU/PICU setting, and conferred etiologic diagnoses to a majority of enrolled infants with a wide range of clinical presentations. Since genetic diseases are the leading cause of death in the NICU and PICU, as well as overall infant mortality, these results have broad implications for the practice of neonatology.

The rate of definitive diagnosis by STATseq was 57%, which was significantly higher than that of reference methods (9%). Nine molecular diagnoses were unsuspected prior to STATseq, and thus patients did not receive reference standard testing for these specific genes. In addition, the rapidity of STATseq diagnosis abbreviated the extent of reference standard testing in some cases. The rate of diagnosis by STATseq was higher than that reported for exome sequencing, especially given the absence of consanguinity herein. Several factors may have contributed to this difference. A priori, genome sequencing is more complete than exome sequencing. Parent-infant trios were utilized, which allowed identification of de novo mutations that were the most common mechanism of disease. Clinicopathologic correlation software helped to overcome the interpretive difficulty of broad genetic and clinical heterogeneity in infants, particularly where the clinical overlap of presentations with classic genetic disease descriptions was modest. In fact, the phenotypes of infants were frequently formes frustes of classical genetic disease descriptions, as evidenced by the average STATseq-based diagnosis ranking 806^{th} most likely on a software-derived list of differential diagnoses. In contrast, the average rank among 32 older children diagnosed in a similar manner was 279^{th}. Additionally, the cases reported herein were a select subset of the total NICU and PICU admissions during the study period, with a strong pretest probability of genetic disease. Finally, the higher rate of diagnosis by STATseq may be the result of higher prevalence of genetic disease in a level IV NICU and PICU population, as opposed to the older children reported in prior exome studies. Irrespective, STATseq was effective for genetic disease diagnosis in infants in a level IV NICU or PICU setting.

While STATseq can give a provisional diagnosis of genetic disorders in 50-hours, the fastest time to reported diagnosis herein was 5 days, and median was 22.5 days. There were several reasons for this: Firstly, some diagnoses were made following improvements in methods or publication of novel disease-gene associations during the study. Secondly, extensive analysis and expert consultation where required in cases where diagnoses differed widely from expected presentations. Thirdly, STATseq is a research test, and confirmation with a clinical test is mandatory before reporting results. Confirmatory Sanger sequencing typically took one week. During the study, however, the FDA granted non-significant risk status to our return of a provisional STATseq-based diagnosis to the treating physician in exceptional cases, where the results were actionable and death was imminently likely. The fastest provisional diagnosis was 3 days.

A prerequisite for broad adoption of STATseq in infants is demonstration of improved outcomes. The mortality rate among infants receiving a diagnosis was very high (52% at 120 days). Among infants who died, the average age was 0.5 days at symptom onset, 26 days at enrollment, and 45 days at death. 65% of STATseq diagnoses were reported prior to discharge or death. Thus, the average interval for diagnosis and institution of genotype-directed interventions that could lessen morbidity and mortality was extremely brief. Nevertheless, treating physicians adjudged STATseq diagnoses to have been helpful in acute clinical care in 62% of infants. The principal types of change in care that were associated with diagnoses were in medications, genetic counseling and medical procedures. In four cases, which were described in detail, acute management and/or outcome was substantively and favorably changed, or had the potential to have been changed. Genetic diagnosis also enabled prognostic determination and discussion of institution of palliative care where the prognosis was poor. Palliative care was implemented in 33% of infants receiving genetic diagnoses.

In toto, this experience suggested a novel framework for implementation of genomic medicine in a level IV NICU or PICU. In families desiring the full complement of intensive care, optimal management of each infant could be considered an N-of-1-genome case study, as exemplified by CMH809. This could be accomplished, for example, by the institution of a specific genomic neontatology care team in large level IV NICUs and PICUs, for early ascertainment of candidate patients, facilitation of etiologic diagnosis by STATseq, immediate provision of prognostic and therapeutic guidance and counseling in ultra-rare disorders, and to facilitate rapid implementation of specialized treatments, services and studies in infants receiving diagnoses.

An unexpected finding was that mortality was significantly higher in infants receiving a diagnosis by STATseq (52% at 120 days) than in those who did not (7%). In addition, palliative care was instituted in a significantly higher number of infants receiving STATseq diagnoses (33%) than those who did not (0%). These findings reflect the poor prognosis for many genetic diseases of infancy, and current absence of ameliorative or curative treatments.

This study had several limitations. It was small, retrospective and lacked a randomized, blinded control group. It was limited to infants of <4 months in a single level IV NICU or PICU where the presentation was of a type that a diagnosis had any potential to alter management or genetic counseling. Sufficient time has not elapsed since study inception to ascertain long-term outcomes. The psychosocial impact of diagnoses for parents or healthcare providers was not measured. Fuller assessment of the utility of STATseq to impact infant morbidity and mortality will necessitate additional study, with enrollment at or close to birth, more timely STATseq than achieved herein, and rapid institution of individualized treatment. Some of these limitations will be addressed, and the generalizability of the results reported herein to broader newborn populations will be examined in a prospective, randomized, blinded study that has recently commenced (clinicaltrials.gov NCT02225522).

In conclusion, STATseq provided genetic diagnoses in a majority of infants of age less than 4 months in a level IV NICU and PICU in whom such diseases were suspected and had a potential to influence clinical management or genetic counseling. STATseq-based diagnoses refined treatment plans in a majority of such infants.

### Additional Materials

Supplementary Box 1: Retrospective Case Example of 24-Hour Diagnostic Whole Genome Sequencing

Case 1, UDT173, unblinded

Five month old male with developmental regression, hypotonia, and
seizures. Brain MRI showed dysmyelination. Hair shafts had pili torti.
Serum copper and ceruloplasmin were low.
Local time (elapsed time)
13:00 (00:00) Modified, PCR-free Sample prep started with DNA of
known concentration.
16:02 (03:02) Sample prep finished
16:03 (03:03) HiSeq 2500 Rapid Run started - On board clustering
and 2 × 101 cycle sequencing
10:00 (21:00) Sequencing completed and started iSAAC alignment
11:24 (22:24) Alignment completed and starling variant caller started
11:57 (22:57) VCF converted to gVCF; 3.7 million variants found.
12:10 (23:10) 70,000 coding variants annotated.
12:11 (23:11) Filters applied:

| | |
|---|---|
| 17,057 | variants in conserved regions |
| 4,766 | variants in HGMD genes |
| 4,586 | not in highly polymorphic genes |
| 660 | predicted function-changing variants |
| 108 | with <5% population frequency |
| 10 | genes with ≧2 variant alleles, 1 SNV, no indels. |

The known diagnosis of Menkes disease (ATP7A Chr X: 77,271,307C >
T, c.2555C > T, p.P852L, OMIM#309400) was recapitulated.

Supplementary Box 2: Retrospective Case Example of 24-Hour Diagnostic Whole Genome Sequencing

Case 2, UDT103, blinded

Local time (elapsed time)
14:00 (00:00) Modified PCR Free Sample Prep started with DNA of known concentration
17:05 (03:05) Modified PCR Free Sample Prep finished (no quantification) + denatured
17:10 (03:10) HiSeq 2500 Rapid Run Started - On board clustering and 2 × 101 cycle
sequencing
11:30 (21:30) Sequencing completed and started iSAAC alignment
13:40 (23:40) Alignment and starling variant caller completed
13:53 (23:53) Annotation of exonic variants in iAFT completed
13:55 (23:55) Filters applied and found 7 variants in 4 genes. Output was BAM + gVCF +
annotation of variants.
13:58 (23:58) Seven likely pathogenic variants interpreted; The known diagnosis of
hemophagocytic lymphohistiocytosis, type 3 (OMIM# 608898) was recapitulated. The
causative genotype was compound heterozygosity with two novel, predicted pathogenic
mutations (UNC13D ENST00000207549.3:c.2955-2A > G and ENST00000207549.3:c.859-
3C > A).

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A process for genetic disease diagnosis of an individual comprising the steps of:
(a) genome sequencing;
(b) creating a superset of sensitive variant calls by using at least two independent analysis methods;
(c) comparing a database of genetic diseases with disease phenotype information to produce a prioritized list of probable genetic diseases; and
(d) integrating said superset of sensitive variant calls and said prioritized list of probable genetic diseases.

2. The process of claim 1 wherein each of said at least two independent analysis methods utilize at least one sequence alignment algorithm and at least one variant detection mechanism.

3. The process of claim 2 wherein said at least one sequence alignment algorithm is selected from the following algorithms: BarraCUDA, BFAST, BLASTN, BLAT, Bowtie, BWA, CASHX, Cloudburst, CUDA-EC, CUSHAW, CUSHAW2, CUSHAW2-GPU, drFAST, ELAND, ERNE, GNUMAP, GEM, GensearchNGS, GMAP and GSNAP, Geneious Assembler, iSAAC, LAST, MAQ, mrFAST and mrsFAST, MOM, MOSAIK, MPscan, Novoaligh & NovoalignCS, NextGENe, Omixon, PALMapper, Partek, PASS, PerM, PRIMEX, QPalma, RazerS, REAL, cREAL, RMAP, rNA, RT Invesgitator, Segemehl, SeqMap, Shrec, SHRiMP, SLIDER, SOAP, SOAP2, SOAP3 and SOAP3-dp, SOCS, SSAHA and SSAHA2, Stampy, SToRM, Subread and Subjunc, Taipan, UGENE, VeolciMapper, XpressAlign, and ZOOM.

4. The process of claim 2 wherein said at least one variant detection mechanism is selected from the following mechanisms: GATK, SAMTools, starling, VCMM.

5. The process of claim 1 wherein each of said at least two independent analysis methods utilize at least two sequence alignment algorithms and at least two variant detection mechanisms.

6. The process of claim 5 wherein said at least two sequence alignment algorithms are selected from the following algorithms: BarraCUDA, BFAST, BLASTN, BLAT, Bowtie, BWA, CASHX, Cloudburst, CUDA-EC, CUSHAW, CUSHAW2, CUSHAW2-GPU, drFAST, ELAND, ERNE, GNUMAP, GEM, GensearchNGS, GMAP and GSNAP, Geneious Assembler, iSAAC, LAST, MAQ, mrFAST and mrsFAST, MOM, MOSAIK, MPscan, Novoaligh & NovoalignCS, NextGENe, Omixon, PALMapper, Partek, PASS, PerM, PRIMEX, QPalma, RazerS, REAL, cREAL, RMAP, rNA, RT Invesgitator, Segemehl, SeqMap, Shrec, SHRiMP, SLIDER, SOAP, SOAP2, SOAP3 and SOAP3-dp, SOCS, SSAHA and SSAHA2, Stampy, SToRM, Subread and Subjunc, Taipan, UGENE, VeolciMapper, XpressAlign, and ZOOM.

7. The process of claim 5 wherein said at least two variant detection mechanisms are selected from the following mechanisms: GATK, SAMTools, starling, VCMM.

8. The process of claim 1 wherein each of said at least two independent analysis methods utilize at least three sequence alignment algorithms and at least three variant detection mechanisms.

9. The process of claim 8 wherein said at least two sequence alignment algorithms are selected from the following algorithms: BarraCUDA, BFAST, BLASTN, BLAT, Bowtie, BWA, CASHX, Cloudburst, CUDA-EC, CUSHAW, CUSHAW2, CUSHAW2-GPU, drFAST, ELAND, ERNE, GNUMAP, GEM, GensearchNGS, GMAP and GSNAP, Geneious Assembler, iSAAC, LAST, MAQ, mrFAST and mrsFAST, MOM, MOSAIK, MPscan, Novoaligh & NovoalignCS, NextGENe, Omixon, PALMapper, Partek, PASS, PerM, PRIMEX, QPalma, RazerS, REAL, cREAL, RMAP, rNA, RT Invesgitator, Segemehl, SeqMap, Shrec, SHRiMP, SLIDER, SOAP, SOAP2, SOAP3 and SOAP3-dp, SOCS, SSAHA and SSAHA2, Stampy, SToRM, Subread and Subjunc, Taipan, UGENE, VeolciMapper, XpressAlign, and ZOOM.

10. The process of claim 8 wherein said at least two variant detection mechanisms are selected from the following mechanisms: GATK, SAMTools, starling, VCMM.

11. The process of claim 1 wherein the method of integrating said superset of sensitive variant calls and said prioritized list of probable genetic diseases includes the step of limiting candidate variants to those with a population frequency of less than 1%.

12. The process of claim 1 wherein the method of integrating said superset of sensitive variant calls and said prioritized list of probable genetic diseases includes the step of limiting candidate variants to those with a population frequency of less than 0.1%.

13. The process of claim 1 wherein the method of integrating said superset of sensitive variant calls and said prioritized list of probable genetic diseases includes the step of limiting candidate variants to those that are novel in a population.

14. The process of claim 1 wherein said genome sequencing is selected from the following types: whole genome sequencing, exome sequencing, TaGSCAN sequencing, TruSight ONE, Mendelian disease gene sequencing, Nextera Expanded Exome sequencing, TruSight Tumor sequencing, TruSight Cancer sequencing, TruSight Cardiomyopathy sequencing, TruSight Autism sequencing, TruSight Inherited Disease sequencing, SureSelect Kinome sequencing, HaloPlex Cancer sequencing, HaloPlex Cardiomyopathy sequencing, transcriptome sequencing, mRNA sequencing.

15. The process of claim 14 using at least two methods of said genome sequencing wherein said genome sequencing methods are selected from the following: whole genome sequencing, exome sequencing, TaGSCAN sequencing, TruSight ONE, Mendelian disease gene sequencing, Nextera Expanded Exome sequencing, TruSight Tumor sequencing, TruSight Cancer sequencing, TruSight Cardiomyopathy sequencing, TruSight Autism sequencing, TruSight Inherited Disease sequencing, SureSelect Kinome sequencing, HaloPlex Cancer sequencing, HaloPlex Cardiomyopathy sequencing, transcriptome sequencing, mRNA sequencing.

16. A process for performing nucleotide sequence variant detection using at least two sequence alignment algorithms and at least two variant detection mechanisms.

17. The process of claim 16 wherein said at least two sequence alignment algorithms are selected from the following algorithms: BarraCUDA, BFAST, BLASTN, BLAT, Bowtie, BWA, CASHX, Cloudburst, CUDA-EC, CUSHAW, CUSHAW2, CUSHAW2-GPU, drFAST, ELAND, ERNE, GNUMAP, GEM, GensearchNGS, GMAP and GSNAP, Geneious Assembler, iSAAC, LAST, MAQ, mrFAST and mrsFAST, MOM, MOSAIK, MPscan, Novoaligh & NovoalignCS, NextGENe, Omixon, PALMapper, Partek, PASS, PerM, PRIMEX, QPalma, RazerS, REAL, cREAL, RMAP, rNA, RT Invesgitator, Segemehl, SeqMap, Shrec, SHRiMP, SLIDER, SOAP, SOAP2, SOAP3 and SOAP3-dp, SOCS, SSAHA and SSAHA2, Stampy, SToRM, Subread and Subjunc, Taipan, UGENE, VeolciMapper, XpressAlign, and ZOOM.

18. The process of claim 16 wherein said at least two variant detection mechanisms are selected from the following mechanisms: GATK, SAMTools, starling, VCMM.
